(19) United States
(12) Patent Application Publication
(10) Pub. No.: US 2026/0284598 A1
(43) Pub. Date: Sep. 24, 2026

(54) ULTRA-LOW POWER MEMBRANE-ASSISTED LITHIUM EXTRACTION SYSTEM WITH PASSIVE FOULANT REMOVAL

(71) Applicant: Lyten, Inc., San Jose, CA (US)

(72) Inventors: Jesse Baucom, Santa Clara, CA (US); Sanjeev Kolli, Santa Clara, CA (US); Engin Tuncer, Milpitas, CA (US)

(21) Appl. No.: 19/691,258

(22) Filed: May 28, 2026

Related U.S. Application Data
(63) Continuation-in-part of application No. 18/122,606, filed on Mar. 16, 2023.

(51) Int. Cl. B01D 61/28; B01D 61/24; B01D 65/02; B01D 71/32; C22B 3/22; C22B 26/12

(52) U.S. Cl. CPC B01D 61/28; B01D 61/246; B01D 65/02; B01D 71/32; C22B 3/22; C22B 26/12; B01D 2313/345; B01D 2321/162; B01D 2321/164; B01D 2321/168; B01D 2321/22

(57) ABSTRACT

A system for ultra-low power extraction of lithium from a lithium-containing brine. The system comprises (1) a feed solution comprising lithium ions and foulant species, (2) a receiving solution, (3) a membrane separating the feed solution from the receiving solution, and (4) a lithium sink in physical contact with the receiving solution. The membrane facilitates concentration-driven transport of lithium ions while concurrently reducing trans-membrane transport of foulant species. The lithium sink removes lithium ions from the receiving solution to preserve a concentration difference across the membrane that promotes diffusion of lithium ions from the feed solution to the receiving solution. Unlike conventional sorbent-based direct lithium extraction systems that require extensive upstream pretreatment to remove foulants before lithium capture, the membrane-based barrier prevents foulants from entering the lithium sink, while concurrently enabling lithium transport without the need to provide electric potentials from external sources.

### CROSS-REFERENCE TO RELATED APPLICATIONS

This application is a continuation-in-part of and claims priority to U.S. application Ser. No. 18/122,606, titled MEMBRANE-BASED ALKALI METAL PRODUCTION SYSTEM, filed Mar. 16, 2023, which is hereby incorporated by reference in its entirety.

### FIELD OF THE INVENTION

The present disclosure relates to lithium extraction systems, and more particularly to membrane-assisted lithium extraction with foulant protection.

### BACKGROUND

Lithium extraction from brine sources has become increasingly important as demand for lithium continues to grow across various industries, including energy storage and battery manufacturing. Direct lithium extraction (DLE) processes using sorbent-based systems offer potential advantages over conventional evaporative methods, including faster processing times and reduced environmental footprint. However, many lithium-containing brines, particularly lower-grade domestic resources, contain dissolved impurities that can interfere with lithium extraction operations. These impurities, which may include silica species, multivalent cations, organic substances, and hydrogen sulfide, can foul, poison, or otherwise degrade the performance of lithium-capturing materials used in extraction systems.

Existing approaches to address foulant interference in lithium extraction systems typically rely on extensive upstream pretreatment of the brine before it contacts the lithium-capturing materials. Such pretreatment steps may include various forms of filtration, chemical precipitation using lime softening or soda ash treatment, pH adjustment, aeration, and other conditioning methods. While these pretreatment approaches can effectively protect downstream extraction components from foulant exposure, they introduce significant process complexity and operational burden. The additional equipment, chemical inputs, and process steps required for pretreatment can substantially increase capital and operating costs for lithium extraction facilities.

For instance, chemical precipitation methods used to remove multivalent cations and silica species from brines often generate substantial quantities of sludge and solid waste streams that require handling, treatment, and disposal. In many cases, the volume and cost of managing these waste streams can render an otherwise viable lithium extraction project commercially impractical. Similarly, multi-stage filtration systems designed to remove particulate foulants add mechanical complexity and require ongoing maintenance, while still potentially allowing dissolved foulant species to pass through to downstream extraction equipment. These limitations of conventional pretreatment approaches have constrained the development of lithium extraction from many lower-grade brine resources that would otherwise represent valuable domestic lithium supplies.

As such, there is thus a need for addressing these and/or other issues associated with the prior art.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for extracting lithium from a lithium-containing brine is provided. The system includes a feed solution comprising lithium ions and one or more foulant species. The system includes a receiving solution configured to receive lithium ions from the feed solution. The system includes a membrane separating the feed solution from the receiving solution, wherein the membrane is configured to permit transport of lithium ions from the feed solution to the receiving solution while reducing transport of at least a portion of the one or more foulant species. The system includes a lithium sink in physical contact with the receiving solution, wherein the lithium sink is configured to reduce a concentration of lithium ions in the receiving solution. Transport of the lithium ions through the membrane is driven by diffusion resulting from a concentration gradient between the feed solution and the receiving solution.

The lithium sink may be configured to maintain a high concentration difference between the feed solution and the receiving solution, which may maximize or optimize a rate of lithium diffusion across the membrane relative to diffusion of foulant species. The lithium sink may maintain the high concentration difference by reducing the concentration of lithium ions in the receiving solution, maintaining a low concentration of lithium ions in the receiving solution, and/or controlling a rate of lithium removal from the receiving solution. By maintaining the high concentration difference, the lithium sink may preferentially enhance transport of lithium ions across the membrane while transport of foulant species remains reduced by the selectivity of the membrane.

According to other aspects of the present disclosure, the system may include one or more of the following features. The one or more foulant species may comprise at least one of silica species, multivalent cations, organic substances, or hydrogen sulfide. The silica species may comprise at least one of SiO₂ particles, silicic acid, or polymeric silica, and the multivalent cations may comprise at least one of magnesium, calcium, barium, strontium, aluminum, or iron. In various embodiments, the foulant species may further comprise colloidal particles, suspended solids, biological materials, sulfates, boron species, and/or dissolved gases that can interfere with lithium extraction operations. The silica species may further comprise colloidal silica, dissolved reactive silica, and/or silica gel. The multivalent cations may be present in specific oxidation states that are more prone to fouling; for example, iron may be present as ferric iron (Fe3+), which may be more prone to precipitation and membrane fouling than ferrous iron (Fe2+) under certain pH and dissolved oxygen conditions. Similarly, manganese may be present in oxidation states that promote precipitation and fouling on membrane surfaces. The specific foulant species present in a given lithium-containing brine may vary based on the geological source, temperature, pH, and dissolved oxygen content of the brine, and the membrane may be selected based on the particular foulant species present in the feed solution.

The lithium sink may comprise one or more materials or methods configured to reduce the concentration of lithium ions in the receiving solution by at least one of sorption, adsorption, electrochemical intercalation, or ion exchange. The one or more materials may comprise at least one of aluminum hydroxide, lithium titanate, or lithium manganese oxide, and the one or more materials may be configured to maintain the concentration gradient by continuously removing lithium ions from the receiving solution as the lithium ions migrate through the membrane. In various embodiments, the one or more materials may further comprise lithium iron phosphate, lithium cobalt oxide, activated alumina, titanium-based ion exchange materials, zirconium-based ion exchange materials, and/or other materials capable of selectively capturing lithium ions from aqueous solutions. The selection of material may be based on the lithium ion concentration in the receiving solution, the pH and temperature of the receiving solution, the desired capture rate, and/or the compatibility of the materials with the receiving solution chemistry. It is to be appreciated that, in various embodiments, the one or more materials may include sorbent materials, intercalation compounds, etc.

The concentration gradient may be maintained without application of an external electric potential across the membrane, and the transport of lithium ions through the membrane may occur without application of a current across an anode and a cathode. The lithium sink may maintain the concentration gradient by reducing a concentration of free lithium ions in the receiving solution below a concentration of lithium ions in the feed solution. The lithium sink may reduce the concentration of free lithium ions in the receiving solution to near zero. The lithium sink may be configured to periodically release accumulated lithium ions for downstream processing and subsequently resume reducing the concentration of lithium ions in the receiving solution.

A rate of transport of the lithium ions through the membrane may be proportional to the concentration gradient, and the lithium sink may be sized to maintain a target transport rate by reducing the concentration of lithium ions in the receiving solution at a rate at least equal to the rate of transport through the membrane. The membrane may be non-porous such that fouling is limited to an outermost surface of the membrane, and the concentration gradient may drive the lithium ions through a bulk of the membrane material rather than through pores.

The membrane may comprise a perfluorosulfonic acid polymer, and the membrane may be reinforced with a porous support material. The membrane may comprise at least one of a polymeric membrane, an inorganic membrane, or a hybrid membrane, and the polymeric membrane may comprise at least one of a perfluorosulfonic acid membrane, a cation exchange membrane, a sulfonated hydrocarbon membrane, a nanoporous membrane, or a fluoropolymer membrane.

The membrane may be configured to undergo a cleaning-in-place procedure comprising treatment with at least one of a strong acid, a strong base, a chelator, an oxidizer, or a surfactant to remove foulants from a surface of the membrane. The system may further comprise a guard solution disposed between a first membrane and a second membrane, wherein the first membrane is configured to permit transport of lithium ions while reducing transport of one or more silica-based foulant species, and the second membrane is configured to permit transport of lithium ions while reducing transport of one or more multivalent cation foulant species, and wherein the receiving solution is disposed on a side of the second membrane opposite the guard solution. The first membrane may comprise a perfluorosulfonic acid polymer and the second membrane may comprise a monovalent-selective cation exchange membrane, and the system may further comprise a bleed stream or a precipitation stream configured to periodically or continuously remove a portion of the guard solution to prevent accumulation of foulant species that have crossed the first membrane.

The membrane may be housed within a membrane stack comprising a plurality of membrane layers separated by flow compartments, wherein the feed solution flows through at least one of the flow compartments in a crossflow configuration parallel to a surface of at least one of the plurality of membrane layers. The membrane stack may be modular such that a lithium processing rate is scalable by adjusting a number of membrane stack modules. The system may further comprise one or more electrodes disposed within a housing of the membrane, wherein the one or more electrodes are configured to generate an electric field to dislodge foulants from a surface of the membrane. The one or more foulant species may comprise at least one of silica species, multivalent cations, organic substances, or hydrogen sulfide, and the membrane may reduce transport of the at least one of the silica species, the multivalent cations, the organic substances, or the hydrogen sulfide while the concentration gradient passively drives the lithium ions through the membrane to the lithium sink.

The foregoing general description of the illustrative embodiments and the following detailed description thereof are merely exemplary aspects of the teachings of this disclosure and are not restrictive.

### BRIEF DESCRIPTION OF THE DRAWINGS

FIG. 1 illustrates a solid electrolyte membrane, in accordance with one embodiment.

FIG. 2 illustrates a method for creating a solid electrolyte membrane, in accordance with one embodiment.

FIG. 3 illustrates a process for mechanical polishing the solid electrolyte membrane, in accordance with one embodiment.

FIG. 4 illustrates a roll-to-roll process for mechanical polishing the solid electrolyte membrane, in accordance with one embodiment.

FIG. 5 illustrates an ion-selective solid electrolyte membrane, in accordance with one embodiment.

FIG. 6 illustrates a voltage drop using a carbon-based membrane, in accordance with one embodiment.

FIG. 7 illustrates a close-up diagram of graphitic carbon, in accordance with one embodiment.

FIG. 8 illustrates a process for recovering energy from lithium extraction, in accordance with one embodiment.

FIG. 9 illustrates a cell architecture, in accordance with one embodiment.

FIG. 10 illustrates a system and method for a carbon-neutral energy reclamation battery recycling, in accordance with one embodiment.

FIG. 11 Illustrates various processes where an ion-selective electrolyte membrane separator may be incorporated, in accordance with one embodiment.

FIG. 12 illustrates electrode modules, in accordance with one embodiment.

FIG. 13 illustrates redox electrode modules, in accordance with one embodiment.

FIG. 14 illustrates a membrane separation cell, in accordance with one embodiment.

FIG. 15 illustrates a lithium extractor with active materials, in accordance with one embodiment.

FIG. 16 illustrates a lithium extractor with redox flow active materials, in accordance with one embodiment.

FIG. 17 illustrates redox electrode modules for critical minerals purification, in accordance with one embodiment.

FIG. 18 illustrates redox electrode modules for critical minerals purification, in accordance with one embodiment.

FIG. 19 illustrates redox electrode modules for metal salt precipitation, in accordance with one embodiment.

FIG. 20 illustrates redox electrode modules being set up for metal salt precipitation, in accordance with one embodiment.

FIG. 21 illustrates redox electrode modules for metal salt precipitation during reaction, in accordance with one embodiment.

FIG. 22 illustrates redox electrode modules for ion exchange, in accordance with one embodiment.

FIG. 23 illustrates a membrane separation system, in accordance with one embodiment.

FIG. 24 illustrates redox electrode modules for ion exchange, in accordance with one embodiment.

FIG. 25 illustrates membrane-based alkali metal production, in accordance with one embodiment.

FIG. 26 illustrates a process for carbon-neutral mineral recycling and reclamation.

FIG. 27 illustrates membrane-based alkali metal production, in accordance with one embodiment.

FIG. 28 illustrates another implementation of membrane-based alkali metal production, in accordance with one embodiment.

FIG. 29 illustrates membrane-based alkali metal production, in accordance with one embodiment.

FIG. 30 illustrates another implementation of membrane-based alkali metal production, in accordance with one embodiment.

FIG. 31 illustrates a redox electrode system for alkali metal extraction, in accordance with one embodiment.

FIG. 32 illustrates a redox electrode system for alkali metal extraction and precipitation, in accordance with one embodiment.

FIG. 33 illustrates a lithium extraction system, in accordance with one embodiment.

FIG. 34 illustrates an energy reclamation process for alkali metal extraction, in accordance with one embodiment.

FIG. 35 illustrates a lithium extraction cell, in accordance with one embodiment.

FIG. 36 illustrates a data plot of lithium extraction, in accordance with one embodiment.

FIG. 37 illustrates a data plot of lithium reclamation, in accordance with one embodiment.

FIG. 38 illustrates an exemplary electrode module, in accordance with one embodiment.

FIG. 39 illustrates an electrode module array, in accordance with one embodiment.

FIG. 40 illustrates an exemplary system for conversion to lithium hydroxide, in accordance with one embodiment.

FIG. 41 illustrates a subset of the exemplary system for conversion to lithium hydroxide, in accordance with one embodiment.

FIG. 42 illustrates a subset of the exemplary system for conversion to lithium hydroxide, in accordance with one embodiment.

FIG. 43 illustrates a subset of the exemplary system for conversion to lithium hydroxide, in accordance with one embodiment.

FIG. 44 illustrates an exemplary process for lithium metal production, in accordance with one embodiment.

FIG. 45 illustrates an exemplary process for lithium metal production, in accordance with one embodiment.

FIG. 46 illustrates results using redox electrode modules, in accordance with one embodiment.

FIG. 47 illustrates results using redox electrode modules, in accordance with one embodiment.

FIG. 48 illustrates results using redox electrode modules, in accordance with one embodiment.

FIG. 49 illustrates a lithium extraction system configured for membrane-assisted lithium extraction using a lithium sink, according to aspects of the present disclosure.

FIG. 50 illustrates a lithium extraction system with a concentration gradient for passive lithium transport, according to aspects of the present disclosure.

FIG. 51 illustrates a system for extracting lithium using multiple membrane barriers and a guard solution, according to aspects of the present disclosure.

FIG. 52 illustrates a system for extracting lithium with a guard solution and a bleed stream configuration, according to aspects of the present disclosure.

FIG. 53 illustrates a membrane stack configured for lithium extraction in a crossflow configuration, according to aspects of the present disclosure.

FIG. 54 illustrates a modular membrane system for lithium extraction, according to aspects of the present disclosure.

FIG. 55 illustrates a lithium extraction system with a non-porous membrane, according to aspects of the present disclosure.

FIG. 56 illustrates a membrane cleaning process for a lithium extraction system, according to aspects of the present disclosure.

FIG. 57 illustrates a lithium extraction process with capture, saturation, and release phases, according to aspects of the present disclosure.

FIG. 58 illustrates a system for electrochemical foulant removal from a membrane, according to aspects of the present disclosure.

FIG. 59 illustrates membrane types suitable for use in lithium extraction systems, according to aspects of the present disclosure.

FIG. 60 illustrates a reinforced membrane with a porous support material, according to aspects of the present disclosure.

### DETAILED DESCRIPTION

Membrane-Assisted Lithium Extraction with Foulant Protection

The present disclosure relates to lithium extraction systems, and more particularly to membrane-assisted lithium extraction with foulant protection for direct lithium extraction (DLE) processes. Lithium extraction from brine sources has become increasingly important as demand for lithium continues to grow across various industries, including energy storage and battery manufacturing. DLE processes using sorbent-based systems offer potential advantages over conventional evaporative methods, including faster processing times and reduced environmental footprint. However, many lithium-containing brines, particularly lower-grade domestic resources, contain dissolved impurities that can interfere with lithium extraction operations.

Existing approaches to address foulant interference in lithium extraction systems typically rely on extensive upstream pretreatment of the brine before it contacts the lithium-capturing materials. Such pretreatment steps may include various forms of filtration, chemical precipitation using lime softening or soda ash treatment, pH adjustment, aeration, and other conditioning methods. While these pretreatment approaches can effectively protect downstream extraction components from foulant exposure, they introduce significant process complexity and operational burden. The additional equipment, chemical inputs, and process steps required for pretreatment can substantially increase capital and operating costs for lithium extraction facilities. Chemical precipitation methods used to remove multivalent cations and silica species from brines often generate substantial quantities of sludge and solid waste streams that require handling, treatment, and disposal. In many cases, the volume and cost of managing these waste streams can render an otherwise viable lithium extraction project commercially impractical.

The present disclosure addresses these challenges by placing a membrane-based barrier between the raw brine and the lithium-capturing sink, such that lithium can be extracted while reducing exposure of the sink to foulants. A system according to the present disclosure includes a feed solution comprising lithium ions and one or more foulant species, a receiving solution configured to receive lithium ions from the feed solution, a membrane separating the feed solution from the receiving solution, and a lithium sink in physical contact with the receiving solution. The membrane is configured to permit transport of lithium ions from the feed solution to the receiving solution while reducing transport of at least a portion of the one or more foulant species. The lithium sink is configured to remove lithium from the receiving solution so as to maintain a lower lithium ion concentration in the receiving solution, thereby preserving a high driving force (i.e. high concentration) for continued lithium transport across the membrane.

The lithium sink may maintain a high concentration difference across the membrane by keeping the lithium ion concentration in the receiving solution substantially lower than the lithium ion concentration in the feed solution. The high concentration difference may serve as the primary driving force for lithium transport across the membrane, such that diffusion is the main mechanism for lithium ion transport. By relying on diffusion as the main driving force, the system may operate without requiring external energy input for lithium ion transport across the membrane, which may reduce operational costs compared to systems that rely on electrochemically-driven transport.

In some aspects, the transport of lithium ions through the membrane may be passive in nature, driven by diffusion as a result of concentration differences between the feed and receiving solutions, without application of an external electric potential across the membrane. The membrane may be non-porous, such that fouling is limited to an outermost surface of the membrane rather than within pores Because foulant accumulation occurs primarily at the outermost surface rather than penetrating into the membrane structure, the foulants may be more readily removed from the membrane through cleaning-in-place procedures. In some aspects, the system may include additional membrane layers and guard solutions between the feed and receiving solutions, where the additional membrane layers can be configured to act as additional barriers for foulants or can act as barriers to different types of foulants than the first membrane. The system assembly of membranes may be modular, such that a given lithium processing rate can be met by scaling up the number of individual modules to meet a throughput target.

### Lithium Demand and Reclamation Challenges

Lithium has become ubiquitous in nearly all electric or electronic products, from batteries to armor plating, from bicycle frames to glass, from lubricants to ceramics and more. Conventional systems and methods for obtaining lithium extract the lithium from raw materials such as from rocks and/or from mineral springs. It is well known that the global demand for lithium will deplete all known commercially viable sources of such raw materials. It therefore becomes imperative to recycle lithium. One source of lithium that is a candidate for recycling is from used lithium-containing batteries. However, to be sustainable, the techniques for lithium extraction must be highly energy efficient and scalable.

Lithium reclamation techniques disclosed herein may be scalable so as to be able to meet the forecasted worldwide EV battery recycling demands through this decade and into the decades to follow. To illustrate the needed scale, it is estimated that 10 TWh of EV battery capacity will be demanded between now and the beginning of 2030, with over 1 TWh being demanded in calendar year 2025 alone. This demand, in turn, may require around 125,000 tons (or more) of lithium for EV batteries each year. It is acknowledged that a substantial high percentage of this lithium tonnage can be reclaimed from spent batteries.

In view of this large scale, a primary challenge is reclamation efficiency. The techniques disclosed herein meet this challenge by implementing energy recycling, resulting in an extremely low demand for energy that is needed to accomplish the lithium reclamation. For example, for a single factory that reclaims 500 tons of lithium per year, using the energy reclamation techniques disclosed herein, a continuous power demand of only 44KW may be required (a number that is small enough to be provided by banks of solar panels that fit on the roof-space of an EV battery factory). As such, the disclosure herein may provide for more efficient separation of lithium from feed solution, but additionally, may provide for significant energy reclamation associated with the lithium extraction.

Additionally, known separation membranes often will crack and fail as time goes on, resulting in both time inefficiencies and fiscal losses (in having to replace the electrolyte). Further, other membranes (e.g., adsorption membranes, etc.) may have membrane fouling, which in turn, may decrease the efficiency and lifetime of the membrane. Using a solid state electrolyte membrane, in combination with a redox reaction, may assist with decreasing fouling or membrane cracking (e.g., as a consequence of volume expansion during extraction, etc.), which in turn, may increase longevity of the electrolyte and the membrane, thereby overcoming said inefficiencies and losses.

Further, the use of a solid state electrolyte membrane may allow for energy reclamation within the context of a cell design used also for alkali metal separation. For example, separating lithium may cause an electric charge which can be reclaimed for additional (or future) processing. In this manner, a near self-sufficient flow may be created (after activation energy of the reaction is initially overcome). It is to be understood that a full energy reclamation system may not be feasible (due to waste heat, impedance of the solid electrolyte membrane, etc.). However, using the systems and methods disclosed herein, a significant amount of energy may be reclaimed (thereby making the system more fiscally efficient and environmentally responsible).

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXEMPLARY EMBODIMENTS

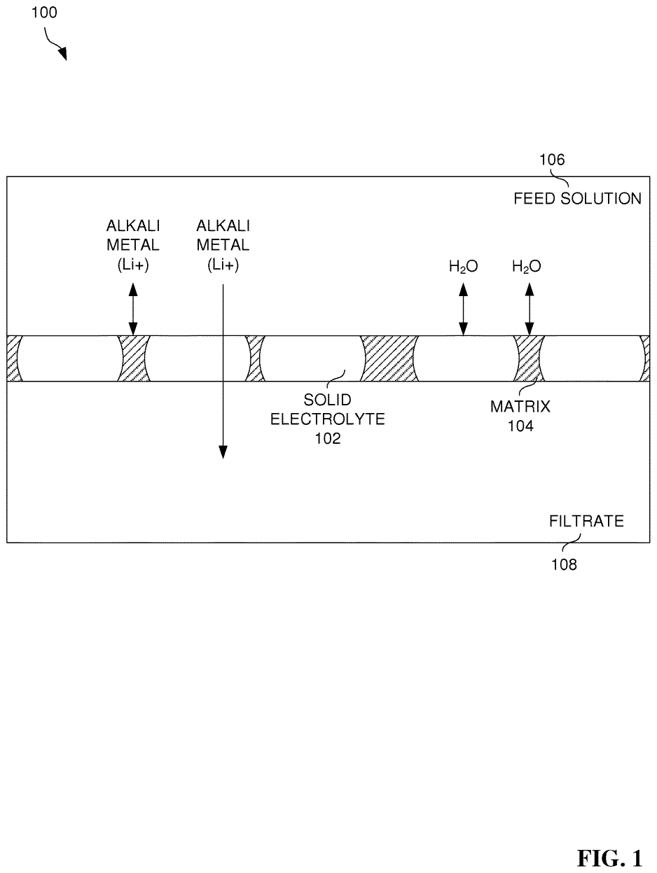

FIG. 1 illustrates a solid electrolyte membrane 100, in accordance with one embodiment. In the context of the present description, the solid electrolyte membrane 100 may be used to enable the passage of Li+ (or any preconfigured alkali metal) ions while preventing all other unwanted substances, such as water, from passing through the solid electrolyte, or through a substrate in which the solid electrolyte is embedded. Additionally, the structure of the solid electrolyte membrane 100 is extremely durable, enabling operation for a significant time without structural degradation or decrease in performance. Of course, it is to be appreciated that the solid electrolyte membrane 100 could be configured to allow passage of any specific ion. Further, the solid electrolyte membrane 100 may be configured for a high selectivity ratio of ions (such as Na+/Li+, Na+/K+, etc.).

The solid electrolyte membrane 100 improves and solves problems previously associated with prior selective membrane. For example, when using the solid electrolyte membrane 100 as an ion-selective membrane for electrochemical lithium extraction/recycling, it may prevent the electrode from contacting water (which may adversely react with it). Further, the ion-selective membrane may prevent the electrode active material from needing to be directly soaked in the feed solution, which would cause the electrode to dry out, which in turn may lead to cracking when removed from the solution while making the electrode material vulnerable to the contents of the feed solution. Additionally, the ion-selective membrane may resist cracking when taken out of the feed solution due to the fact that the ion-selective membrane may be held together by a densely crosslinked matrix, which may prevent a reconfiguration of the polymer structure (which may occur when a liquid with high surface tension, such as water, is removed from the ion-selective membrane, etc.).

Further, the solid electrolyte membrane 100 may be used as a polysulfide barrier, which may attenuate or remove (even near completely) the polysulfide shuttle phenomena in Li—S batteries. Still yet, the solid electrolyte membrane 100 may protect Li metal (or any alkali metal) from air, enabling the use of Li-air batteries, which have the highest specific energy of any known chemistry for lithium-ion batteries. As such, the solid electrolyte membrane 100 may be used as a conductive barrier to air.

As shown, a solid electrolyte 102 is embedded in an matrix 104. In one embodiment, the solid electrolyte 102 may be embedded in aluminized mylar. The combination of the solid electrolyte 102 and the matrix 104 represents a membrane. In one embodiment, as illustrated, feed solution 106 may include an alkali metal (such as Li⁺) and a liquid (such as water, H₂O). The membrane may be water impermeable such that the water may be prevented from crossing the solid electrolyte 102 and the matrix 104. In contrast, the alkali metal (such as Li⁺) may not pass thorough the matrix 104 but may pass through the solid electrolyte 102. That which passes through the membrane may be found in the filtrate 108. Additionally, in addition to repelling water, the membrane may also repel polysulfides, air (including but not limited to oxygen, nitrogen, carbon dioxide, etc.), etc.

The membrane may be composed of solid electrolyte particles (shown as the solid electrolyte 102) within a dense matrix (shown as the matrix 104). Each individual solid electrolyte particle may completely traverse the membrane such that a Li+ ion (or any alkali metal ion) entering from one side of the membrane enters the membrane through the same solid electrolyte particle that it exits the membrane from (i.e., it does not need to pass through any solid-solid interface). In one embodiment, completely traversing the membrane as a single particle may allow for higher conductivity, as the transport pathway may be more direct (especially compared to Li+ transport pathways that go through many solid-solid interfaces which may in turn have lower Li+ conductivity).

In one embodiment, the solid electrolyte membrane 102 may also prevent water from passing through the space in between the solid electrolyte particles and the matrix 104. In one embodiment, this may be due to the fact that the matrix 104 may interact strongly with the solid electrolyte particles of the solid electrolyte 102. Additionally, the solid electrolyte particles of the solid electrolyte 102 may be functionalized to improve interactions with the matrix 104. For example, in one embodiment, if using the solid electrolyte LATP, which is rich in phosphates, acrylic acid derivatives (such as 2-(aminoethyl) methacrylate) may be used to react with the surface phosphates (via michael addition) in order to enrich the surface of the solid electrolyte 102 with amine groups. As such, the epoxide molecules from the matrix 104 may covalently bond with the solid electrolyte particles of the solid electrolyte 102.

Although the alkali metal is shown as Li+ in the solid electrolyte membrane 100, it is to be appreciated that any ion of choice can be selected. Depending on the ion that should be separated, the solid electrolyte may be replaced with the appropriate material. For example, in one embodiment, if Na+ separation is desired, then NASICON can be used in place of LiSICON as the solid electrolyte. Of course, it is to be appreciated that any other ions (such as K+, Rb+, Cs+, etc.) may be separated based on accompanying solid electrolyte materials. Further, it is to be appreciated that LiSICON is a member of the NASICON family of solids, which is composed of ZrO6 octahedra and PO4/SiO4 tetrahedra that share common corners, with Na+ in the interstitial space. LiSICON may have a structural analogue with MO6 (M=Ti, Ge, Zr, Hf, Sn) octahedra and PO4 tetrahedra and Li+ in the interstitial sites. Such solid electrolytes may have high resistance to degradation and/or corrosion in water. It is to be appreciated that other materials may likewise work (that provide resistance to degradation and/or corrosion in water).

Additionally, the process can be tuned such that any desired volume fraction of solid electrolyte particles within the matrix can be achieved. For example, a slurry may be cast in which all particles are the same size and are hexagonally close packed such that the volume fraction of particles in the casted membrane is maximized. For example, maximizing the volume fraction may include maximizing the volume for a particular given particle size distribution. In other words, if all the particles are the same exact size, then hexagonally close packing may be the most efficient way to make use of the volume. However, in one embodiment, it may be possible to use an even higher volume fraction of the membrane if particles of multiple sizes and/or of different shapes are used. The volume fraction of solid electrolyte particles may then be further increased by removing an increasingly large amount of membrane (via abrasive polishing) on both sides. In this manner, any volume fraction of solid electrolyte particles can be achieved. Creating a membrane with a higher volume fraction of solid electrolyte may require polishing down the membrane film to thinner membranes, thereby removing higher fractions of the initial membrane.

Further, although the solid electrolyte membrane 100 are shown as having spherical solid electrolyte particles, it is to be appreciated that particles of the solid electrolyte 102 do not necessarily need to be spherical. For example, the particles of the solid electrolyte 102 may be donut shaped, blood-cell shaped, and/or any other specifically desired shape (which may be created based on the tuning the spray drying process, specifically the feed rate of the aqueous precursor, to shape the particles). Additionally, particles of the solid electrolyte 102 can be prepared by preparing a precursor solution and regular drying, followed by sintering, yielding non-spherical particles. Ball milling can then be used to reduce the particle size.

To maximize kinetic flow, it is recommended that an ion traverse a single particle of the solid electrolyte 102. However, the solid electrolyte membrane 100 may include multiple layers of the solid electrolyte 102, which may cause an ion to traverse or hop from one particle of the solid electrolyte 102 to another particle of the solid electrolyte 102. Having multiple layers of the solid electrolyte 102 may allow for more uniform distribution of particles within the matrix.

Additionally, multiple membranes (such as the solid electrolyte membrane 100 and another of the solid electrolyte membrane 100) can be stacked together to make a thicker membrane (which may be used for ion selectivity, kinetic flow, greater filtering capability, etc.). In such an embodiment, the individual layers of more than one membranes can be joined together with a Li+ (or whatever alkali metal ion selected) conductive adhesive, such as a matrix containing polyethylene glycol diglycidyl ether (PEG-DGE) and/or Jeffamine D-230, and a lithium, salt such as LiTFSI. Of course, it is to be appreciated that other Li+ conductive adhesives may be used to enable the fabrication of a multilayered membrane.

In one embodiment, rather than using mechanical polishing, laser ablation and/or chemical etching may be used to shave down the surfaces of the solid electrolyte membrane 100 and expose the particles of the solid electrolyte 102 to the surfaces. Additionally, ion milling or focused ion beams (FIB) may be used to polish the surface.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

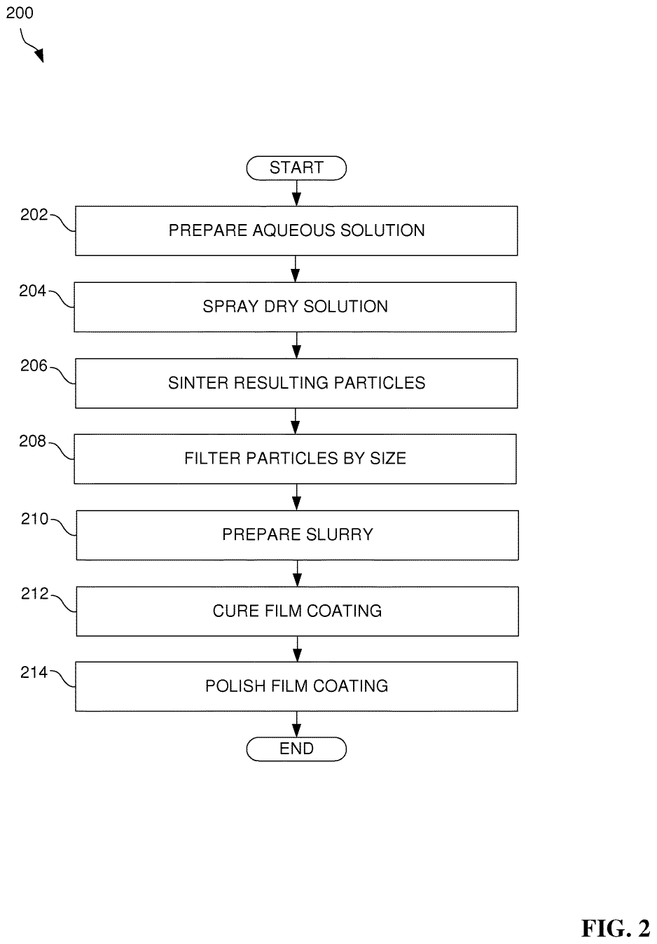

FIG. 2 illustrates a method 200 for creating a solid electrolyte membrane, in accordance with one embodiment. As an option, the method 200 may be implemented in the context of any one or more of the embodiments set forth in any previous and/or subsequent figure(s) and/or description thereof. Of course, however, the method 200 may be implemented in the context of any desired environment. Further, the aforementioned definitions may equally apply to the description below.

As shown, individual particles of the solid electrolyte of choice are prepared (step 202). In one embodiment, in the case of using LiSICON as the solid electrolyte material, an aqueous solution containing a precursor (Li2CO3, LiNO3, Al2O3, TiO2, GeO2, NH4H2PO4) may be spray-dried (step 204) into spherical particles 1 um-1 mm (or even smaller than 1 um) in diameter. It is to be appreciated that the precursors enumerated are not to be construed as only limited thereto. Other precursors may be used that are compatible with the desired and selected solid electrolyte material. Additionally, the particle size may directly influence the resistance for ion transport. For example, a thinner membrane may result in a lower resistance for ion transport. That being said, the membrane may be adjusted such that it is sufficiently thick to prevent any appreciable penetration of water (or a feed solution). The resulting particles are then sintered at high temperature (step 206) in order to densify the particles. The temperature and time of sintering may depend on the selected solid electrolyte material. The densified particles may result in undesired substances (such as water) being prevented from diffusing through the bulk of the aqueous solution, while also homogenizing the distribution of atoms in the particle (which increases Li+ conductivity).

The precursors solution for the solid electrolyte may be composed of salts, inorganic or organic compounds containing the elements of the solid electrolyte. The following tables show possible precursor and candidate materials to result in the solid electrolyte:

TABLE 1
Possible Precursors

| Solid Electrolyte | Precursors |
|---|---|
| LATP | LiNO₃, Al₂O₃, TiO₂, NH₄H₂PO₄ |
| LAGP | LiNO₃, Al₂O₃, GeO₂, NH₄H₂PO₄ |
| LiSICON | LiNO₃, Al₂O₃, GeO₂, TiO₂, NH₄H₂PO₄ |
| LTO | LiNO₃, TiO₂ |
| NaSICON | Na₂CO₃, Al₂O₃, GeO₂, TiO₂, NH₄H₂PO₄ |

TABLE 2
Candidate Materials for Solid Electrolyte
Alkali Metals

| | |
|---|---|
| Li | Li₂CO₃, LiNO₃, LiOH, LiOR (R = Alkyl) |
| Na | Na₂CO₃, NaNO₃, NaOH, NaOR (R = Alkyl) |
| K | K₂CO₃, LiNO₃, KOH, KOR (R = Alkyl) |

Tetravalent Metals

| | |
|---|---|
| Ti | TiO₂, Ti(OR)₄ (R = Alkyl) |
| Si | SiO₂, Si(OR)₄ (R = Alkyl) |
| Ge | GeO₂, Ge(OR)₄ (R = Alkyl) |
| Zr | ZrO₂, Zr(OR)₄ (R = Alkyl) |

Phosphorus

| | |
|---|---|
| P | H₃PO₄, (NH₄)₃₋ₓHₓPO₄ (x = 0, 1, 2) |

Trivalent Metals

| | |
|---|---|
| Al | Al(NO₃)₃, Al₂O₃, Al(OR)₃ (R = Alkyl) |
| Cr | Cr(NO₃)₃, Cr₂O₃, Cr(OR)₃ (R = Alkyl) |
| Ga | Ga(NO₃)₃, Ga₂O₃, Ga(OR)₃ (R = Alkyl) |
| Fe | Fe(NO₃)₃, Fe₂O₃, Fe(OR)₃ (R = Alkyl) |
| Sc | Sc(NO₃)₃, Sc₂O₃, Sc(OR)₃ (R = Alkyl) |
| In | In(NO₃)₃, In₂O₃, In(OR)₃ (R = Alkyl) |
| Lu | Lu(NO₃)₃, Lu₂O₃, Lu(OR)₃ (R = Alkyl) |
| Y | Y(NO₃)₃, Y₂O₃, Y(OR)₃ (R = Alkyl) |
| La | La(NO₃)₃, La₂O₃, La(OR)₃ (R = Alkyl) |
| Eu | Eu(NO₃)₃, Eu₂O₃, Eu(OR)₃ (R = Alkyl) |

where R=any alkyl substituent, including methyl, ethyl, propyl, butyl, isopropyl, isobutyl groups. Notable precursors include titanium isopropoxide (TTIP) for Ti and tetraethyl orthosilicate (TEOS) for Si.

For the lithium-selective membrane, the solid electrolyte may be composed of any NASICON-type Li+ conductor such as LATP, LAGP, LAGTP, LATP, LTASP, LLZP (L=Li if it is the first letter of the anagram, A=Al, T=Ti, G=Ge, L=La if it is not the first letter of the anagram, Z=Zr, S=Si, P=PO₄³⁻). Of the aforementioned electrolytes in the NASICON-type Li+ conductors, any tetravalent metal may be partially or completely substituted with any other tetravalent metal mentioned in the table above, and any of the trivalent metals (Al) may be partially or completely substituted with any other trivalent metal mentioned in the table above. Additionally, any trivalent or tetravalent metal may be partially or completely removed. Other potential solid electrolyte materials may include lithium iron phosphate (LFP), lithium titanium oxide (LTO). Further, the precursors used may depend on the elements used in the solid electrolyte. Of course, for each element selected, a suitable precursor may be listed in the table provided herein.

Additionally, A more than one membrane may be used. For example, as shown in process 800 detailed hereinbelow, a first solid electrolyte membrane may be used to selectively extract lithium from a feed solution, and a second solid electrolyte membrane may be used to transfer ions (such as sodium) from a second electrode into the feed solution (from which the lithium was extracted). In such an embodiment, the second solid electrolyte membrane, the composition may depend on the specific ion to be utilized for the second electrode. For example, in the case of sodium, the solid electrolyte may be composed of any NASICON-type conductor of the form Na₁₊ₓZr₂SiₓP₃₋ₓO₁₂ (0<x<3). For the aforementioned NASICON-type conductor, any tetravalent metal (Zr, Si) may be partially or completely replaced by any other isovalent metal in the table provided hereinabove. Additionally, the electrolyte may be doped with any trivalent metal in the above table. In the case of potassium, the solid electrolyte can be composed of K₂Fe₄O₇. The precursors used may therefore depend on the elements used in the solid electrolyte, where for each element selected, a suitable precursors may be listed in the table provided herein.

Next, the particles may be preferably filtered (step 208) based on size (e.g., using a sieve) to remove the excessively small particles and/or to narrow the size distribution of the batch of particles. Suitable materials for the solid electrolyte materials may include, but not be limited to, NASICON-type Li+ conductors (also known as LiSICON), including LATP/LAGP/LAGTP, as well as lithium titanium oxides (LTO), and lithium iron phosphate (LFP). In general, any material that is water-stable, has Li+ (or whatever alkali metal selected) conductivity of at least 10\hat{ }-6 S/cm, and a dense crystal structure that has a high selectivity for Li+ (or whatever ion is desired) over other ions, may be acceptable as a solid electrolyte material.

In one embodiment, the crystal structure of the solid electrolyte may include a tetrahedra structure (such as ZrO₆), and/or an octahedra structure (such as PO₄, SiO₄, etc.). Additionally, using the process disclosed herein, the microparticles may be sized as needed for efficient membrane ion transfer. For example, a microparticle for the solid electrolyte may be sized at or greater than 100 microns (μm) when used in a membrane with a thickness of 100 microns.

Next, a slurry containing the particles, and matrix (such as epoxy pre-polymers), is casted onto a substrate (step 210) to form a dense coating in which the particles may be embedded in a matrix. In one embodiment, the matrix materials (such as pre-polymers) may function also as a thickener. Additionally, the substrate may include but not be limited to: fluorinated ethylene propylene (FEP), polytetrafluoroethane (PTFE), silicone, polyethylene (PE), polypropylene, kapton, polyethylene terephthalate (PET), etc. Additionally, the substrate may also be composed of one material but coated with one of the aforementioned materials (fluorinated ethylene propylene (FEP), polytetrafluoroethane (PTFE), silicone, polyethylene (PE), polypropylene, kapton, polyethylene terephthalate (PET), etc.) to give the resulting substrate similar or same surface properties enabling delamination of the resulting coating. The film coating is then cured (step 212). As an example, the curing may occur through thermal, and/or UV curing. A result of the curing may include a densely crosslinked matrix.

In various embodiments, suitable materials for the pre-polymers for thermally crosslinked epoxies may include any multifunctional epoxide molecule (Epon828, and/or PEG-DGE, etc.) and amine crosslinkers (melamine, phenylenediamine, and/or jeffamine D-230, etc.). Suitable materials for UV-cured polymers may include multifunctional acrylates/methacrylates (e.g., PEGDMA, and/or PEGDA, Urethane dimethacrylate, bisphenyl A diglycidyl ether acrylate etc.) and photoinitiators (e.g., Darocur 1173). Thermal initiators such as AIBN or BPO may be used in place of a photoinitiator. The crosslinked matrix may have a structure that prevents the diffusion of any substance (most notably water and gases), as a result of its hydrophobic structure and densely crosslinked nature.

Lastly, the film coating is then polished (step 214), including one or both sides, using an abrasive pad. This could be done on a roll-to-roll operation in which the membrane roll with the film coating may be passed through a series of abrasive pads that rotate/slide in order to grind down the surfaces of the membrane, thereby removing the outermost regions of the membrane. After polishing, individual solid electrolyte particles embedded in the membrane may each have large areas of exposed surfaces on both sides of the membrane, providing a route for Li+ ions (or any membrane specific ion) to completely traverse the membrane without the need to travel through multiple particles.

The membrane as discussed herein can be fabricated using web coaters. With respect to scalability of production of such a membrane, as increased battery manufacturing capability comes online to meet growing demand, a single conventional roll-to-roll coater (having a footprint small enough to fit in an office cubicle) can produce enough membrane (such as the solid electrolyte membrane 100) to match each additional 2 GWH of lithium battery manufacturing capacity. Additional web coaters can be added to operate in parallel (as lithium battery manufacturing capacity continues to increase with time). Moreover, these web coaters can be collocated near the battery factory. In this manner, production of the solid electrolyte is space-efficient and scalable, and can satisfy expected industry demands.

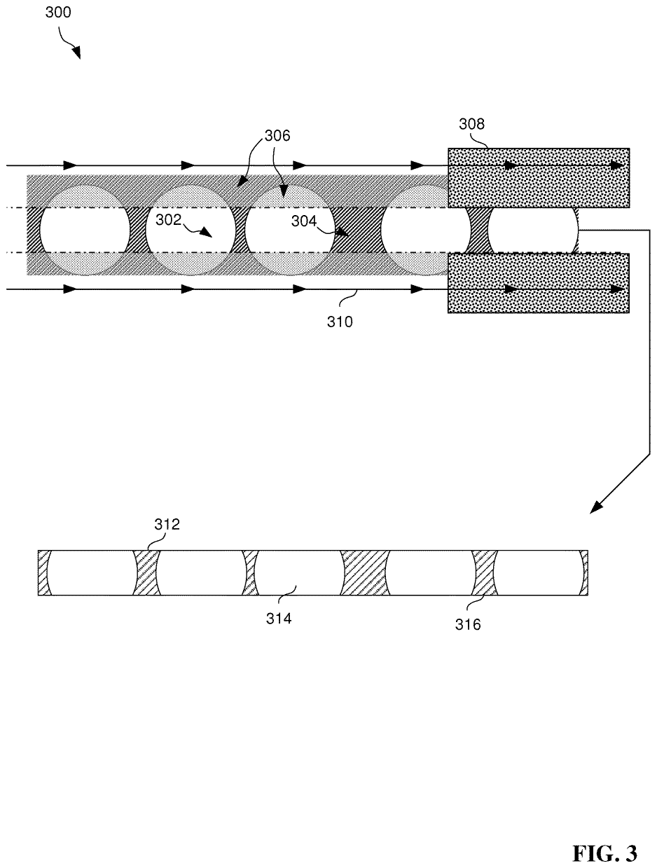

FIG. 3 illustrates a process 300 for mechanical polishing the solid electrolyte membrane, in accordance with one embodiment. As an option, the process 300 may be implemented in the context of any one or more of the embodiments set forth in any previous and/or subsequent figure(s) and/or description thereof. Of course, however, the process 300 may be implemented in the context of any desired environment. Further, the aforementioned definitions may equally apply to the description below.

As shown, the solid electrolyte 302 is embedded within a matrix 304. Mechanical polishers 308 may be used to polish one or more surfaces of the membrane film (containing both the solid electrolyte 302 and the matrix 304). In various embodiments, the solid electrolyte 302 may extend to a surface of the membrane film. In other embodiments, the matrix 304 may extend to a surface of the membrane film. In either case, additional material 306 (either of the solid electrolyte 302 and/or the matrix 304) may be present within the membrane film. In various embodiments, the polishing may occur one side at a time (in series), or both sides simultaneously (assuming both sides polished is desired). Additionally, in one embodiment, a first side may be polished, the coating may then be removed from the release film and transferred to the surface of the electrode (active material coating), where the polished side faces the active material coating, then the resulting laminate is polished once again to expose the solid electrolyte particles on the remaining side.

The membrane film may be polished by passing 310 the membrane film through one or more series of abrasive pads that rotate/slide in order to grind down the surfaces of the membrane film, thereby removing the outermost regions of the membrane film.

After polishing one or more surfaces of the membrane film, polished membrane 312 includes a first exposed surface 314 of the solid electrolyte and a second exposed surface 316 of the matrix. As such, individual solid electrolyte particles embedded in the membrane film may each have large areas of exposed surfaces on both sides of the membrane, providing a route for Li+ ions to completely traverse the membrane without the need to travel through multiple particles.

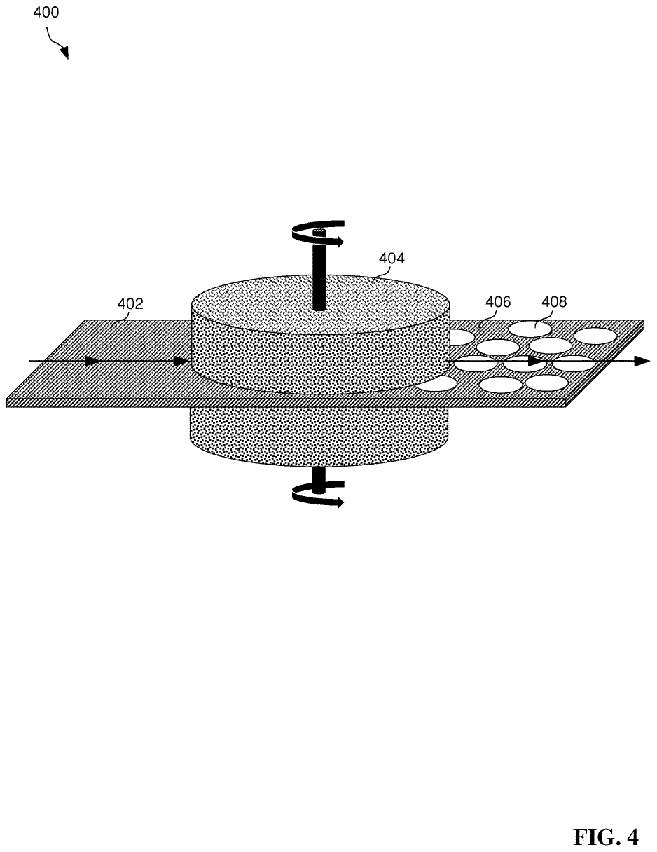

FIG. 4 illustrates a roll-to-roll process 400 for mechanical polishing the solid electrolyte membrane, in accordance with one embodiment. As an option, the roll-to-roll process 400 may be implemented in the context of any one or more of the embodiments set forth in any previous and/or subsequent figure(s) and/or description thereof. Of course, however, the roll-to-roll process 400 may be implemented in the context of any desired environment. Further, the aforementioned definitions may equally apply to the description below.

As shown, a membrane film 402 may be polished on one or more sides (shown as polishing on both sides in the roll-to-roll process 400) using a mechanical polisher 404 (such as an abrasive pad). The roll-to-roll process 400 shows a roll-to-roll operation in which the membrane film 402 roll is passed through a series of mechanical polishers 404 that rotate/slide in order to grind down the surfaces of the membrane film 402, thereby removing the outermost regions of the membrane film 402. After passing through the mechanical polishers 404, a first exposed surface of the matrix 406 and a second exposed surface of the solid electrolyte 408 may be shown.

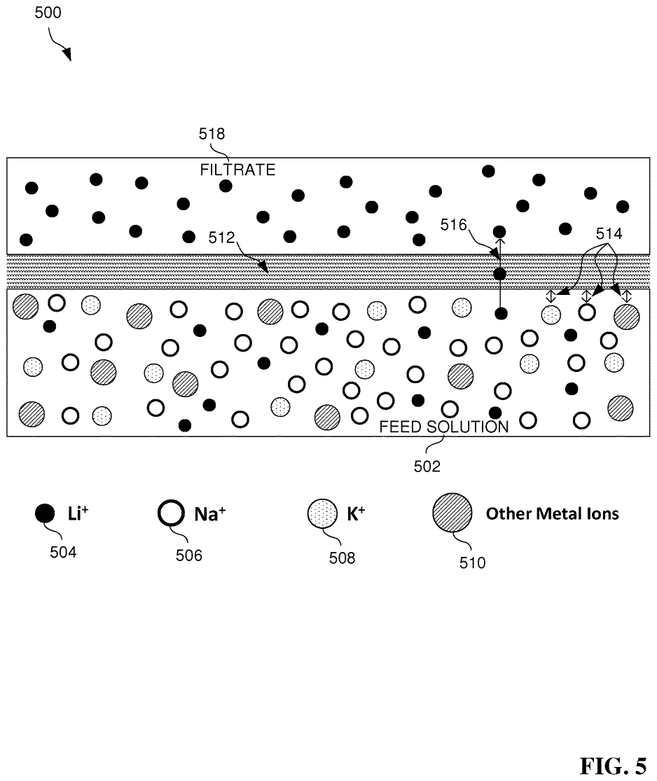

FIG. 5 illustrates an ion-selective solid electrolyte membrane 500, in accordance with one embodiment. As an option, the ion-selective solid electrolyte membrane 500 may be implemented in the context of any one or more of the embodiments set forth in any previous and/or subsequent figure(s) and/or description thereof. Of course, however, the ion-selective solid electrolyte membrane 500 may be implemented in the context of any desired environment. Further, the aforementioned definitions may equally apply to the description below.

As shown, the ion-selective solid electrolyte membrane 500 includes a feed solution 502, which may include a collection of many different types of ions, including but not limited to lithium Li⁺ 504, sodium Na⁺ 506, potassium K⁺, and/or other metal ions 510. The feed solution 502 may additionally include any aqueous solution containing one or more of lithium Li⁺ 504, sodium Na⁺ 506, potassium K⁺, and/or other metal ions 510.

Additionally, a membrane 512 may be used to selectively allow an ion, in this exemplified case, lithium Li⁺ 504, to pass 516 through the membrane 512. In contrast, the membrane 512 may be used to prevent other ions, in this exemplified case, sodium Na⁺ 506, potassium K⁺, and/or other metal ions 510, from passing 514 through the membrane 512. The accumulated ions that pass through the membrane 512 may be found in the filtrate 518.

It is to be appreciated that world demands for lithium continues to increase (especially as demands for electrification of vehicles increase). Using the ion-selective solid electrolyte membrane 500 may allow for extraction of lithium from lithium minerals, as well as from otherwise unused or discarded sources, including but not limited to recycled lithium batteries, and even seawater (especially as seawater contains >99% of the Earth's accessible Li supply). Current systems (such as from Li brines and/or Li minerals) fail to recover lithium (and other alkali metals) from unconventional sources, and/or are problematic (in terms of selectivity, durability, and/or scalability).

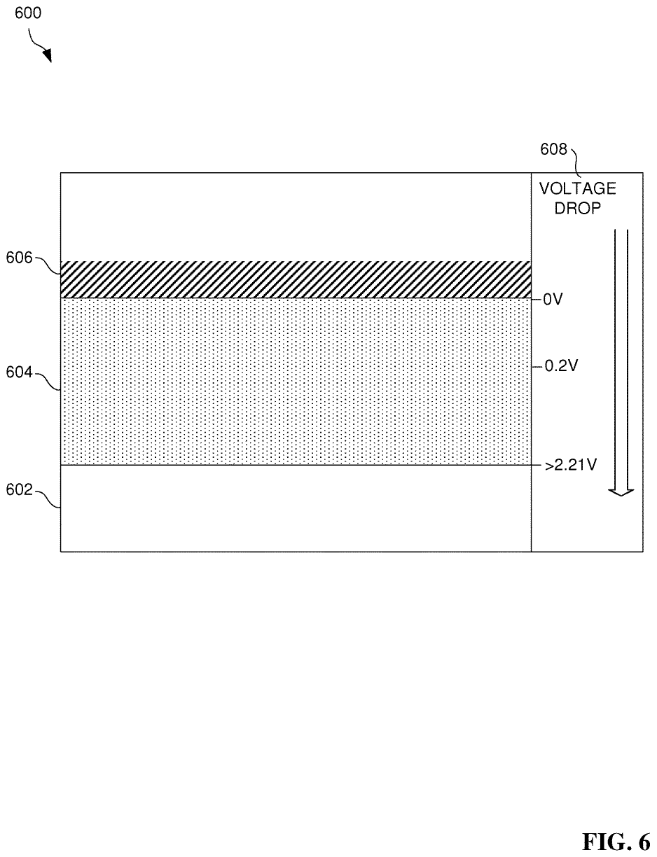

FIG. 6 illustrates voltage drop 600 using a carbon-based membrane, in accordance with one embodiment. As an option, the voltage drop 600 may be implemented in the context of any one or more of the embodiments set forth in any previous and/or subsequent figure(s) and/or description thereof. Of course, however, the voltage drop 600 may be implemented in the context of any desired environment. Further, the aforementioned definitions may equally apply to the description below.

As shown, the voltage drop 600 may occur using a membrane 604. For example, the membrane 604 may be in contact with a feed solution 602 and an electrode 606. As ions pass through the membrane 604, they may experience a voltage drop 608. In various embodiments, the membrane 604 may be carbon-based (without solid electrolyte particles). In this particular embodiment, carbon-based particles may carry lithium ions through capacitive adsorption rather than through the intrinsic crystal structure of the material (as is the case with solid electrolyte particles). It is to be understood, however, that the voltage drop 600 may occur for any type of membrane used (whether it be carbon-based or solid electrolyte particles).

In one particular embodiment (and as an alternative to the membrane 604), the separation membrane may include multiple layers of graphitic carbon. For example a capacitor-like carbon-based membrane may interface and be in contact with the feed solution 602. Additionally, a graphitic carbon membrane may be a second layer within the membrane. It is to be appreciated that any number of layers of graphitic carbon may be used. Based on interaction with the graphitic carbon, the ions that pass through the capacitor-like carbon-based membrane and the graphitic carbon membrane may accumulate as solid metal (such as metallic lithium Li). Further, ions may accumulate at the electrode 606 (which may include but not be limited to graphite). The electrode 606 may be made of low-porosity graphite, prepared via high-temperature sintering of carbonaceous precursors (e.g., polymers such as polyacrylonitrile (PAN)) over prolonged periods of time.

In one embodiment, the membrane 604 and/or the multilayer membrane of graphitic carbon may be configured to selectively extract lithium ions (and/or any preconfigured alkali metal ion) from a precursor/feed solution containing an abundance of the selected ion and other ions. This precursor/feed solution may include lithium-rich brines, an aqueous solution of ions produced upon acid leaching of lithium minerals, an aqueous solution of ions produced via dissolution (with or without acid) of a discarded/recycled battery, sea water, and/or any other aqueous solution containing the desired ions to be extracted.

With respect to the multilayer membrane of graphitic carbon, it may consist of multiple layers (such as the capacitor-like carbon-based membrane, the graphitic carbon membrane, etc.) each composed of various types of carbon.

Additionally, with respect to the graphitic carbon membrane of the multilayer membrane of graphitic carbon, it may be composed of graphitic carbons bound together with a matrix (including polymeric binders such as polyvinylidene fluoride (PVDF), epoxy) and/or compression plates. With respect to the capacitor-like carbon-based membrane, it may be another membrane layer composed of carbon particles bound together via polymeric binders or compression plates (similar to the graphitic carbon membrane).

In one embodiment, regardless of whether the membrane 604 or the multilayer membrane of graphitic carbon is used, as the alkali metal (such as lithium) travels through the membrane, the alkali metal may be electrochemically reduced to its metallic state (such as Li). Additionally, with respect to the membrane 604, the alkali metal may be reduced to its metallic state. As such, an active material (such as graphite) may be chosen with a reduction potential close to that of metallic alkali metal (such as Li), such that the membrane may be in direct electrical contact with the active material, and the current density may be high enough (or the active material may be overcharged) to initiate formation of metallic alkali metal (Li). Further, the cell design may include a separator between the active material coating and the membrane 604 to prevent direct electrical contact. Additionally, if it were desired to plate metallic Li, an electrode could be created with no active material (such that metallic Li may directly plate on the current collector or any electronically-conductive surface in the electrode), and/or the active material may be overcharged such that all available sites for Li insertion into the active material may be occupied (leading to plating of metallic Li upon further charging). It is to be understood that although reduction to a metallic state is feasible, the system may be set to prioritize energy efficiency (which in turn may require low current density demands to reduce energy loss due to ohmic resistance). As such, the system may be modified to prioritize desired outcomes (such as, but not limited to, energy efficiency, metallic reduction, etc.).

In one embodiment, the voltage drop may relate to the stability of the membrane 604 with respect to water. With respect to this particular application, the voltage drop may be either ionic or electronic in nature. Additionally, if the voltage drop were electronic, that may allow for safe operation of the membrane 604 in contact with water.

In this manner, the feed solution 602 may function as an electrolyte, and the electrode 606 may function as an anode. Such phenomenon is illustrated by voltage drop 608. The voltage drop may be due to Ohmic resistance as described by V=IR. The resistance R of the membrane layer(s) may be fixed based on the design, but the voltage drop V varies with the current I that is applied. Since the intercalation of lithium ions into graphite (lithiation) occurs at reduction potentials well below the reduction potential of water, a voltage drop may be necessary in order to prevent the current from reducing water (which would significantly reduce the efficiency of the design). Since the difference in reduction potential of lithium metal and water is 2.21 V (but preferably higher to provide an adequate electrochemical buffer), in one embodiment, the membrane may operate at a current I such that the electrons experience a voltage drop of at least 2.21 V as to not reduce water.

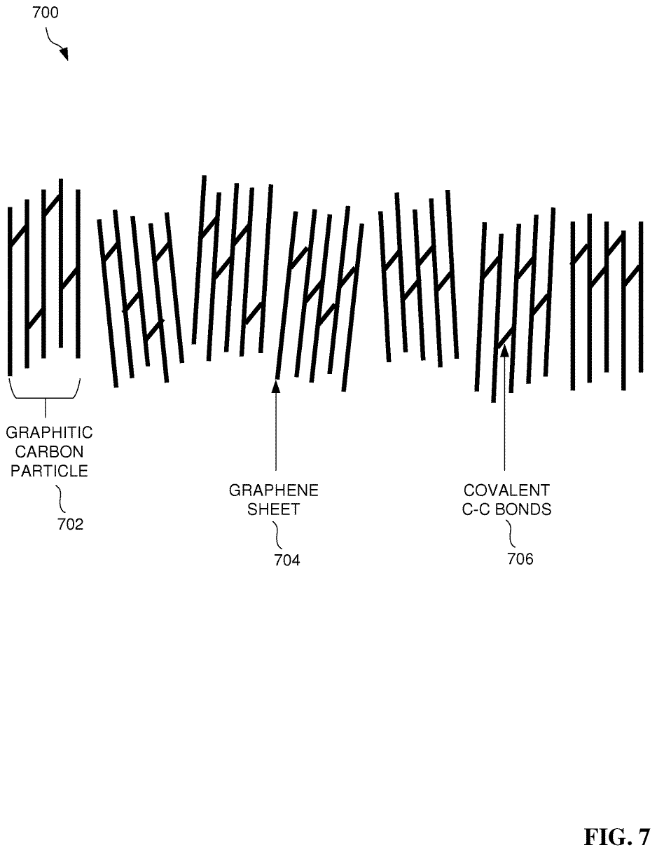

As shown later (in FIG. 7), individual sheets of graphene within the carbon particles (of either or both of the capacitor-like carbon-based membrane and the graphitic carbon membrane of the multilayer membrane of graphitic carbon) may be covalently adhered to one another (as opposed to van der Waals forces). This covalent bond may significantly increase the amount of energy required to push apart the lattices (e.g., it is intolerable to strain). Thus, the sizing of the distance between the sheets of graphene may be tuned to the particular size ion that should pass through the membrane.

In operation, the graphitic carbon particles of the multilayer membrane of graphitic carbon (in either or both of the capacitor-like carbon-based membrane and the graphitic carbon membrane) may extract ions from the feed solution 602 via electrochemical intercalation/adsorption. Since electrochemical intercalation of Li requires the lowest strain (10 vol %) among all ions that are likely to be found in the feed solution 602, the selectivity of Li will be highest. Additionally, by increasing the degree of covalent C—C bonds between adjacent sheets of graphene, the selectivity of Li over other ions is even further enhanced, as a substantial amount of strain would be required for other ions to intercalate. In this manner, an effective voltage drop may occur as the selected ion (such as Li⁺) passes through the capacitor-like membrane and the graphitic carbon membrane of the multilayer membrane of graphitic carbon. In similar manner, as the selected ion (such as Li⁺) passes through the membrane 604, it may also experience an effective volage drop.

In one embodiment, the carbon particles contained in the capacitor-like carbon-based membrane of the multilayer membrane of graphitic carbon may serve multiple purposes. For example, they may serve as an electrical buffer layer between the graphitic carbon membrane and the feed solution 602 (which is likely to be an aqueous solution). Additionally, the carbon particles may extract ions from the feed solution 602 and transport such ions to the graphitic carbon membrane of the multilayer membrane of graphitic carbon.

Additionally, the electrochemical buffering effect may be achieved via the hydrophobic nature of the materials (such as carbon) in the capacitor-like carbon-based membrane, and by a large electrochemical voltage drop across the capacitor-like carbon-based membrane. Such voltage drop 608 may prevent the reduction of water at the interface between the feed solution 602 and the capacitor-like carbon-based membrane of the multilayer membrane of graphitic carbon. This voltage drop is achieved by tuning the thickness and resistivity of the membrane, as governed by Ohm's law (V=IR, where R=(resistivity)*(thickness/area).

As such, alkali metal ions may be extracted via electrochemical and capacitive adsorption of ions on the surface of the carbon particles. By tuning the porosity and surface area of the carbon particles, the kinetics of ion transport can be tuned. Though all ions are possible to adsorb onto the carbon particles, lighter ions and monovalent ions (e.g., alkali metal ions) can move much more rapidly through the membrane 604 (to the electrode 606).

In various embodiments, the design of the membrane 604 can be modified such that the alkali ion (such as lithium) does not fully reduce all the way to its metallic state (such as metallic Li) and/or plate on the surface of the electrode 606.

In one embodiment, reducing the alkali ion to its metallic stage may be limited by making the graphitic carbon membrane substantially larger (in terms of thickness of layer) such that the alkali metal (such as lithium) extracted may be completely contained within the graphitic carbon membrane (and subsequently removed).

In like manner, using the membrane 604 may allow for recovery of the electrical energy used to drive this reaction, reducing the net energy requirement and therefore cost of the material. In other words, energy used to drive the displacement of alkali metals (from a feed solution) to an electrode may, in turn, be stored in the form of electrochemical energy, which may discharged at a later time.

FIG. 7 illustrates a close-up diagram 700 of graphitic carbon, in accordance with one embodiment. As an option, the close-up diagram 700 may be implemented in the context of any one or more of the embodiments set forth in any previous and/or subsequent figure(s) and/or description thereof. Of course, however, the close-up diagram 700 may be implemented in the context of any desired environment. Further, the aforementioned definitions may equally apply to the description below.

As shown, the close up diagram 700 of graphitic carbon includes a graphitic carbon particle 702. Additionally, such graphitic carbon particle 702 (collectively) may include individual graphene sheets 704, where a covalent carbon-carbon bond 706 links the individual graphene sheets 704 together.

In one embodiment, the graphitic carbon membrane 606 described hereinabove may be tuned such that the surface area (of the graphitic carbon particle 702) may be minimized, and the interplanar fusion (e.g., covalent C—C bonds between adjacent sheets of graphene in the lattices) may be maximized.

By decreasing the surface area of the graphitic carbon particle 702, the amount of ions that can be held on the surface of the carbon particles may be greatly decreased, minimizing the amount of undesired ions extracted from the membrane.

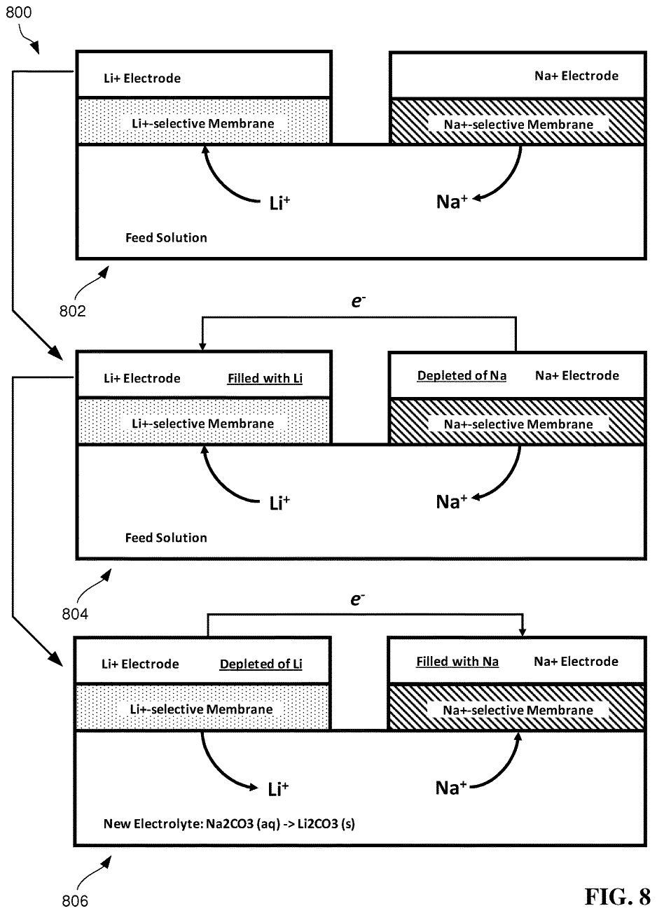

FIG. 8 illustrates a process 800 for recovering energy from lithium extraction, in accordance with one embodiment. As an option, the process 800 may be implemented in the context of any one or more of the embodiments set forth in any previous and/or subsequent figure(s) and/or description thereof. Of course, however, the process 800 may be implemented in the context of any desired environment. Further, the aforementioned definitions may equally apply to the description below.

As shown, step 802 shows lithium present in a feed solution. Two membranes may be interfaced with the feed solution, a first membrane as a lithium selective membrane (consistent with use of the solid electrolyte 102 embedded in the matrix 104 disclosed herein), and a second membrane as a sodium selective membrane. In one embodiment, the sodium selective membrane may use a solid electrolyte embedded in a matrix (similar to the first membrane), but tuned to the particular ion (such as sodium). The first membrane may interface with an electrode, and the second membrane may interface with a second electrode (in other words, a separate electrode for each of the lithium ions and the sodium ions). It is to be appreciated that although lithium and sodium are used in the context of the process 800, the solid electrolyte may be tuned for separation of any particular ion, as disclosed hereinabove. Further, although sodium is shown, any ion which is less reducing than lithium (or the ion to be extracted) may be used.

At step 804, a voltage is applied to the process 800 which, in turn, may cause the lithium ions to transfer from the feed solution to the lithium electrode via the lithium selective membrane. As lithium is removed from the feed solution, sodium ions may be depleted from the sodium electrode (and transfer to the feed solution). Once the lithium ions are stored in the lithium electrode, the energy inputted (to cause the lithium ions to transfer to the lithium electrode) may be stored in the form of electrochemical energy.

At step 806, the feed solution may be changed to a new electrolyte (to such as Na2CO3), and lithium ions stored at the lithium electrode may transfer back to the new electrolyte (which in turn may then form Li2CO3). Sodium ions that were in the new electrolyte may transfer from the new electrolyte to the sodium electrode (via the sodium selective membrane).

The electrochemical energy (stored via the lithium ions on the lithium electrode) may be released with the transfer of the lithium ions from the lithium electrode to the new feed solution (the new electrolyte). In one embodiment, the energy released through the transfer may be stored via any conventional system (such as an external battery, etc.). Such released energy may then be used to drive the process 800 again to extract the ions, which after extraction, the energy may be reclaimed (to drive future extraction of lithium ions). In this manner, once the process 800 is initially established (such that the initial extraction is achieved), energy may be reclaimed, and in turn, used to drive future extraction/separation.

By way of greater detail, the energy required for extraction of lithium from the feed solution into the lithium electrode and for expulsion of lithium from the lithium electrode to the new electrolyte (the final solution) may be dependent on the current density, where a higher current density corresponds with a higher energy need to overcome energy dissipation through ohmic resistance, and the difference in reduction potentials of the electrodes used for the two electrodes (shown as the lithium electrode and the sodium electrode). If the active material for the lithium electrode has a lower reduction potential than the active material for the opposite electrode (shown as the sodium electrode), an input of energy may be required to extract lithium ions from the feed solution (corresponding to the expulsion of the second ion from the opposite electrode, again, shown as the sodium ion from the sodium electrode), which can be recovered when subsequently expelling the lithium from the lithium electrode to the new electrolyte, which may correspond with the extraction of the second ion (shown as sodium) from the new electrolyte to the sodium electrode. If the active material for the lithium electrode has a higher reduction potential than the active material for the opposite electrode (shown as sodium electrode), an input of energy may be required to expel lithium ions from the feed solution (corresponding to the expulsion of the second ion from the opposite electrode), which can be recovered when subsequently extracting lithium from the lithium electrode.

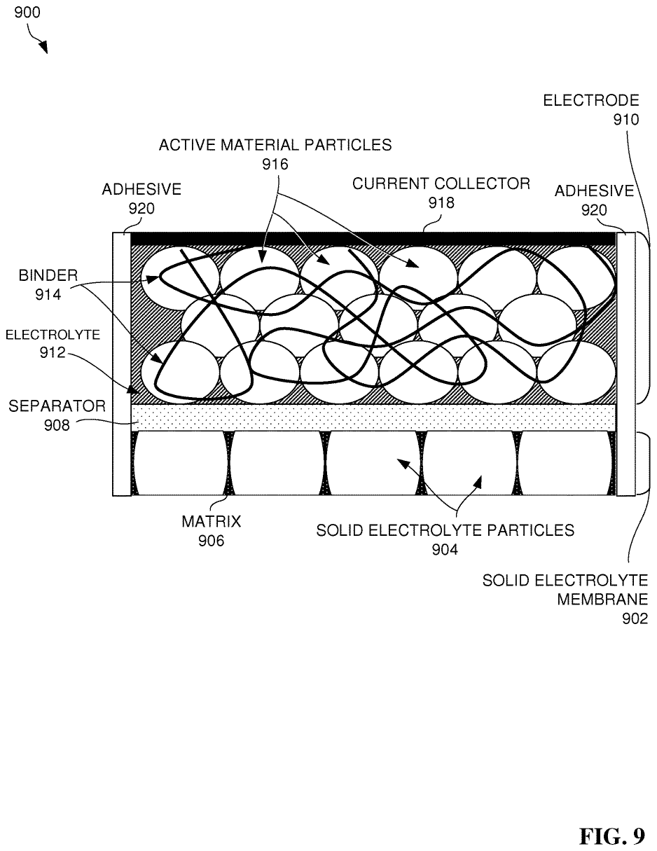

FIG. 9 illustrates a cell architecture 900, in accordance with one embodiment. As an option, the cell architecture 900 may be implemented in the context of any one or more of the embodiments set forth in any previous and/or subsequent figure(s) and/or description thereof. Of course, however, the cell architecture 900 may be implemented in the context of any desired environment. Further, the aforementioned definitions may equally apply to the description below.

As shown, the cell architecture 900 may include a solid electrolyte membrane 902, which in turn, may comprise solid electrolyte particles 904 embedded in a matrix 906. The solid electrolyte membrane 902 may be separated from the electrode 910 via the separator 908. The electrode 910 may comprise an electrolyte 912, a binder(s) 914, active material particles 916, and a current collector 918. An adhesive 920 may line the entirety (on both sides) of the solid electrolyte membrane 902, the separator 908, and the electrode 910.

With respect to the electrode 910, the current collector 918 may serve as an electronically conductive substrate for transferring electricity on which the active material coating is bound on. Additionally, the current collector may be one of the following (but not limited thereto): copper, aluminum, stainless steel, nickel, titanium, graphene.

The active material particles 916 may be the location where alkali metal ions and electrochemical energy are stored. Additionally, the active material particles 916 may serve as a host for the extracted lithium ions and store the energy input for extraction in the form of electrochemical energy.

In various embodiments, suitable electrode materials for a lithium electrode may include, but not be limited to, carbon-based materials (graphite, carbon nanotubes (CNT), graphene, carbon nano onions (CNO), hard carbons), lithium intercalation materials such as lithium titanium oxide (LTO), lithium manganese oxide (LMO), lithium iron phosphate (LFP), lithium manganese phosphate, lithium cobalt phosphate, lithium cobalt oxide (LCO), lithium nickel oxide, lithium nickel manganese cobalt oxide (NMC), lithium nickel cobalt aluminum oxide (NCA), lithium titanium sulfide, lithium vanadium phosphate (LVP), lithium iron sulfate fluoride (LFPF), lithium conversion materials such as halides of the form MXx, where M can be Fe, Co, Ni, Bi, Cu, Ag, and X can be F, Cl, Br, or I, lithium chalcogenides such as S, Se, Te, metals and metalloids that alloy with lithium such as Si, Sn, Ge, Ga, Mg, Al, Zn, In, Au, Ag, Pt, other nonmetals in the group of iodine or oxygen, or lithium metal.

With respect to a sodium electrode (or a less reducing element compared to the ion to be extracted), it may be composed of an active material which may serve as a host for the sodium ion (or whatever ion is selected). In the case of Na+ or K+, the active material may be composed of Fe4[Fe(CN)6]3 (Prussian blue), Prussian blue analogues of the form M1x [M2y(CN)6]3, where M1 and M2 is a metal in the group of Fe, Ni, Cu, Mn, Co, Ti, Cr, Zn, carbon-based materials (graphite, carbon nanotubes (CNT), graphene, carbon nano onions (CNO), hard carbons). In the case of Na+, the active materials may also include materials alloying with sodium such as P, K, or sodium metal. In the case of K+, the active materials may also include materials alloying with potassium such as Na, or potassium metal.

In various embodiments, the active material for the sodium electrode may comprise sodium iron phosphate (NFP). Sodium iron phosphate may function as an intercalation compound configured to reversibly intercalate sodium ions, similar to the Prussian blue and Prussian blue analogue materials described above. The sodium iron phosphate active material may be configured to host sodium ions during extraction operations and release sodium ions during reclamation operations. In some aspects, sodium iron phosphate may be selected as the active material for the sodium electrode based on electrochemical stability, intercalation capacity, and/or compatibility with aqueous electrolyte solutions used in the lithium extraction system.

In one embodiment, the active material particles 916 may also store ions via capacitive/pseudocapacitive mechanisms, such as graphene, carbon nanotubes (CNT), carbon nano onions (CNO), Mxenes, metal oxides, such as ZnO, TiO₂, SnO2, RuO2, Co3O4, MnO2, NiO, NiCo2O4, Fe3O4, Fe2O3, and V2O5.

The binder 914 may adhere the active material particles 916 to the current collector 918 while providing cohesion among active material particles and other additives. The binder 914 may include one or more of the following (but not be limited thereto): poly(vinylidene fluoride) (PVDF), carboxymethylcellulose (CMC), styrene-butadiene rubber (SBR).

The electrolyte 912 may serve as a medium for transporting alkali metal ions to and from the active material (including the active material particles 916) and solid electrolyte membrane 902. The electrolyte may contain one or more salts dissolved in a solvent system of one or more components. The salt may contain one or more of any of the following cations: H+, Li+, Na+, K+, Cs+; and one or more of any of the following anions: Cl—, Br—, I—, NO3—, SO42—, PO43—, PF6—, TFSI—, FSI—, OTf—, ClO4—. The solvent may be one or more of the following: Water, dimethoxyethane (DME), dioxolane (DOL), tetrahydrofuran (THF), dimethyl carbonate (DMC), propylene carbonate (PC), ethylene carbonate (EC), ethyl methyl carbonate (EMC).

Still yet, the separator 908 may optionally serve as a reservoir for the electrolyte 912 and as an electronically insulating barrier between the active material (such as the active material particles 916) and the solid electrolyte membrane 902.

The adhesive 920 may surround the edges of the electrode 910, and may serve as an impermeable barrier between the inside and outside of the electrode 910. The adhesive may be composed of (but not be limited thereto) epoxy, polyurethanes, polyimides, cyanoacrylates, or acrylic adhesives cured via thermal or UV curing.

Still yet, a second electrolyte (including liquid) may be used in the electrode 910. The edges of the electrode 910 may be protected (edge sealant, glue sealant, etc.) to prevent a feed solution from reaching the active material (such as the active material particles 916) through these exposed areas.

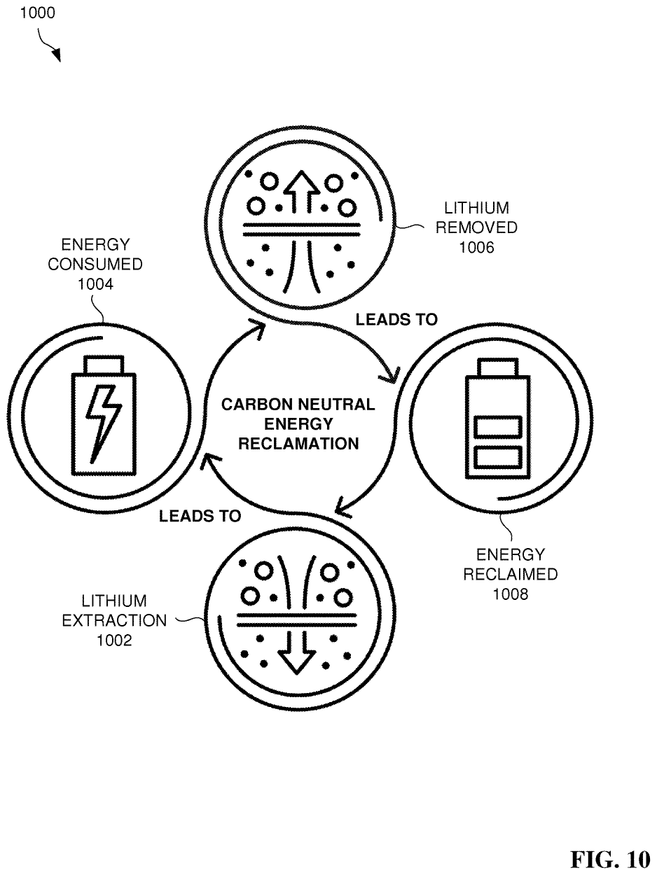

FIG. 10 illustrates a system and method 1000 for a carbon-neutral energy reclamation battery recycling, in accordance with one embodiment. As an option, the system and method 1000 may be implemented in the context of any one or more of the embodiments set forth in any previous and/or subsequent figure(s) and/or description thereof. Of course, however, the system and method 1000 may be implemented in the context of any desired environment. Further, the aforementioned definitions may equally apply to the description below.

FIG. 10 is being presented to illustrate a virtuous cycle that encompasses sustainability of both lithium extraction as well as sustainability of energy reclamation. For example, lithium has become ubiquitous in nearly all electric or electronic products, from batteries to armor plating, from to bicycle frames to glass, from lubricants to ceramics and more. Conventional systems and methods for obtaining lithium extract the lithium from raw materials such as from rocks and/or from mineral springs. It is well known that the global demand for lithium will deplete all known commercially viable sources of such raw materials. It therefore becomes imperative to recycle lithium. One source of lithium that is a candidate for recycling is from used lithium-containing batteries. However, to be sustainable, the techniques for lithium extraction must be highly energy efficient and scalable.

The present description relates not only to extraction methods for lithium, but additionally to how to recover energy spent to extract the lithium. In use, extracting lithium ions from a feed solution using a membrane having a solid electrolyte may cause a voltage drop. The extracted lithium ions may be stored on an electrode. When needed, the lithium ions can then be transferred from the electrode, which in turn, may cause a discharge of the energy stored. In this manner, the extraction, storage, and discharge steps correspond with a typical anode and cathode assembly, and the typical charging/discharging of energy based on the flow of ions.

Additionally, reclamation techniques disclosed herein are scalable so as to be able to meet the forecasted worldwide EV battery recycling demands through this decade and into the decades to follow. To illustrate the needed scale, it is estimated that 10 TWh of EV battery capacity will be demanded between now and the beginning of 2030, with over 1 TWh being demanded in calendar year 2025 alone. This demand, in turn, may require around 125,000 tons (or more) of lithium for EV batteries each year. It is acknowledged that a substantial high percentage of this lithium tonnage can be reclaimed from spent batteries.

In view of this large scale, a primary challenge is reclamation efficiency. The techniques disclosed herein meet this challenge by implementing energy recycling, resulting in an extremely low demand for energy needed to accomplish the lithium reclamation. For example, for a single factory that reclaims 1500 tons of lithium per year, using the energy reclamation techniques disclosed herein, a continuous power demand of only 44KW may be required (a number that is small enough to be provided by banks of solar panels that fit on the roof-space of an EV battery factory). As such, the disclosure herein not only provides for more efficient separation of lithium from feed solution, but additionally provides for significant energy reclamation associated with the lithium extraction.

As such, based on the ability to recover energy spent (to extract) through the discharging of ions may allow for a near carbon-neutral system for ultra-efficient electric battery recycling. As demand for lithium continues to increase, the need to recycle and recover lithium sustainably from preexisting lithium-containing items will likewise increase. Additionally, with the push for more green energy, the present description provides for recovery of a substantial fraction of energy spent for extracting lithium ions, which in turn results in an environmentally prudent and responsible alternative to known methods and systems.

Additionally, known separation membranes often will crack and fail as time goes on, resulting in both time inefficiencies and fiscal losses (in having to replace the electrolyte). Further, other membranes (e.g., adsorption membranes, etc.) may have membrane fouling, which in turn, may decrease the efficiency and lifetime of the membrane. The membrane disclosed herein, in contrast, is bound in a stable matrix that does not suffer from (or have much less of) membrane fouling or membrane cracking (e.g., as a consequence of volume expansion during extraction, etc.), which in turn, increases longevity of the electrolyte and the membrane, thereby overcoming said inefficiencies and losses.

As shown, the system and method 100 includes extracting lithium (step 1002). The extraction of lithium may occur using a solid electrolyte membrane (such as the solid electrolyte membrane 100, detailed herein). In extracting the lithium, energy may be consumed (step 1004).

In one embodiment, a voltage drop (such as the voltage drop 608 due to transporting of lithium ions) may be due to ohmic resistance (V=IR). Since I (or desired current I) is generally dictated by a desired extraction rate of Li, an extractor may be configured to minimize R in order to result in the lowest voltage drop V (corresponding to, for example, unreclaimable electricity). Since resistance is proportional to the membrane thickness and inversely proportional to conductivity, the system may be constructed to use charge-conducting components (e.g., such as the Li+ extraction membrane) with minimal thickness and maximum conductivity.

The lithium ions that are extracted are stored on an electrode. When the energy is needed, a second electrolyte may be used to facilitate the removal and transfer of lithium ions from the electrode (step 1006). In removing and transferring the lithium ions from the electrode, energy may be reclaimed (step 1008).

In operation, therefore, lithium may be extracted from a feed solution using a first membrane, stored on an electrode, and then transferred out using an electrolyte solution. The energy required to extract the lithium ions from the feed solution may be recovered when the lithium ions are transferred from the electrode. Once the lithium ions are transferred out (to the electrolyte solution), the lithium ions may be in the form of lithium carbonate (or an equivalent thereof). In operation, as the lithium is extracted (per step 1002), it may be removed from the feed solution and stored on the electrode. As lithium ions are transported from the feed solution, they may be, in turn, replaced with other ions (such as sodium) which may be transported from a second electrode, through a second membrane and into the feed solution. At a later time, the feed solution may be removed and replaced with an electrolyte solution. For example, in various embodiments, the membrane may be physically removed from the feed solution (like a sponge is removed from a bath), or the membrane may be immersed in a tank containing the electrolyte solution (where the electrolyte solutions can be pumped in/out to change the electrolyte solution. In another embodiment, the extracted lithium may be put into a new solution without needing to replace the original feed solution.

The lithium ions stored on the electrode may then be transported from the electrode to the electrolyte solution. This removal of lithium ions (and transporting of them via the membrane) may cause an energy release which may be reclaimed (via an external battery, for example). In other words, the energy stored in the form of electrochemical energy of the extracted lithium may be reclaimed upon removal of the lithium. As lithium ions move from the electrode to the electrolyte solution, another ion (such as sodium) present in the electrolyte solution may transfer (via the second membrane) to the second electrode. In this manner, as lithium is transported to the electrode, energy may be consumed, and as lithium is transferred from the electrode, energy may be released. This release of energy may, in turn, be used to provide most of the input energy needed for the lithium extraction (via the lithium extraction step 1002 and the energy consumed step 1004).

As such, therefore, the operation of extracting the lithium ions, storing, and then discharging mimics energy charge and discharge cycles of a battery, which in turn, may provide high energy efficiency (due to the recovery of energy inputted).

With respect to the feed solution, previously used and spent batteries may be added to the aqueous solution, and may be the basis from which the lithium ions may be extracted. If it were desired to have greater selectivity (for example of lithium ions), the first membrane (used to extract the lithium ions) may be thickened. To clarify, a thicker membrane may have lower permeation (rate of diffusion through) of water by virtue of a longer distance that the water may need to travel through. As such, a thicker membrane may have a higher selectivity for Li+ uptake via electrodialysis over water uptake via diffusion. Additionally, in one embodiment, the greater the thickness, the greater the voltage drop as well. In other words, the voltage drop may scale linearly with thickness, since resistance scales linearly with thickness.

For example, the first membrane may be tuned to the ion that is to pass through it. In this manner, the membrane may be tuned such that a larger ion, for example, may pass through a first membrane layer, and a smaller ion, for example, may pass through a second membrane layer. For example, a solid electrolyte material may be selected whose crystal structures have inherent selectivity for the desired ion. The ease at which a specific ion may pass through the solid electrolyte material may depend on the amount of energy it takes for ions to “hop” through different sites of the crystal lattice. Ions that are too large or too small will require more energy to hop from site to site. As such, for any given solid electrolyte structure, an “optimal” ion size with the lowest activation energy (and therefore the highest ionic conductivity and selectivity over other ions) may be tuned to the particular solid electrolyte structure. In this manner, a structure of the crystal lattice (of the solid electrolyte) may be tuned for a specific ion (where if the activation energy is too high, it simply will not pass through the membrane, or it will pass through in small or insignificant quantities.

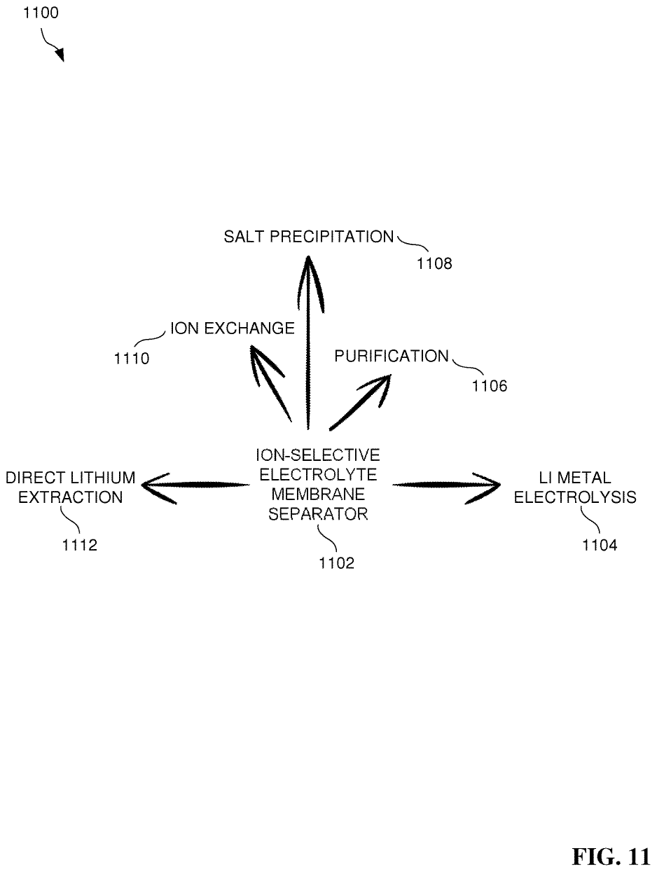

FIG. 11 illustrates various processes 1100 where an ion-selective electrolyte membrane separator may be incorporated, in accordance with one embodiment. As an option, the various processes 1100 may be implemented in the context of any one or more of the embodiments set forth in any previous and/or subsequent figure(s) and/or description thereof. Of course, however, the various processes 1100 may be implemented in the context of any desired environment. Further, the aforementioned definitions may equally apply to the description below.

In one embodiment, the ion-selective electrolyte membrane separator 1102 may comprise multiple layers of membrane to help further facilitate various ion-oriented processes including, but not limited to purification 1106, salt precipitation 1108, ion exchange 1110, direct lithium extraction 1112, and/or electrolysis 1104.

The ion-selective electrolyte membrane separator 1102 may be applied consistent with the discussion relating to any of the prior (or subsequent) Figures. As shown at a high level, the application of the ion-selective electrolyte membrane separator 1102 may apply to many processes and industries. In particular, such an application may apply to critical mineral industry which may have need of the purification 1106, the salt precipitation 1108, the ion exchange 1110, the direct lithium extraction 1112, and/or the electrolysis 1104. It is to be understood that although much discussion within the present description focuses on lithium, the application of the ion-selective electrolyte membrane separator 1102 may apply equally to any critical mineral.

In one embodiment, existing direct lithium extraction (DLE) battery technology may be used to develop a DLE cell that electrochemically extracts lithium from various brines using an ion-selective solid electrolyte membrane disclosed herein. In operation, DLE cells in combination with the ion-selective solid electrolyte membrane 1102 may be used to convert untapped deposits including, but not limited to, recycled materials, lithium-based alloys, and/or solutions containing atoms such as lithium hydroxide into high-volume sources of lithium. As a result, the resulting lithium may then support production of greater volumes of EV batteries.

In one embodiment, a composition, density, and/or structure of complex brines and the ion-selective electrolyte membrane may be mapped via high-fidelity synchrotron X-ray based imaging, diffraction, and/or spectroscopy.

In one embodiment, electrolyte membrane-assisted direct lithium extraction 1112 may include applications upon lithium battery cell materials, membranes, and/or cell design, which may result in optimized systems capable of pilot-scale (≥1,000 T/year pure lithium basis) extraction of lithium from geothermal brines. Additionally, such electrolyte membrane-assisted direct lithium extraction 1112 practices may be designed to assist accompanying economic and environmental analyses.

In one embodiment, sodium (Na) super ionic conductor (NASICON)-type ceramic electrolytes such as lithium aluminum titanium phosphate (LATP) and lithium aluminum germanium phosphate (LAGP), which have previously been demonstrated to be stable in water and known to have high charge-transport selectivity for lithium ions (Li+) over common ions such as sodium (Na+) and magnesium (Mg²⁺), may be embedded in an impermeable matrix wherein Li+ is selectively removed from a solution under the influence of an electric potential across the membrane. In addition, the ion-selective electrolyte membrane separator 1102 may be incorporated into a cell design consisting of two electrodes immersed in separate electrolytes, wherein one cell is configured to reversibly store Li+ and the other cell is configured to reversibly store Na+. Such a construction may provide a low-cost, environmentally-benign-waste product. Additionally, each electrolyte may contain a pair of ferricyanide (Fe(CN)₆]³⁻/⁴⁻) electroactive solutes and the alkali metal ion that it may be configured to store. Further, in one implementation, the electrochemical cell design may result from the layering of individual electrode modules assembled into a lithium extractor.

In another embodiment, the electrochemical cell (such as for direct lithium extraction 1112) may be configured to extract Li+ from geothermal brine and produce a solid lithium salt product, lithium carbonate (Li₂CO₃), via a two-step process. It is noted that other resulting products may be provided as desired (based on the electrolyte solution, the precursor, the configuration of the membrane, etc.). In operation, one step may comprise a process for Li+ extraction in which all Na+ electrode modules may be loaded with Na+ at maximum capacity and Li+ modules may be loaded at minimum capacity. Additionally, under steady-state operation, brine may be pumped through the Li extractor and a charge may be transferred from ferrocyanide (Fe(CN)₆]⁴⁻) within Na+ electrodes to ferricyanide in Li+ electrodes. Correspondingly, Li+ from the brine may be selectively transported into Li+ modules, and Na+ transported from Na+ modules into the brine as waste. In further operation, a second step may comprise a process for Li+ reclamation in which an aqueous solution of sodium carbonate (Na₂CO₃) and saturated lithium carbonate may be pumped from a silo into the extractor where it may completely replace the brine. In addition, under batch operation, charge may be transferred from the Li+ modules to the Na+ modules. Correspondingly, Li+ may be transported from the Li+ modules into the carbonate salt solution, and Na+ may be selectively transported into the Na+ modules, resulting in the precipitation (such as the salt precipitation 1108) of solid lithium carbonate that may be collected (such as in a decanter) at the bottom of the Li extractor and reconstitution of the lithium extractor into its initial state.

Current, electrochemical DLE methods historically require fragile active material electrode coatings to directly contact brine, produce toxic byproducts, or utilize non-scalable fabrication processes, limiting their viability. In contrast, the direct lithium extraction 1112 (which in particular uses the ion-selective electrolyte membrane separator 1102) may not require any active material electrode coatings, such as those used in lithium-ion batteries, which may significantly reduce cost and circumvent issues of stability in brines pumped through DLEs. In addition, other advantages may include environmentally responsible measures that may produce Na+ as waste product and may use no acid reagents, scalable ion-selective membranes which may be produced via roll-to-roll coating and polishing, robust designs featuring durable membranes which may protect vulnerable components from geothermal brine, highly selective lithium ion membrane technology which may be based on size and charge fitting of ion in solid electrolyte, adequate performance based on low-cost materials including, but not limited to, lithium, aluminum, titanium, sodium, silicon, zirconium, and iron, and/or a capacity to operate at low Li+ concentrations, which may potentially include seawater, thus diversifying Li+ resources.

In one embodiment, a Lit-selective membrane with bulk ionic resistance of 1,000 (per cm2 may be produced for membranes of sub-mm thickness based on reported conductivity values of NASICON-type conductors. It should be noted that Na+ conductors may have less resistance than Li+ analogues and may thereby be assumed to be inconsequential. Further, at an operating potential of 0.4 V (within the 1.23 V electrochemical stability window for H2O) and 10 hours of Li+ extraction per day, 4 mAh worth of Li (1 gram Li=3,860 mAh) may be extracted per cm2 of membrane per day. As a result, a 1,000 T pure Li/year target may thus meet with approximately 300,000 m2 of each membrane.

The ion-selective electrolyte membrane separator 1102 may, in like manner, be used for the ion exchange 1110, the salt precipitation 1108, the purification 1106, and/or the lithium metal electrolysis 1104, all of which are detailed hereinbelow. As such, the technology disclosed herein relate to critical mineral extraction, purification, exchange, etc. may be viable for long-term DLE from feed solutions (such as geothermal brine).

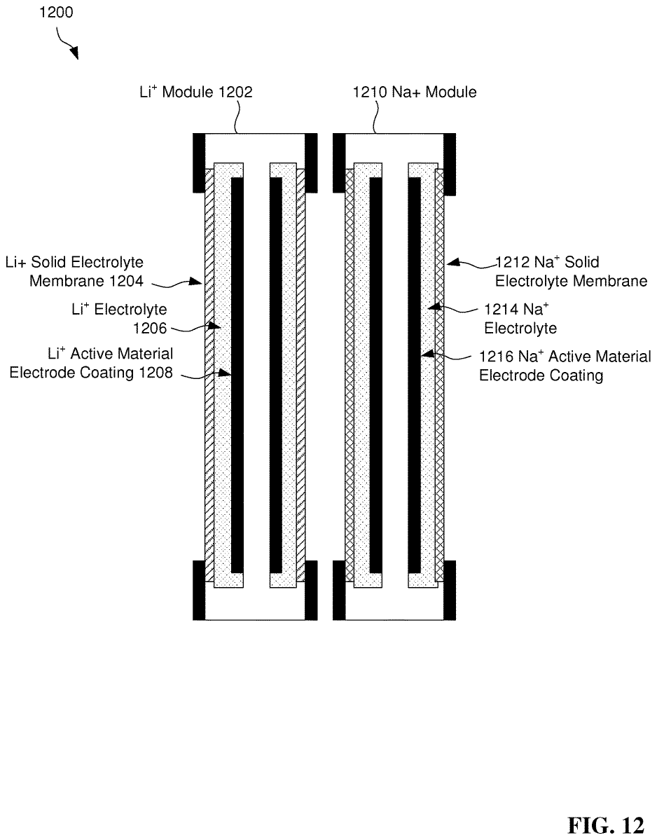

FIG. 12 illustrates electrode modules 1200, in accordance with one embodiment. As an option, the electrode modules 1200 may be implemented in the context of any one or more of the embodiments set forth in any previous and/or subsequent figure(s) and/or description thereof. Of course, however, the electrode modules 1200 may be implemented in the context of any desired environment. Further, the aforementioned definitions may equally apply to the description below.

As shown, the electrode modules 1200 may include a lithium module 1202 (functioning as an anode) comprising a Li⁺ solid electrolyte membrane 1204, a Li⁺ electrolyte 1206, and Li⁺ active material electrode coating 1208. In like manner, the electrode modules 1200 may include a sodium module 1210 (functioning as a cathode) comprising a Na⁺ solid electrolyte membrane 1212, a Na⁺ electrolyte 1214, and a Na⁺ active material electrode coating 1216. It is to be appreciated that, in order to function as a redox system, both an anode and a cathode would be needed. For simplicity, the redox electrode module is presented in a singular form (a single module electrode) to describe the elements of the module that are consistent for either and/or both of the anode module and the cathode module.

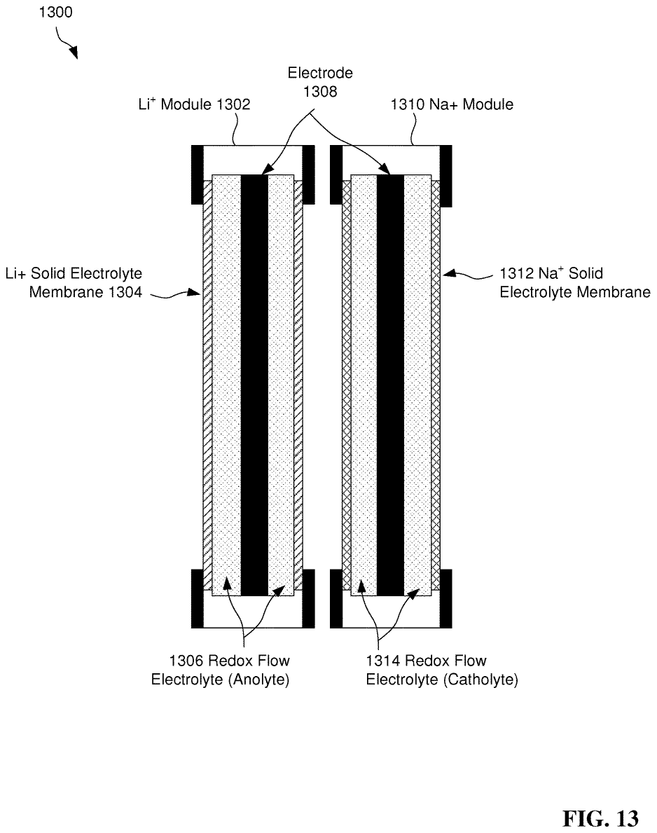

The Li⁺ solid electrolyte membrane 1204 may interface with a feed solution. Additionally, in one embodiment, the Li⁺ electrolyte 1206 may function as an anolyte, and the Na⁺ electrolyte 1214 may function as a catholyte. Taking a step back, FIG. 12 may depict an electrode module design that uses active material coatings (such as those found in lithium-ion and sodium-ion batteries). Further, FIG. 13 (shown and described hereinbelow) is a variation of FIG. 12 that uses “redox flow” active materials (including electroactive solutes). In addition, a redox flow electrolyte may comprise one or more electroactive solutes. In one embodiment, each electroactive solute may be characterized by its ability to adopt multiple oxidation states whose relative concentrations within the electrolyte may be manipulated through the addition or removal of charge (electrons) from the electrolyte. Further, the redox flow electrolyte may include one or more dissolved alkali metal cations. Further, the redox flow electrolyte may include one or more dissolved anions to balance the charge of cations in the solution. The current collector may be in direct contact with the redox flow electrolyte.

In operation, the lithium electrode module 1200 may be used to separate lithium from a feed solution (via the Li⁺ solid electrolyte membrane 1204). Additional details relating to the separation of lithium via the solid electrolyte membrane 1204 may be found in relation to the disclosure of FIG. 1—FIG. 6 hereinabove. In practice, the solid electrolyte membrane may interface directly with the redox flow electrolyte, on one side, and a feed solution on the other side. The feed solution may comprise ions which may be effectively separated from the feed solution via the solid electrolyte membrane. The solid electrolyte membrane may be tuned to selectively separate desired ions from the feed solution. In other words, the solid electrolyte membrane may be configured to allow selective passage of a specific alkali metal cation.

In operation, the ion module may be configured as an anode electrode module or a cathode electrode module. Once again, it is emphasized that the redox electrode module is shown in singularity (with a single module). FIG. 13 discussed hereinbelow displays redox electrode modules 1300 including both an anode electrode module and a cathode electrode module.

Further, the electrode modules 1200 may be used to reclaim energy used during the separation process. For example, as lithium is extracted, it may be stored in the form of electrochemical energy which may be subsequently released.

FIG. 13 illustrates redox electrode modules 1300, in accordance with one embodiment. As an option, the redox electrode modules 1300 may be implemented in the context of any one or more of the embodiments set forth in any previous and/or subsequent figure(s) and/or description thereof. Of course, however, the redox electrode modules 1300 may be implemented in the context of any desired environment. Further, the aforementioned definitions may equally apply to the description below.

As shown the redox electrode modules 1300 includes the lithium (Li⁺) module 1302, the Li⁺ solid electrolyte membrane 1304, the redox flow electrolyte 1306, the electrode 1308, the sodium (Na⁺) module 1310, the Na⁺ solid electrolyte membrane 1312, and a redox flow electrolyte 1314. The lithium module 1302 may function as an electrode for an anode, and the sodium module 1310 may function as an electrode for a cathode. In like manner, the redox flow electrolyte 1306 may function as an anolyte and the redox flow electrolyte 1314 may function as a catholyte. In one embodiment, the redox flow electrolyte 1306 and the redox flow electrolyte 1314 may contain electractive solutes that function as an active material.

In practice, the redox electrode modules 1300 may be used for the separation of ions (such as lithium) from a feed solution via the use of the Li⁺ solid electrolyte membrane 1304 and the Na⁺ solid electrolyte 1312 (each of which may be ion-selective), and redox flow electrodes (such as the lithium module 1302 and the sodium module 1310). Such an invention can be used for the selective extraction of Li⁺ from a suitable feed source. For example, the suitable feed solution may include lithium (or other ions, etc.) brines, seawater, and/or a solution prepared from recycled battery waste. In one embodiment, the lithium solid electrolyte membrane 1304 and/or the sodium solid electrolyte membrane 1312 may be constructed in a manner consistent, e.g., with FIG. 1-FIG. 6.

In one embodiment, the feed solution may be a first solution and may include a target alkali metal ion (or H+) that is desired to be selectively removed from the rest of the solution. Additionally, a second solution, where a target alkali metal ion (or H+) may be removed from the first solution may be discharged to the second solution during the separation process.

The second solution may contain a dissolved alkali metal ion (or H+) that may be discharged into the feed solution (the first solution) as a waste product during the process. In one embodiment, the anion within the second solution may be selected as desired. The second solution may also include one or more other dissolved salts as desired. When applied as an extraction system for Li+, the second solution may contain Na⁺ ions in the form of dissolved Na₂CO₃, where the Na⁺ cations may be used as the eventual waste product discharged into the feed solution, while the carbonate anions (CO₃²⁻) may serve as the anion that combines with the extracted Li⁺ ions to form Li₂CO₃. In one embodiment, the second solution may include saturated Li₂CO₃ as a second dissolved species to facilitate the removal of the extracted Li⁺ ions in the form of Li₂CO₃ via precipitation.

In one embodiment, the two electrode modules (including the lithium module 1302 and the sodium module 1310) may include an “anode” electrode module and another as a “cathode” electrode module. Each of the lithium module 1302 and the sodium module 1310 may include an electrolyte solution. In the context of the present description, the electrolyte for the “anode” electrode module may be referred to as the “anolyte” (such as the redox flow electrolyte 1306), and the electrolyte for the “cathode” electrode module may be referred to as the “catholyte” (such as the redox flow electrolyte 1314). Each of the redox flow electrolyte 1306 and the redox flow electrolyte 1314 may include one or more electroactive solutes. In one embodiment, each electroactive solute may be characterized by its ability to adopt multiple oxidation states whose relative concentrations within the electrolyte may be manipulated through the addition or removal of charge (electrons) from the electrolyte. For example, the electroactive solute may include, but not be limited to: ferricyanide/ferrocyanide ([Fe(CN)₆]³⁻/[Fe(CN)₆]⁴⁻), pervanadyl/vanadyl (VO₂⁺/VO²⁺), phosphotungstic acid and its various redox states ([PW₁₂O₄₀]³⁻/[P₂W₂₁O₇₁]⁶⁻/[PW₁₁O₃₉]⁷⁻, etc.), phosphomolybdic acid and its various redox states, and/or silicotungstic acid and its various redox states. In one embodiment, the same electroactive solutes or set of electroactive solutes may be used for both the anolyte and catholyte.

Additionally, each of the redox flow electrolyte 1306 and the redox flow electrolyte 1314 may include one or more dissolved alkali metal cations. In one embodiment, each electrolyte may contain one type of alkali metal cation (or H⁺), depending on the ion that the system is configured to extract and/or expel as a waste product in the process. Further, each of the redox flow electrolyte 1306 and the redox flow electrolyte 1314 may include one or more dissolved anions to balance the charge of cations in the solution. In one embodiment, the electroactive solute(s) may serve as the dissolved anions if the dissolved anions are anionic. Still yet, each of the redox flow electrolyte 1306 and the redox flow electrolyte 1314 may include a solvent including but not limited to water, an alcohol, a carbonate, and/or an ether-based solvent.

As shown, the electrode 1308 may be in direct contact with the electrolyte solution (such as the redox flow electrolyte 1306 and the redox flow electrolyte 1314). The electrode 1308 may be electronically conductive (such as a metal or carbon-based material). The electrode 1308 may also be porous or non-porous. In one embodiment, a non-porous current collection may be selected in order to increase the surface area of contact between the electrode 1308 and either or both of the redox flow electrolyte 1306 and/or the redox flow electrolyte 1314. Further, the electrode 1308 may be constructed of, but not limited to aluminum, nickel, copper, titanium, stainless steel, graphite felt, and/or carbon fiber. The electrode 1308 may also be a carbon-based material coated onto the surface of a metallic substrate. Still yet, the electrode 1308 may include meshed aluminum (or any desired material in meshed structure).

In one embodiment, an ion-selective solid electrolyte membrane (such as the lithium solid electrolyte membrane 1304 and/or the sodium solid electrolyte membrane 1312) may be configured to allow selective passage of a specific alkali metal cation (or H⁺). The positioning of the ion-selective solid electrolyte membrane may be chosen such that it separates the feed solution (first solution) and a second solution from contacting the redox flow electrolyte 1306 and/or the redox flow electrolyte 1314, the electrode 1308, and/or any other electronically-conductive parts of each of the lithium module 1302 and/or the sodium module 1310 used to transfer charge to/from each module. In this way, only the target alkali metal cation (or H⁺) may be able to transfer to/from the feed solution (first solution) and the second solution to the electrolyte solution (such as the redox flow electrolyte 1306 and/or the redox flow electrolyte 1314).

With respect to the lithium solid electrolyte membrane 1304 and/or the sodium solid electrolyte membrane 1312, each or both may consist of a matrix (used as a durable, impermeable scaffold for the membrane), and solid electrolyte particles (selected on the basis of the ion that the membrane is designed to allow selective passage through). In the case where H⁺ is the ion of choice, Nafion may function as both the matrix and the ion-selective material, circumventing the need for a solid electrolyte particle.

In one embodiment, the lithium module 1302 and/or the sodium module may include a structural framework, which maybe designed in such a way to sequester the redox flow electrolyte 1306, the redox flow electrolyte 1314, and/or the electrode 1308 from the external environment. One or more surfaces of the structural framework may be composed of the ion-selective solid electrolyte membrane (such as the lithium solid electrolyte membrane 1304 and/or the sodium solid electrolyte membrane 1312) to enable selective passage of the desired alkali metal ion (or H⁺) to/from the exterior of the module/framework to the interior of the module/framework.

In various embodiments, the traditional concept of “discharge” and “charge” may not necessarily apply to the redox electrode modules 1300, particularly in the case where the same set of electroactive solutes may be used for both the lithium module 1302 and/or the sodium module 1312. For example, a single step of charge transfer between the lithium module 1302 and the sodium module 1310 may include both the input of energy and reclamation of energy. In this case, the “anode” electrode module (such as the lithium module 1302) may be the module with the lower mean potential (as current may be transferred between electrode modules throughout the extraction/reclamation steps), and the “cathode” electrode module (such as the sodium module 1310) may be the module with the higher mean potential (as current may be transferred between electrode modules throughout the extraction/reclamation steps).

In the case where the mean potential of each electrode module is equal throughout the extraction/reclamation steps, the “anode” electrode module may be identified by any method convenient to the user. In the context of a Li⁺ extraction system, the “anode” electrode module may be referred to as the module that receives charge as Li⁺ may be selectively removed from the feed solution to the electrode module (such as the lithium module 1302).

When the redox electrode modules 1300 is utilized as a system for extracting Li⁺ from a feed solution (such as a Lit-containing brine), the following steps may be used: 1) extraction; and 2) reclamation.

With respect to the step of extraction, a feed solution may be fed between the cathode/anode modules. To initiate removal of Li⁺ from the feed solution, a current may be flowed from the cathode electrode module to the anode electrode module. During this step, the electroactive solute in the cathode electrode module may be oxidized, coinciding with the removal of the alkali metal ion or H⁺ within the catholyte into the feed solution through the solid electrolyte membrane of the cathode electrode module. Additionally, the electrons fed from the cathode electrode module to the anode electrode module may result in the reduction of the electroactive solute in the anode electrode module and the selective transfer of Li⁺ from the feed solution to the anolyte. In this manner, the Li⁺ ions extracted from the feed solution may be temporarily stored within the anolyte, while the alkali metal ions or H+ initially contained within the catholyte may be expelled to the feed solution as a waste product.

With respect to the step of reclamation, a second solution may be fed between the cathode/anode modules. The second solution may contain saturated Li₂CO₃ and a carbonate salt (such as Na₂CO₃), depending on what alkali metal ion the cathode electrode module may be configured to selectively remove. To initiate the reclamation of Li⁺ and precipitation of Li₂CO₃, a charge may be transferred from the anode electrode module to the cathode electrode module. During this step, the electroactive solute in the anode electrode module may be oxidized, coinciding with the removal of the Li+ within the anolyte into the feed solution through the solid electrolyte membrane of the anode electrode module. Additionally, the electrons fed from the anode electrode module (such as the lithium module 1302) to the cathode electrode module (such as the sodium module 1310) results in the reduction of the electroactive solute in the cathode electrode module and the selective transfer of Na+ (or any other alkali metal ion or H+ that the cathode electrode module is configured to transport) from the feed solution to the catholyte. In this manner, the alkali metal ions or H+ extracted from the feed solution may be temporarily stored within the catholyte, restoring the system to its initial state before the preceding extraction state.

In one embodiment, the redox electrode modules 1300 may be used for grid-scale energy storage. It is noted that theoretically, the redox electrode modules 1300 may function for grid-scale energy storage with any electroactive solutes (although it may be better to use different active materials for each side so that the voltage of the cell is higher). Additionally, in one embodiment, solvents used in the redox electrode modules 1300 may be used as both an electrode and an electrolyte.

In one embodiment, electroactive solutes used for vanadium redox flow batteries (pervanadyl (VO2+), vanadyl (VO2+), V2+, V3+) may be viable substitutes for the electroactive solutes discussed herein ([Fe(CN)6]3−/4-).

Conventional lithium extraction systems from Li-containing brines may often comprise a multi-step process requiring the use of many reagents, high amounts of energy, and/or high amounts of evaporated water. As such, these processes may only be economically viable when Li+ concentrations in the brines are high. In addition, extraction from ore and clay requires large volumes of water and may produce toxic waste streams. It should be noted that it may only be economically viable to perform extraction upon Li-rich brines, as the process may rely on creating high surface area pools of the brine (often in the order of square kilometers of area) to evaporate the water, thereby making it possible to precipitate the lithium out in the form of lithium carbonate.

In contrast, the systems disclose herein allow for the ability to extract Lit from more dilute sources using less energy input and less chemical reagents may make extraction from many of these sources economically viable, thus providing increased levels of Li+ to supply the ever-growing lithium-ion battery industry. Advantageously, performing these processes without producing toxic waste streams may ultimately preserve the surrounding environment and be more sustainable.

In one embodiment, electrolyte membrane-assisted lithium extraction may include a system for extraction of Li+ from a Li-containing brine composed of Li+ electrode modules, which act as reservoirs for reversibly storing Li+ extracted from a feed solution, Na+ (or another ion, such as K+ or H+) electrode modules, which act as reservoirs for reversible storing Na+ extracted from a feed solution, an array of Li+/Na+ modules positioned such that the surface of each Li+ module faces the surface of a Na+ module so that both modules may exchange ions from a feed solution positioned in the space between the modules. In one embodiment, the array of modules may be encased in a rectangular enclosure such that the spaces between the modules form rectangular ducts (or any shape) through which feed solutions may be passed. It should be noted that, within the system, an extractor may include the array and the requisite enclosure. Additionally, the electrolyte membrane-assisted lithium extraction system may further comprise a set of pipes and pumps, which may transport the feed solution (containing Lit) to the extractor and through the rectangular ducts of the extractor, within which Li+/Na+ may be reversibly transported to and from the feed solution through the electrode modules. In addition, the system may comprise a silo for storing an aqueous solution of sodium carbonate and/or lithium carbonate (i.e. a carbonate solution), which may contain a stirrer such that extra sodium carbonate may be added and dissolved into the aqueous solution. It should be noted that, when stored, the concentration of lithium carbonate may be maintained such that it is fully saturated. Further, the system may comprise a decanter, which may be positioned at the bottom of the extractor to collect lithium carbonate that precipitates as Li+ stored in the extractor (as a result of extracting it from the feed solution). To assist in the precipitation of lithium carbonate, a sonicator may be used either directly within the extractor or within a separate tank where the solution is pumped to after the reclamation step.

In likewise embodiment, each module may consist of an active material coating on a current collector welded to both sides of a metal plate, an ion-selective solid electrolyte membrane covering the active material coating on both sides of the metal plate, a metal frame, which may be electronically connected to the internal active material coating and function as a framework for protecting the active material coating from the external environment, an elastomeric sealant around the edges of the metal frame/solid electrolyte membrane where the frame and membrane touch, which may prevent substances from leaking into the electrode module through the membrane, an electrolyte, which may fill up the space on the interior of the module, acting as a medium for transporting ions between the active material and solid electrolyte membrane, and/or a separator between each active material coating and solid electrolyte membrane (optional), which may provide mechanical support and electronically isolate the active material from the solid electrolyte membrane.

In operation, the Na+ modules of the extractor may be completely filled with Na+ in the active material, and the Li+ modules of the extractor may be completely devoid (or near devoid) of Li+ in the active material. Additionally, a feed solution (e.g., a Lit-containing brine) may be pumped into the extractor, where Li+ ions are extracted from the feed into the Li+ electrode modules while Na+ ions are released from the Na+ modules. It should be noted that this step may operate continuously (i.e., the solution may constantly flow through the extractor as Lit/Na+ ions are transported to and from the solution). In addition, the outlet stream may be returned to the feed, where the only waste material may be Na+. Further, the carbonate solution may then be pumped from the feed silo and transferred back into the extractor such that the extractor may be completely filled with the carbonate solution. Further still, once the extractor has been filled with carbonate solution, the flow of water may be halted, after which the Li+ stored in the Lit electrode modules may be expelled while Na+ ions from the carbonate solution may be transported into the Na+ electrode modules. It should be appreciated that, since the carbonate solution may be already fully saturated with lithium carbonate, the Li+ expelled from the extractor may immediately precipitate as a solid and collect in the decanter located at or near the bottom of the extractor. As indicated hereinabove, a supersaturated solution may benefit from an input of energy (e.g. via sonication) to initiate precipitation.

Further yet, the lithium carbonate collected in the decanter may be removed and the carbonate solution returned to the silo where additional sodium carbonate may also then be added to the silo to compensate for the material lost during reclamation. Of course, it is appreciated the solution may be configured such that the Li+ may not precipitate. For example, the solution may be configured such that the Li+ may undergo an ion exchange, as discussed herein as well.

In other embodiments, a solution of pure water may be passed through the system between the extraction and reclamation steps to ensure that the extractor has been purged of any contaminants. Additionally, the reclamation step may also be run under a constant flow, where the solution may be circulated through the extractor, back to the silo, and then back to the extractor again. In addition, the extraction step may also be run as a batch operation, where the feed solution may first be transferred to the extractor, the Li+/Na+ than may go through the exchange process, and the solution may then be removed at the end.

In another embodiment, the system may also be run such that the reclamation and extraction steps occur simultaneously. This may include two electrodes within each module (that may be electronically isolated from one another). This may also include every other rectangular duct in the extractor to have the Li brine flowing through it, and every other rectangular duct to have the carbonate solution flow through it. Within each module, one electrode may function as be an “extraction” module and one electrode may function as a “reclamation” module. During operation, the “extraction” electrodes may work in parallel such that charge is transferred from the “extraction” electrodes in Na+ modules to the “extraction” electrodes in Li+ modules; and during reclamation, charge may be transferred from “reclamation” electrodes in Li+ modules to the “reclamation” electrode in Na+ modules.

As such, this particular embodiment may enable a higher throughput of lithium to be extracted for a given period of time. This may also circumvent the need to “replace” the brine with the carbonate solution and to “wash” the module between runs. Further, this embodiment, may also be advantageous in that it may function as a “heat exchanger” for the brine. For example, as a “heat exchanger”, the heat from the brine may dissipate into the carbonate solution. Further, this, in turn, may assist the Li carbonate to precipitate (Li carbonate has a lower solubility in water at higher temperatures).

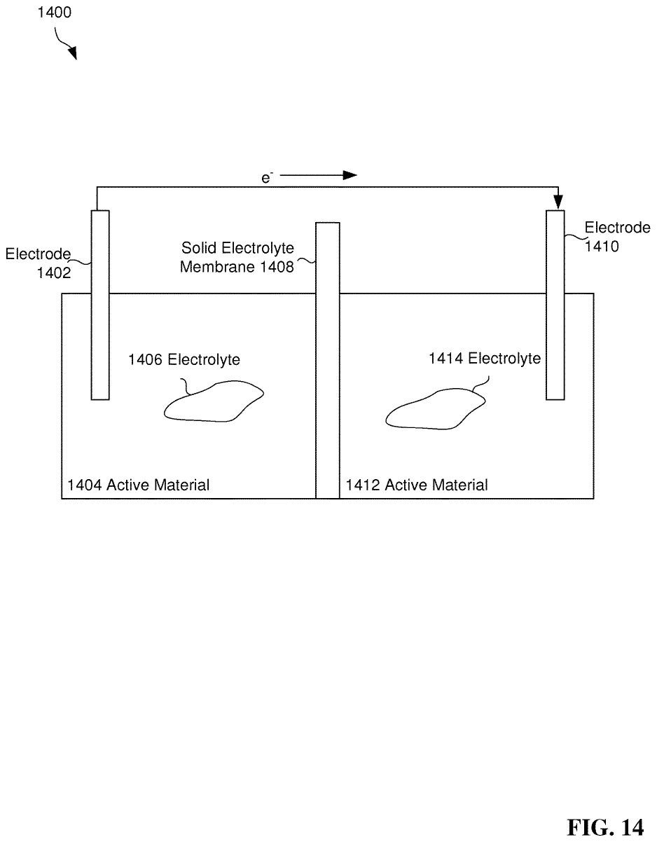

FIG. 14 illustrates a membrane separation cell 1400, in accordance with one embodiment. As an option, the membrane separation cell 1400 may be implemented in the context of any one or more of the embodiments set forth in any previous and/or subsequent figure(s) and/or description thereof. Of course, however, the membrane separation cell 1400 may be implemented in the context of any desired environment. Further, the aforementioned definitions may equally apply to the description below.

As shown, the membrane separation cell 1400 includes an electrode 1402 that is in direct contact with an active material 1404 and an electrolyte 1406. Additionally, the membrane separation cell 1400 includes an electrode 1410 that is in direct contact with an active material 1412 and an electrolyte 1414. A solid electrolyte membrane 1408 may separate the active material 1404 and the electrolyte 1406 from the active material 1412 and the electrolyte 1414. The solid electrolyte membrane 1408 may be ion selective such that preconfigured ions can pass from one solution (such as the electrolyte 1406) to another (such as the electrolyte 1414). In one example, if a liquid electrolyte (such as the electrolyte 1406 and/or the electrolyte 1414) were used as either the anolyte or catholyte, it would need to be in direct contact with the solid electrolyte membrane 1408, and in some instances, would also be in direct contact with the electrode (such as the electrode 1402, the electrode 1410, etc.).

In operation, the membrane separation cell 1400 may be used to selectively remove a particular type of alkali metal from one electrolyte or active material to another electrolyte or active material.

In one embodiment, the membrane separation cell 1400 shows electrode 1402 and/or the electrode 1410. It is to be understood that any number of electrodes may be associated with the membrane separation cell 1400. The electrode 1402 and/or the electrode 1410 may each be an electronically conductive material that interfaces with electroactive substances to partake in redox chemical reactions. Additionally, the electrode 1402 and/or the electrode 1410 may be in electrical contact with an external circuit that controls the flow of electrons between one or more other electrodes. When charge is transferred between electrode (such as between the electrode 1402 and the electrode 1410), the electrode that supplies electrons for a reduction reaction is referred to as a cathode, whereas the electrode that supplies electrons for the oxidation reaction is referred to as an anode.

In another embodiment, a single electrode may be used as both an “anode” and a “cathode” at different times of a given process. However, if more than one electrode is configured for the system, each may be referred to specifically as either an “anode” or “cathode”, regardless of whether the specific electrode is currently used for a reduction or oxidation. The assignment of an electrode as the “anode” and/or “cathode” may be preconfigured as desired (although the naming generally coincides with whether the electrode functions predominately as an “anode” or “cathode” during the most relevant step of the process).

The electrode 1402 and/or the electrode 1410 may include an electronically-conductive substrate, and, optionally, a catalyst. The electronically-conductive substrate may include carbon-based materials (such as but not limited to graphite, graphene, carbon nano onions (CNO), carbon nanotubes (CNT), carbon nanofibers (CNF), and carbon felt), and/or other materials (such as but not limited to metals such as Al, Cu, Li, Na, Stainless Steel, Ti, Ni, Ta, Au, Ag, Pt, Rh, Ir, Pd). Additionally, the catalyst may participate in a chemical reaction (but may not be generated or consumed by the overall reaction). A catalyst may function to lower the activation energy of the reaction, thereby increasing its rate and improving the energy efficiency of the overall system.

With respect to the active material 1404 and/or the active material 1412, it is to be understood that two or any number of active materials may be involved in the membrane separation cell 1400. The active material 1404 and/or the active material 1412 may be any substance (such as but not limited to a solid, liquid, gas, solute, or ionic species) that serves as a reactant or product for a redox reaction. As electrons are transferred between two electrodes, at least one active material may be oxidized at one electrode, and at least one active material may be reduced at the opposite electrode. The active material 1404 and/or the active material 1412 may include, but not limited to carbon-based materials (such as but not limited to graphite, graphene, carbon nano onions (CNO), carbon nanotubes (CNT)); pure alkali metals (such as but not limited to Li, Na, K, Rb, Cs); metals and metalloids that alloy with alkali metals (such as but not limited to Si, P, Mg, Ca, Sn, Ga, In, Ge, Au, Ag, Pd, Pt, and any alloys of these metals); oxide materials (such as but not limited to LTO, LMO, NCA, NMC, LCO); phosphate materials (such as but not limited to LFP, NVP); Prussian blue and Prussian blue analogues; metal hydrides (such as but not limited to NiO(OH)₂/NiO (OH)); gases, liquids, and solids (such as but not limited to H₂, O₂, H₂O, H₂O₂, CO₂, CH₄, F₂, Cl₂, Br₂, I₂); and/or aqueous solutes (such as but not limited to H⁺, OH⁻, OH₂₋). It is to be understood that H+ may be a common notation for H₃O+ (the hydronium cation, or protonated water) but may also include protonated alcohols and ethers such as CH₃(OH₂)⁺ (protonated methanol) and CH₃CH₂(OH⁺)CH₂CH₃ (protonated dimethyl ether).

With respect to the electrolyte 1406 and/or the electrolyte 1414, it is to be understood that they may be same or different substance. The electrolyte 1406 and/or the electrolyte 1414 may be configured to transport ions between different electrodes under the application of a potential difference between electrodes. An electrolyte in contact with the anode, but not in contact with the cathode is referred to as the “anolyte”, whereas an electrolyte in contact with a cathode but not an anode is referred to as the “catholyte”. It is to be appreciated that the electrolyte 1406 and/or the electrolyte 1414 may be in either/or liquid, semi-solid (such as gel), or solid form.

The electrolyte 1406 and/or the electrolyte 1414, in liquid electrolyte form, may consist of one or more liquid solvents (such as but not limited to water, alcohols, carbonates, ethers, hydrocarbons, etc.), and/or multiple ionic solutes (one of which may include the alkali metal cation of interest or H+, and another of which may include at least one anion). Alkali metal cations of interest may include Li+, Na+, K+, H+. A single substance can function as both a liquid solvent and as an ionic solute, such as in the case of ionic liquids. In one embodiment, the liquid electrolyte may contain an active material (such as the active material 1404 and/or the active material 1412) as a solute. In another embodiment, a single solute may function as both an active material and an ionic solute. Further, the liquid electrolyte may contain one or more solutes acting as a buffer, which may stabilize the pH within a narrow, desired range.

The electrolyte 1406 and/or the electrolyte 1414, in solid electrolyte form, may be either an ion-conducting ceramic, glass, polymer, polymer/salt hybrid, or any combination thereof. In another embodiment, the electrolyte 1406 and/or the electrolyte 1414 may also include a plasticizer (which may be but not be limited to a solid or liquid distributed throughout the electrolyte to increase segmental motion of the electrolyte, thereby increasing its ionic conductivity), and/or a mechanical additive (which may serve to improve any mechanical property of interest such as hardness, modulus, or elasticity of the electrolyte).

With respect to the solid electrolyte membrane 1408, it may be configured as an ion-selective solid electrolyte membrane, and may be a particular subset of electrolytes that enables highly selective separation of alkali metals. In one embodiment, the driving force of separation may be a potential difference across the solid electrolyte membrane 1408, which may be precisely controlled by controlling the potential difference between two electrodes (such as the electrode 1402 and the electrode 1410) positioned at opposite sides of the solid electrolyte membrane 1408.

In one embodiment, the solid electrolyte membrane 1408 may consist of (but not limited to) an ion-selective solid electrolyte, a matrix, and/or mechanical additives. With respect to the ion-selective solid electrolyte, it may have high ionic conductivity for the alkali metal of interest and low (such as negligible, or no) ionic conductivity for other substances. For example, in one embodiment, if the alkali metal of interest was Li+, the applicable solid electrolyte membrane 1408 may include, but not be limited to any member of the family of NASICON-type structure (including but not be limited to LAGP, LATP, any of LFP, LTO, NCM, or LMO). If Na⁺ was the alkali metal of interest, the applicable solid electrolyte membrane 1408 may include, but not be limited to, any member of the family of NASICON-type structure. Further, if K⁺ was the alkali metal of interest, the applicable solid electrolyte membrane 1408 may include, but not be limited to, K2Fe4O7. If H⁺ was the alkali metal of interest, the applicable solid electrolyte membrane 1408 may include, but not be limited to, Nafion. Additionally, the solid electrolyte membrane 1408 may include Rb+ (such as RbxFeyVzO4, where x y and z denote subscripts), Cs (such as CsxPyZzO4, where x y z are subscripts and Z is an element from S, Cr, Mo, W; CsxMyPO4, where M is a metal from Mg, Ca, Sr, Ba; and/or CsxPO4M, where M is a metal from Sc, Y, La, Sm, Nd.

With respect to the matrix of the solid electrolyte membrane 1408, the matrix may serve as a scaffold that holds the ion-selective solid electrolyte in place. The matrix may inhibit the permeation of all materials across the solid electrolyte membrane 1408. The matrix may or may not be covalently crosslinked and may or may not be covalently bonded to the ion-selective solid electrolyte. In one embodiment, the matrix may also comprise a metal (such as Sn, etc.), which may make it easier to polish the membrane to a preconfigured roughness, and configure the matrix for increased impermeability.

With respect to the mechanical additives of the solid electrolyte membrane 1408, the mechanical additives may serve to maintain the structural integrity of the solid electrolyte membrane 1408 to prevent the uptake of solvent and/or loss of impermeability of the solid electrolyte membrane 1408 to unwanted substances. For example, mechanical additives may include, but not be limited to carbon-based materials (such as but not limited to graphene, carbon nano onions (CNO), carbon nanotubes (CNT), carbon nanofibers (CNF), diamond), metals (such as but not limited to titanium, stainless steel), and/or ceramics (such as but not limited to TiO₂, SiO₂, Al₂O₃).

In one embodiment, the membrane separation cell 1400 may relate to a membrane-based alkali metal extraction system. In use, an alkali metal extraction system includes an anode and a cathode, where the anode is configured for oxidation and the cathode is configured for reduction. Additionally, wherein migration of a predetermined alkali metal ion through an ion-selective solid electrolyte membrane is driven by a current across the anode and the cathode, and the ion-selective solid electrolyte membrane is selectively permeable to the predetermined alkali metal ion. The alkali metal extraction system further includes at least one active material, a first solution comprising the predetermined alkali metal ion, and a second solution comprising the migrated predetermined alkali metal ion.

In various embodiments, the first solution may include an anolyte, and the second solution may include a catholyte. Additionally, each of the anolyte and the catholyte may include an active material (including for example, one or more electroactive solutes) or an electrode coating immersed in each of the anolyte and the catholyte, one or more dissolved alkali metal cations (including the predetermined alkali metal ion), one or more dissolved anions, and a solvent.

In various embodiments, the active material may include one or more of: H₂, Na⁺, Li metal, LFP, LMO, NCA, NMC, graphite; Na-based active materials including Prussian Blue; and/or electroactive solutes include but are not limited to: ferricyanide, ferrocyanide, or a redox state ferricyanide or ferrocyanide ([Fe(CN)6]3−/[Fe(CN)6]4−); ferrocene (Fe(C₅H₅)₂, ferrocenium Fe(C₅H₅)₂⁺, cobaltocene (Co(C₅H₅)₂, cobaltocenium Co(C₅H₅)₂⁺, or any organic derivatives thereof; vanadium-containing ions or vanadium coordination complexes, including one or more of pervanadyl (VO₂⁺), vanadyl (VO²⁺), V²⁺, V³⁺; phosphotungstic acid, or a redox state of phosphotungstic acid ([PW₁₂O₄₀]³⁻/[P₂W₂₁O₇₁]⁶⁻/[PW₁₁O₃₉]⁷⁻, etc.); phosphomolybdic acid, or a redox state of phosphomolybdic acid; silicotungstic acid, or a redox state of slicotungstic acid; and/or an ion of any common redox state of Fe, Co, Ni, or Cu, including one or more of Fe²⁺, Fe³⁺, Co²⁺, Co³⁺, Ni²⁺, Ni³⁺, Cu²⁺, Cu⁺, or any coordination complex thereof.

In various embodiments, a first current collector may be in contact with the first solution, and a second current collector may be in contact with the second solution. Additionally, each of the first current collector and the second current collector may be electronically conductive, and made of at least one of aluminum, nickel, copper, titanium, stainless steel, graphite felt, or carbon fiber.

In various embodiments, the anode may have a first mean potential, and the cathode may have a second mean potential, where the first mean potential is less than or equal to the second mean potential such that the anode receives electronic charge as the predetermined alkali metal migrates from the first solution to the second solution. Additionally, the first solution may include one or more secondary ions, and/or a first concentration of the one or more secondary ions in the first solution may be greater than a second concentration of the one or more secondary ions in the second solution.

In various embodiments, the configuration of the ion-selective solid electrolyte membrane may include a solid electrolyte particle with a predetermined pore size corresponding with the predetermined metal ion. In one embodiment, ionic selectivity of the material may be based on the barrier for diffusion for the ion through a crystal lattice (of the material). The energy barrier for diffusion may be a function of charge and size of the ion and may not necessarily correlate with either. The first solution may be a geothermal brine or a salar brine. Still yet, the first solution may comprise at least one of lithium minerals, lithium-containing brines, recycled lithium batteries, or seawater.

In various embodiments, the second solution may comprise a first electroactive solute, where the reduction of the first electroactive solute coincides with the migration of the predetermined alkali metal ion. Additionally, the first solution may comprise a second electroactive solute, where oxidation of the second electroactive solute coincides with the migration of the predetermined alkali metal ion. A first concentration of at least one H⁺ ion or at least one Na⁺ ion may decrease in the second solution, and a second concentration of the at least one H⁺ ion or the at least one Na⁺ ion may increase in the first solution.

In various embodiments, the first solution may include LiOH at a first solubility, and the second solution may include an organic solution with second solubility, wherein the second solubility is lower than the first solubility. Additionally, the organic solution may comprise H₂O, where the H₂O is configured to facilitate formation of an alkali salt.

In various embodiments, the migrated predetermined alkali metal ion may be configured to recombine with a hydroxyl group to precipitate. Additionally, input energy used to migrate the predetermined metal alkali ion may be stored and recovered, at least in part, as electrochemical energy of the migrated predetermined metal alkali ion at the cathode. Further, the input energy may correspond with an electric charging at an electrode with the predetermined metal alkali ion and the electrochemical energy may correspond with an electric discharge at the electrode of the predetermined metal alkali ion. Still yet, the recovery of the input energy may reduce a carbon footprint of a manufacturing facility.

In another embodiment, recovering energy may apply to a design where the reduction potential of the anode and cathode are different (e.g. each of the anode and cathode use different active materials). In this case, it may take an input of energy to move charge from a cathode side to an anode side (which may correspond to the migration of an alkali metal ion from cathode to anode), but such energy may be recovered when the cell then moves charge from the anode to the cathode (which may correspond to the migration of an alkali metal ion from anode to cathode). The recovery therefore may occur via a two-step process where the direction of current changes.

In another embodiment where the anode and cathode have equal mean reduction potentials (as is the case when using the same active materials on both sides), it may not be required to have any net energy input to drive the electrochemical reaction in either direction. In any case, an input of irrecoverable energy is always required to move charge (per Ohm's law).

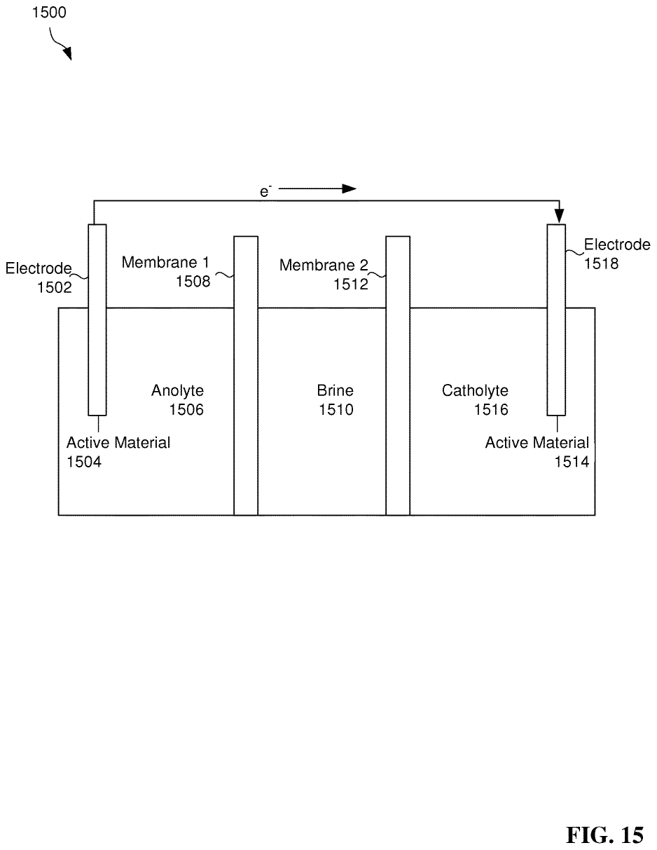

FIG. 15 illustrates a lithium extractor 1500 with active materials, in accordance with one embodiment. As an option, the lithium extractor 1500 may be implemented in the context of any one or more of the embodiments set forth in any previous and/or subsequent figure(s) and/or description thereof. Of course, however, the lithium extractor 1500 may be implemented in the context of any desired environment. Further, the aforementioned definitions may equally apply to the description below.

As shown, the lithium extractor 1500 includes an electrode 1502 in contact with active material 1504, and an anolyte 1506. The anolyte 1506 may be separated from brine 1510 via a membrane 1 1508. Further, the brine 1510 may be separated from a catholyte 1516 via a membrane 2 1512. The electrode 1518 may be in contact with active material 1514, and the catholyte 1516. The active material 1504 may be a coating on the surface of the electrode 1502, and the active material 1514 may be a coating on the surface of the electrode 1518.

In one embodiment, the electrode 1502 may be copper (Cu), and the electrode 1518 may be aluminum (Al). In other embodiments, the anode electrode (such as the electrode 1502) may be a sheet of Al or Cu foil coated with the anode active material, and the cathode (such as the electrode 1518) may be a sheet of Al or Cu foil coated with the cathode active material.

In operation, the lithium extractor 1500 may include three electrolytes (anolyte 1506, brine 1510, catholyte 1516) which may be used in series. Each of the three electrolytes may be separated from each other via an ion-selective solid electrolyte membrane (such as the membrane 1 1508 and the membrane 2 1512). One liquid electrolyte may in direct contact with the anode (such as the anolyte 1506), a second liquid electrolyte may be in direct contact with the cathode (such as the catholyte 1516), and a third liquid electrolyte (such as the brine 1510) may be a Li ion-containing brine.

The membrane 1 1502 may include an ion-selective solid electrolyte membrane separating the anolyte 1506 and the brine 1510, and may be selective for Li ions. In contrast, the membrane 2 1512 may include an ion-selective solid electrolyte membrane separating the catholyte 1516 from the brine 1510, and may be selective for a different type of ion (such as Na ions).

In one embodiment, the anolyte 1506 may be an aqueous solution containing Li+ cations and SO₄²⁻ anions. Further, the catholyte 1516 may be an aqueous solution containing Na+ cations and SO₄²⁻ anions.

With respect to the active material 1504 (for the anode), the active material 1504 may include, but not be limited to LMO, LTO, LFP, etc., Further, the active material 1514 (for the cathode) may include, but not be limited to Na iron phosphate (NFP), Prussian Blue, etc..

In other embodiments, the anolyte 1506 may include, but not be limited to, a solvent (water), cations (Li+), and/or anions (TFSI−). The catholyte 1516 may include, but not be limited to, a solvent (water), cations (Na+), and/or anions (TFSI−). The brine 1510 may include, but not be limited to, a solvent (water, naturally present), cations (Na+, Li+, naturally present), and anions (naturally present).

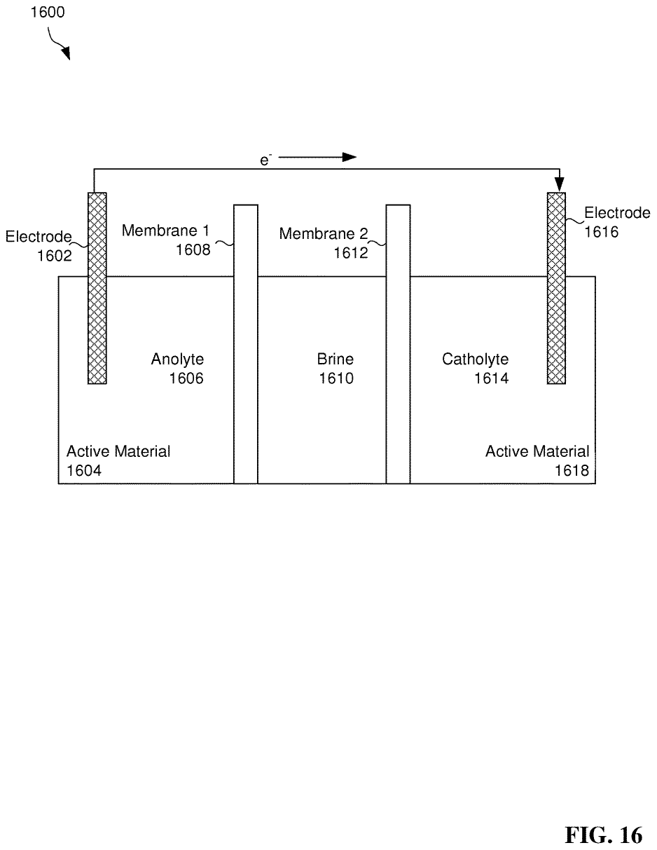

FIG. 16 illustrates a lithium extractor 1600 with redox flow active materials, in accordance with one embodiment. As an option, the lithium extractor 1600 may be implemented in the context of any one or more of the embodiments set forth in any previous and/or subsequent figure(s) and/or description thereof. Of course, however, the lithium extractor 1600 may be implemented in the context of any desired environment. Further, the aforementioned definitions may equally apply to the description below.

As shown, the lithium extractor 1600 includes an electrode 1602 in contact with active material 1604, and an anolyte 1606. The anolyte 1606 may be separated from brine 1610 via a membrane 1 1608. Further, the brine 1610 may be separated from a catholyte 1614 via a membrane 2 1612. The electrode 1616 may be in contact with active material 1618, and the catholyte 1614. In one embodiment, the active material 1604 may include an electroactive solute.

In operation, the lithium extractor 1600 may include three electrolytes (anolyte 1606, brine 1610, catholyte 1614), which may be used in series. The three electrolytes may be separated from each other via an ion-selective solid electrolyte membrane (such as the membrane 1 1608 and the membrane 2 1612). One liquid electrolyte may be in direct contact with the anode (the anolyte 1606), a second liquid electrolyte may be in direct contact with the cathode (the catholyte 1614), and a third liquid electrolyte (the brine 1610) may be a Li ion-containing brine.

The membrane 1 may be an ion-selective solid electrolyte membrane separating the anolyte 1606 and the brine 1610, and may be selective for Li ions, whereas the membrane 2 may be an ion-selective solid electrolyte membrane separating the catholyte 1614 from the brine 1610, and may be selective for a different type of ions (such as but not limited to Na ions).

In various embodiments, the anolyte 1606 may be an aqueous solution containing, but not be limited to, Li+ cations and [Fe(CN)₆]⁴⁻ and [Fe(CN)₆]³⁻ anions. Additionally, the catholyte 1614 may be an aqueous solution containing, but not be limited to, Na+ cations and [Fe(CN)₆]⁴⁻ and [Fe(CN)₆]³⁻ anions.

The anode (such as the electrode 1602) may be a porous mesh composed of stainless steel. Additionally, the cathode (such as the electrode 1616) may be a porous mesh composed of stainless steel. Further, the active material 1604 (the active material for the anode) may be, but not be limited to, [Fe(CN)₆]⁴⁻. The active material 1618 (the active material for the cathode), may be, but not be limited to, is [Fe(CN)₆]³⁻.

In other embodiments, the anolyte 1606 may include, but not be limited to, a solvent (water), cations (Li+), and/or anions ([Fe(CN)₆]³, [Fe(CN)₆]³⁻). The catholyte 1614 may include, but not be limited to, a solvent (water), cations (Na+), and/or anions ([Fe(CN)6]3, [Fe(CN)6]3−). The brine 1610 may include, but not be limited to, a solvent (water, naturally present), cations (Na+, Li+, naturally present), and anions (naturally present).

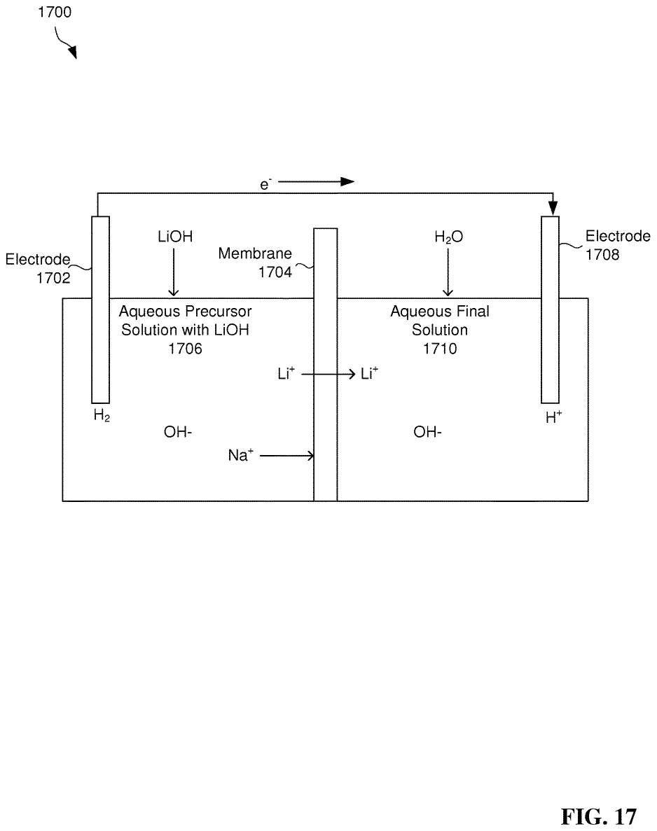

FIG. 17 illustrates redox electrode modules 1700 for critical minerals purification, in accordance with one embodiment. As an option, the redox electrode modules 1700 may be implemented in the context of any one or more of the embodiments set forth in any previous and/or subsequent figure(s) and/or description thereof. Of course, however, the redox electrode modules 1700 may be implemented in the context of any desired environment. Further, the aforementioned definitions may equally apply to the description below.

As shown, lithium ions (Li+) may pass from an anode comprised of aqueous precursor solution 1706 through a solid electrolyte membrane 1704 to a cathode comprised of an aqueous final solution 1710. In operation, lithium hydroxide (LiOH) atoms present in the aqueous precursor solution 1706 may break apart into positively-charged lithium ions and negatively-charged hydroxide (OH⁻) atoms. In addition, the lithium ions may then be drawn across the electrolyte membrane 1704 into the aqueous final solution 1710 where they may recombine with hydroxide atoms to reform into additional lithium hydroxide atoms, thus yielding a higher concentration of lithium hydroxide in the aqueous final solution 1710 upon completion of the purification process. Further, the purification process may simultaneously combine the actions of reduction of H⁺ at a cathode electrode 1708, forming H₂ (sent to an anode), and oxidation of H₂ at the anode electrode 1702, forming H⁺ waste.

In one embodiment, the solid electrolyte membrane 1704 may be impermeable such that the aqueous solution may be prevented from crossing the solid electrolyte and matrix, yet simultaneously allow an alkali metal (such as Li⁺) to pass through the solid electrolyte.

In one embodiment, the redox electrode modules 1700 may relate to a membrane-based critical minerals purification system. In use, a critical minerals purification system includes an anode and a cathode, where the anode is configured for oxidation and the cathode is configured for reduction. Additionally, migration of a predetermined alkali metal ion through an ion-selective solid electrolyte membrane is driven by a current across the anode and the cathode, and the ion-selective solid electrolyte membrane is selectively permeable to the predetermined alkali metal ion. Additionally, the critical minerals purification system includes at least one active material, a precursor solution comprising the predetermined alkali metal ion, where the precursor solution is characterized by a first purity with respect to an alkali metal salt, and a second solution comprising the migrated predetermined alkali metal ion, wherein the second solution is characterized by a second purity with respect to the alkali metal salt.

In various embodiments, the second purity may be greater than the first purity. Additionally, the at least one active material at the anode and/or the cathode includes at least one of: H₂, Na⁺, Li metal, LFP, LMO, NCA, NMC, graphite; Na-based active materials including Prussian Blue; ferricyanide, ferrocyanide, or a redox state ferricyanide or ferrocyanide ([Fe(CN)₆]³⁻/[Fe(CN)₆]⁴⁻); ferrocene (Fe(C₅H₅)₂, ferrocenium Fe(C₅H₅)₂⁺, cobaltocene (Co(C₅H₅)₂, cobaltocenium Co(C₅H₅)₂⁺, or any organic derivatives thereof; vanadium-containing ions or vanadium coordination complexes, including one or more of pervanadyl (VO₂⁺), vanadyl (VO²⁺), V²⁺, V³⁺; phosphotungstic acid, or a redox state of phosphotungstic acid ([PW₁₂O₄₀]³⁻/[P₂W₂₁O₇₁]⁶⁻/[PW₁₁O₃₉]⁷⁻, etc.); phosphomolybdic acid, or a redox state of phosphomolybdic acid; silicotungstic acid, or a redox state of slicotungstic acid; or an ion of any common redox state of Fe, Co, Ni, or Cu, including one or more of Fe²⁺, Fe³⁺, Co²⁺, Co³⁺, Ni²⁺, Ni³⁺, Cu²⁺, Cu⁺, or any coordination complex thereof.

In various embodiments, the ion-selective solid electrolyte membrane may be the at least one active material. Additionally, the second solution may include H₂, where the H₂ is an output of the reduction of the cathode. Further, the first solution may include H₂, where the H₂ is an input of the oxidation of the anode. In one embodiment, Cl₂ may be produced from Cl— at the anode and consumed at the cathode (and converted back to Cl—).

In various embodiments, the anode may use a first active material, the cathode may use a second active material, and the first active material may differ from the second active material. Additionally, energy lost to the output of the reduction may be regained by the input of the oxidation. Further, the precursor solution may be in contact with the anode. The precursor solution may include LiOH.

In one embodiment, the aqueous precursor solution 1706 may contain any type of dissolved salt, not limited to LiOH (e.g. Li₂CO₃, LiCl, etc.). The flexibility of the aqueous precursor solution 1706 is further exemplified via LiX 1806 discussed hereinbelow.

In various embodiments, the second solution may be in contact with the cathode. The second solution may include H₂O. Additionally, the H₂O may function as a reagent and a solvent. Further, the alkali metal salt may be extracted from the second solution. The extracted alkali metal salt at the second purity may be used for battery components.

In various embodiments, a reagent may be added to the second solution, where the reagent is configured to cause the migrated predetermined alkali metal ion to combine with a hydroxyl group to form the alkali metal salt at the second purity. Additionally, the precursor solution may include at least one of lithium minerals, lithium-containing brines, recycled lithium batteries, or seawater.

In various embodiments, input energy used to migrate the predetermined metal alkali ion may be saved and recovered, at least in part, as electrochemical energy of the migrated predetermined metal alkali ion at the cathode. Additionally, the input energy may correspond with an electric charge process and the electrochemical energy may correspond with an electric discharge process. Further, the recovery of the input energy may reduce a carbon footprint of a manufacturing facility.

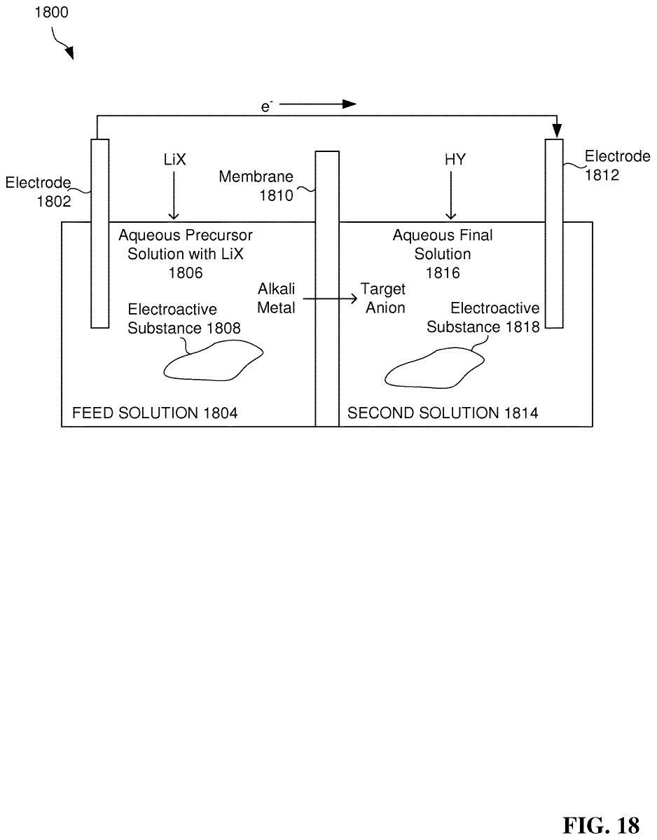

FIG. 18 illustrates redox electrode modules 1800 for critical minerals purification, in accordance with one embodiment. As an option, the redox electrode modules 1800 may be implemented in the context of any one or more of the embodiments set forth in any previous and/or subsequent figure(s) and/or description thereof. Of course, however, the redox electrode modules 1800 may be implemented in the context of any desired environment. Further, the aforementioned definitions may equally apply to the description below.

As shown, alkali metal ions may pass from an anode comprised of aqueous precursor solution with LiX 1806 in a feed solution 1804 through a solid electrolyte membrane 1810 to a cathode comprised of an aqueous final solution 1816 in a second solution 1814. In one embodiment, LiX 1806 may include any lithium salt, including but not limited to monovalent anions (e.g. Cl—, Br—, I—, etc.), Li₂CO₃, and/or any other anion disclosed herein. In operation, alkali metal atoms comprising an electroactive substance 1808 present in the aqueous precursor solution with LiX 1806 may break apart into positively-charged metal ions and counterpart negatively-charged atoms. In addition, the alkali metal ions may then be drawn across the electrolyte membrane 1810 into the aqueous final solution 1816 where they may recombine with other counterpart atoms to reform into new atoms comprising a higher concentration of electroactive substance 1818 in the aqueous final solution 1816 upon completion of the purification process. In one embodiment, the purification process may simultaneously combine the actions of reduction of H⁺ at a cathode electrode 1812, forming H₂ (sent to an anode electrode), and oxidation of H₂ at the anode electrode 1802, forming H⁺ waste.

In one embodiment, the solid electrolyte membrane 1810 may be impermeable such that the aqueous solution may be prevented from crossing the solid electrolyte and matrix, yet simultaneously allow an alkali metal (such as Li⁺) to pass through the solid electrolyte.

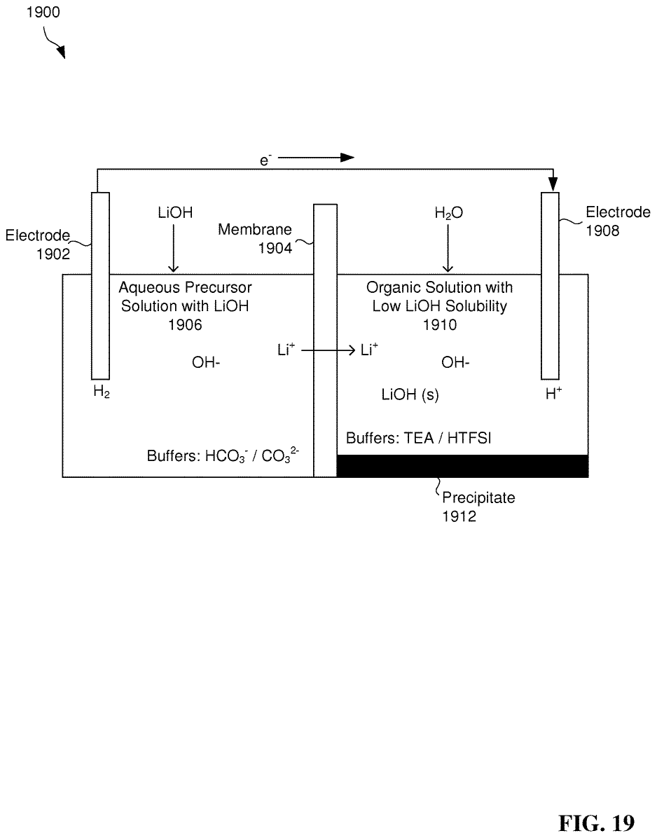

FIG. 19 illustrates redox electrode modules 1900 for metal salt precipitation, in accordance with one embodiment. As an option, the redox electrode modules 1900 may be implemented in the context of any one or more of the embodiments set forth in any previous and/or subsequent figure(s) and/or description thereof. Of course, however, the redox electrode modules 1900 may be implemented in the context of any desired environment. Further, the aforementioned definitions may equally apply to the description below.

As shown, lithium ions (Li⁺) may pass from an anode comprised of aqueous precursor solution with lithium hydroxide (LiOH) 1906 through a solid electrolyte membrane 1904 to a cathode comprised of an organic solution with low LiOH solubility 1910. In operation, lithium hydroxide atoms present in the aqueous precursor solution 1906 may break apart into positively-charged lithium ions and negatively-charged hydroxide (OH⁻) atoms. In addition, the lithium ions may then be drawn across the electrolyte membrane 1904 into the organic solution with low LiOH solubility 1910 where they may recombine with hydroxide atoms to reform into additional lithium hydroxide atoms, thus yielding a high concentration of lithium hydroxide in the organic solution with low LiOH solubility 1910 resulting in the formation of a concentrated precipitate salt 1912 upon completion of the precipitation process.

Additionally, in one embodiment, the precipitation process may simultaneously combine the actions of reduction of H⁺ at a cathode electrode 1908, forming H₂ (sent to an anode), and oxidation of H₂ at the anode electrode 1902, forming H⁺ waste. Further, to prevent corrosion and degradation of the effectiveness of the solid electrolyte membrane 1904, suitable buffers may be used to coat the solid electrolyte membrane 1904 in the case of contact with both the aqueous precursor solution with lithium hydroxide 1906 and organic solution with low LiOH solubility 1910. By way of example, the compound used to comprise the buffer in the aqueous precursor solution with lithium hydroxide 1906 may include, but not be limited to, bicarbonate (HCO₃⁻) and/or Carbonate ion (CO₃²⁻). Conversely, the compound used to comprise the buffer in the organic solution with low LiOH solubility 1910 may include, but not be limited to, Triethylamine (TEA) and/or bis(trifluoromethanesulfonyl)imide (HTFSI).

In one embodiment, the redox electrode modules 1900 may relate to a membrane-based alkali metal salt precipitation system. In use, an alkali metal salt precipitation system includes an anode and a cathode, where the anode is configured for oxidation and the cathode is configured for reduction. Additionally, migration of a predetermined alkali metal ion through an ion-selective solid electrolyte membrane is driven by a current across the anode and the cathode, and the ion-selective solid electrolyte membrane is selectively permeable to the predetermined alkali metal ion. The alkali metal salt precipitation system further includes at least one active material, a precursor solution comprising the predetermined metal ion, where the precursor solution is at a first solubility of an alkali metal salt, and a second solution comprising the predetermined metal ion, where the second solution is at a second solubility of the alkali metal salt which causes the migrated predetermined metal ion to precipitate.

In various embodiments, the precursor solution may include at least one of LiOH, LiCI, or Li₂CO₃. Additionally, the LiOH may be insoluble in the second solution. Further, the first solubility may be higher than the second solubility.

In various embodiments, the precursor solution may include one or more buffers. The one or more buffers may include at least one of HCO₃⁻; or CO₃²⁻, Additionally, the one or more buffers may be used to protect the ion-selective solid electrolyte membrane. Further, the migrated predetermined metal ion may be Li+, and/or the second solution may comprise at least one LiOH precipitate. Still yet, the second solution may comprise H₂O, where the H₂O may be configured to facilitate the LiOH precipitate formation. The H₂O may function as a reagent.

In various embodiments, the second solution may comprise at least one ether. In other embodiments, the second solution may comprise alcohols, organic carbonates, esters, and/or ketones. Additionally, the precursor solution may include an electroactive solute. The cathode and the anode each may include an electronically conductive substrate made of at least one of: graphite, CNO, graphene, Pt, Au, Ag, Ti, Cu, Al, or stainless steel.

In various embodiments, the at least one active material may comprise an electrode slurry casted on a current collector. The cathode may include a catalyst electrically coupled with an electrically conductive substrate of the cathode. Additionally, the anode may include a catalyst electrically coupled with an electrically conductive substrate of the anode.

In various embodiments, input energy used to migrate the predetermined metal ion may be saved and recovered, at least in part, as electrochemical energy of the migrated predetermined metal ion at the cathode. Additionally, the input energy may correspond with an electric charge process and the electrochemical energy may correspond with an electric discharge process. Further, the recovery of the input energy may reduce a carbon footprint of a manufacturing facility.

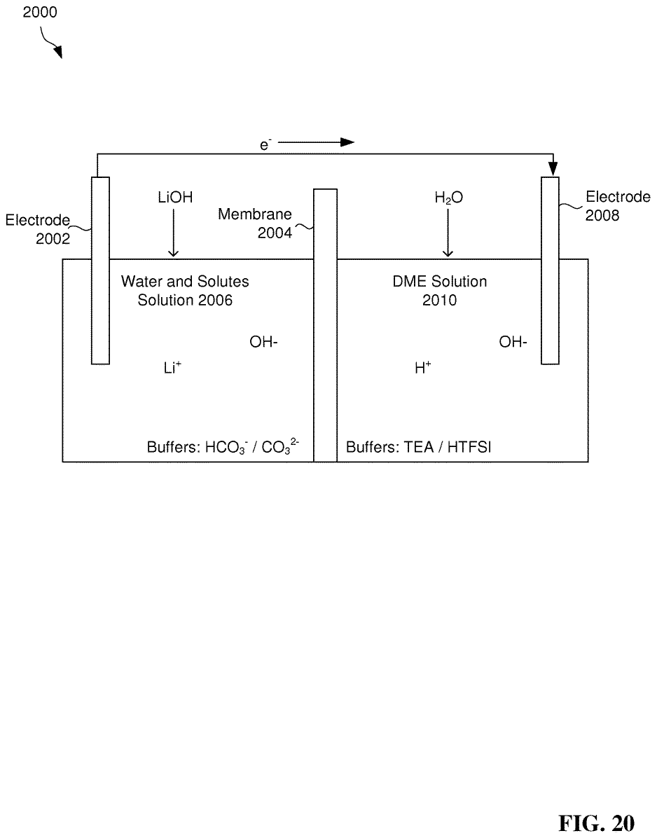

FIG. 20 illustrates redox electrode modules 2000 being set up for metal salt precipitation, in accordance with one embodiment. As an option, the redox electrode modules 2000 may be implemented in the context of any one or more of the embodiments set forth in any previous and/or subsequent figure(s) and/or description thereof. Of course, however, the redox electrode modules 2000 may be implemented in the context of any desired environment. Further, the aforementioned definitions may equally apply to the description below.

As shown, anode electrode 2002 may be comprised of platinum, and cathode electrode 2008 comprised of copper. The anode electrode 2002 may be in contact with a water and solutes solution 2006 and the cathode electrode 2008 may be in contact with a dimethoxyethane (DME) solution 2010. By design, a current may pass from the anode to the cathode and lithium ions (Li+) may simultaneously pass from the water and solutes solution 2006 through a LATP/epoxy membrane 2004 to the Dimethoxyethane (DME) solution 2010. It should be noted that, in order to prevent corrosion and degradation of the effectiveness of the LATP/epoxy membrane 2004, suitable buffers may be used to coat the LATP/epoxy membrane 2004 in the case of contact with both the water and solutes solution 2006 and Dimethoxyethane (DME) solution 2010. By way of example, the compound used to comprise the buffer in the water and solutes solution 2006 may include bicarbonate (HCO₃⁻) and/or Carbonate ion (CO₃²⁻). Conversely, the compound used to comprise the buffer in the dimethoxyethane (DME) solution 2010 may include triethylamine (TEA) and/or bis(trifluoromethanesulfonyl)imide (HTFSI).

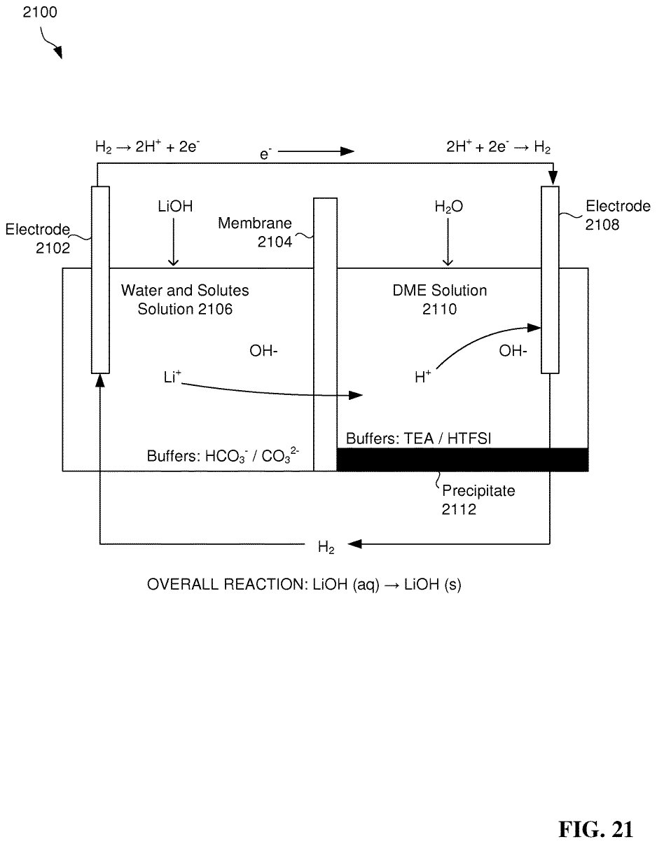

FIG. 21 illustrates redox electrode modules 2100 for metal salt precipitation during reaction, in accordance with one embodiment. As an option, the redox electrode modules 2100 may be implemented in the context of any one or more of the embodiments set forth in any previous and/or subsequent figure(s) and/or description thereof. Of course, however, the redox electrode modules 2100 may be implemented in the context of any desired environment. Further, the aforementioned definitions may equally apply to the description below.

As shown, anode electrode 2102 may be comprised of platinum and cathode electrode 2108 may be comprised of copper. The anode electrode 2102 may be in contact with a water and solutes solution 2106, and the cathode electrode 2108 may be in contact with a dimethoxyethane (DME) solution 2110. In operation, a current may pass from the anode electrode 2102 to the cathode electrode 2108 and lithium ions (Li+) may simultaneously pass from the anode containing the water and solutes solution 2106 through a LATP/epoxy membrane 2104 to the cathode comprised of the dimethoxyethane (DME) solution 2110. Additionally, lithium hydroxide atoms present in the water and solutes solution 2106 may break apart into positively-charged lithium ions and negatively-charged hydroxide (OH) atoms. Further, the lithium ions may then be drawn across the LATP/epoxy membrane 2104 into the dimethoxyethane (DME) solution 2110 where they may recombine with hydroxide atoms to reform into additional lithium hydroxide atoms, thus yielding a high concentration of lithium hydroxide in the dimethoxyethane (DME) solution 2110 resulting in the formation of a concentrated precipitate salt 2112 upon completion of the precipitation process. Further still, the precipitation process may simultaneously combine the actions of oxidation of H₂ at the anode electrode 2102, forming H⁺ waste and reduction of H⁺ at the cathode electrode 2108, forming H₂ (sent to the anode).

It should be noted that, in order to prevent corrosion and degradation of the effectiveness of the LATP/epoxy membrane 2104, suitable buffers may be used to coat the LATP/epoxy membrane 2104 in the case of contact with both the water and solutes solution 2106 and dimethoxyethane (DME) solution 2110. By way of example, the compound used to comprise the buffer in the water and solutes solution 2106 may include, but not be limited to, bicarbonate (HCO₃₋) and/or Carbonate ion (CO₃²⁻). Conversely, the compound used to comprise the buffer in the Dimethoxyethane (DME) solution 2110 may include Triethylamine (TEA), and/or bis(trifluoromethanesulfonyl)imide (HTFSI).

In one embodiment, a net result of the completed reaction process may yield a concentrated precipitate salt 2112 in the form of a mass of lithium hydroxide (LiOH) solid.

It is acknowledged that conventional removal of an ionic species from solution, particularly an aqueous solution, may be a complex and expensive process due to the high amounts of energy and time required to remove water by methods such as boiling, evaporation, and/or centrifugation. Known industrial methods include manipulation of temperature, either to induce precipitation of the target species or to remove the solvent, manipulation of evaporation rate, either by altering temperature, humidity, or pressure of the system, or addition of kinetic energy, such as via centrifugation. All these methods typically require either a long time or a high amount of energy and add to complexity of processes. In addition, in the context of traditional chemical processes, the introduction of an additional liquid phase, such as in water/organic extraction, and the precipitation of a solute by addition of a second solvent, can be used. The former is only applicable to some chemicals, particularly organic acids/bases, while the latter requires either a large amount of second (typically organic) solvent as a consumable, or additional processing to remove the second solvent. As such, a process for removing highly soluble salts, such as lithium chloride (LiCl) and/or lithium hydroxide (LiOH), may make the precipitation process much less expensive, and thus enable additional potential applications. It should be noted that such a process may also significantly reduce the energy required, which may also realize the added benefit of decreasing the carbon footprint of the facility.

In various embodiments, the redox electrode modules 2100 may be used for precipitation of an ionic compound. Such an application may be, in particular, for those solutions with a high solubility in water and that contain an alkali metal cation. Additionally, the solutions may consist of a feed solution containing a precursor ionic compound (which in turn may contain the alkali metal cation of the salt that the system is designed to precipitate). In one embodiment, the precursor ionic compound may be lithium hydroxide or any other ionic compound containing Li+, which is the alkali metal cation that the system is designed to precipitate. It is acknowledged that although lithium is focused on as the desired mineral to be extracted and precipitated, other critical minerals may, in like manner, be extracted and precipitated.

In another embodiment, the precursor ionic compound and/or target ionic compound may have a high solubility in the feed solution, the solvent for which may be water, an alcohol, a carbonate, an ether, a hydrocarbon, and/or a liquid metal solution. Additionally, the system may comprise a second solution containing a target anion, which may be identical to or different from the anion of the precursor compound. Additionally, in one embodiment, the solvent for the second solution may be selected such that the target compound that the system may be designed to precipitate at low solubility. For example, the solvent for the second solution may be water, an alcohol, a carbonate, an ether, a hydrocarbon, or a liquid metal solution. In one embodiment, the system may be designed to precipitate a salt containing the target anion.

The system for precipitation of an ionic compound may also comprise a solid electrolyte membrane, which may serve as a barrier for the precursor solution and nonvolatile solution and selectively transport lithium in the form of lithium ions through the membrane. Additionally, the solid electrolyte membrane may contain an ion-selective solid, such as lithium aluminum titanium phosphate, lithium aluminum germanium phosphate and/or any other member of the NASICON-type solid electrolyte structure family. As discussed herein, the solid electrolyte membrane may be constructed to be ion-specific in selectively allowing a predesignated ion to pass.

The system for precipitation of an ionic compound may also comprise an alkali metal cation or H+ initially dissolved in the feed solution. Additionally, the alkali metal cation may also ultimately be the salt that the system is designed to precipitate. In like manner, the system may also comprise a target anion initially dissolved in the second solution, the salt for which the system is designed to precipitate.

The system for precipitation of an ionic compound may also comprise a first electroactive solute, which can be oxidized and donate electrons for the system and may be a single solute or set of solutes that undergo electrochemical reactions. Such reactions may include electrons as a product, based on one or more of hydrogen gas, hydroxide, a chloride ion, a bromide ion, and/or an iodide ion. Additionally, the system may comprise a second electroactive solute, which can be reduced and receive electrons from the system. Such second electroactive solute may include a single solute or set of solutes that undergo electrochemical reactions in which electrons are a reactant, based on one or more of oxygen gas, a hydrogen ion, water, chlorine, bromine, and/or iodine.

The system for precipitation of an ionic compound may also comprise a first buffer which may be dissolved in the feed solution and may be comprised of a set of multiple solutes that together maintain a pH of the solution within a desired range (such as pH 7 or any desired level). Additionally, the system may comprise a second buffer, which may be dissolved in the second solution and may comprise a set of multiple solutes that together maintain the pH of the solution within a desired range (such as pH 7 or any desired level). In addition, a buffering system with two components may contain a base, whose conjugate acid (for example, triethylamine (TEA), and/or an acid, etc.) may form a substance that when combined with the target anion, or any other anion found in the second solution, may be soluble in the second solution during operation of the system, whose conjugate base (for example, (bis(trifluoromethylsulfoniminic) acid (HTFSI), etc.) may form a substance that when combined with the target alkali metal cation or H+, or any other cation found in the second solution, may be soluble in the second solution during operation of the system. It should be noted that either the conjugate acid of the base or the acid may have a moderate pKa, (such as a pH of around 7).

The system for precipitation of an ionic compound may also comprise an anode, immersed in a feed solution consisting of an electronically conductive substrate, such as a metal, metalloid, or carbon-based material, an active material (optional). The feed solution may be electronically in contact with the electronically conductive substrate and may undergo a chemical reaction with the first electroactive solute, and/or a catalyst (optional). The feed solution may further be in contact with the electronically conductive substrate and, when utilized, may lower the activation energy/overpotential of the oxidation of the first electroactive solute.

In one embodiment, the electronically conductive substrate may be a sheet, a rod, and/or a sphere immersed in the solution. Additionally, the substrate may be selected such that the reduction potential of the material is higher than that of the first electroactive solute. The first electrode may include, but not be limited to graphite, cyanate, graphene, platinum, gold, silver, titanium, copper, aluminum, and/or stainless steel. In another embodiment, the catalyst may be comprised of platinum, gold, silver, iridium, iron, ruthenium, rhodium, and/or palladium.

The system for precipitation of an ionic compound may also comprise a cathode immersed in the second solution further comprised of an electronically conductive substrate. The electronically conductive substrate may include, but not be limited to a metal, metalloid, or carbon-based material that may be a sheet, a rod, and/or a sphere, and may be immersed in the solution. In addition, the electronically conductive substrate may be selected such that the reduction potential of the material is higher than that of the second electroactive solute. Additionally, the system may comprise an active material (optional), which may be electronically in contact with the electronically conductive substrate and, when utilized, may react with the second electroactive solute. Further, the system may comprise a catalyst (optional), which may be in contact with the electronically conductive substrate and, when utilized, may lower the activation energy/overpotential of the oxidation of the second electroactive solute.

In one embodiment, the electronically conductive substrate may be comprised of, but not limited to, graphite, cyanate, graphene, platinum, gold, silver, titanium, copper, aluminum, and/or stainless steel. In a related embodiment, the catalyst may be comprised of platinum, gold, silver, iridium, iron, ruthenium, rhodium, and/or palladium.

In operation, the process for precipitation of an ionic compound may comprise transferring current from the anode to the cathode, which may result in selective transport of the alkali metal cation or a Hydrogen ion from a first solution, through the solid electrolyte membrane, and into a second solution. In addition, the process may include oxidation of the first electroactive species at the anode and reduction of the second electroactive species at the cathode. Additionally, the process may include transport of gaseous products from one electrode to another. In one embodiment, the terms anode and cathode may both be referred to as electrodes.

In further operation, the process for precipitation of an ionic compound may comprise a change in relative concentration of the buffering species of the first buffer and the second buffer, which may maintain the pH of the feed and second solutions. Additionally, the process may include precipitation of target salt, which may occur due to, in one embodiment, low solubility of the salt in the second solution, thus resulting in a precipitated salt formed in the bottom of the second solution.

In one embodiment, an active material may be an electrode slurry applied to a current collector. In another embodiment, additional solutions may be added to the system, wherein the additional solutions may be situated between the feed and second solution and separated by any other solutions via ion-selective solid electrolyte membranes.

In still another embodiment, a system for circulating any gaseous species formed at either the cathode or anode may be used to partially reclaim the energy input required for the system. Additionally, a second system of solutions and/or ionically selective solid electrolyte membranes may be used to recycle any gaseous species formed at either the cathode or anode.

It is to be appreciated that the system may be used in conjunction with any other membrane-assisted system, such as those used for selective extraction of alkali metal ions or hydrogen ions from a feed solution, an ion-exchange system, a system for the production of lithium metal via electrolysis (solid metal production), and/or a system for purification of alkali metal ions. This can be configured in such a way where all processes take place in series and only a single anode or cathode may be used to run all processes simultaneously.

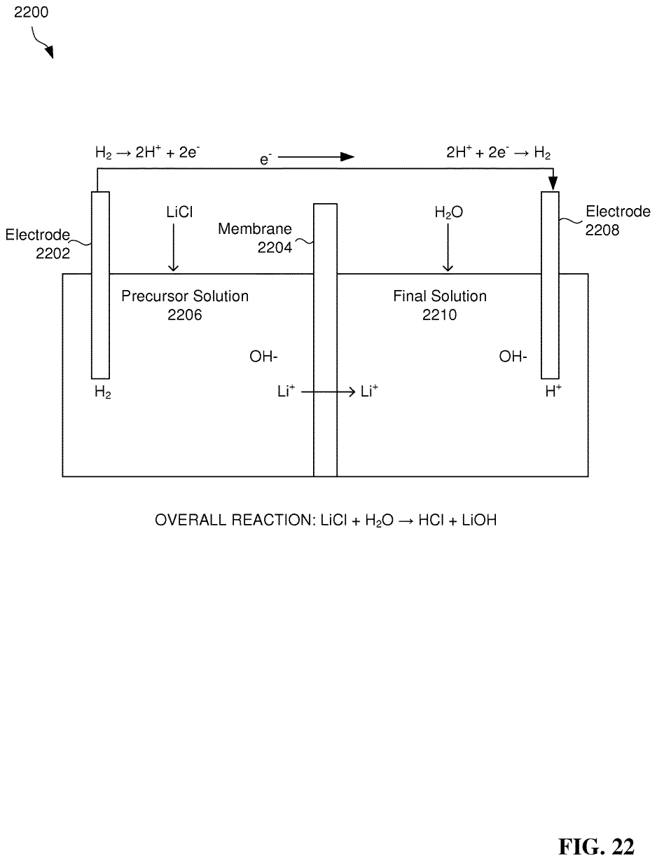

FIG. 22 illustrates redox electrode modules 2200 for ion exchange, in accordance with one embodiment. As an option, the redox electrode modules 2200 may be implemented in the context of any one or more of the embodiments set forth in any previous and/or subsequent figure(s) and/or description thereof. Of course, however, the redox electrode modules 2200 may be implemented in the context of any desired environment. Further, the aforementioned definitions may equally apply to the description below.

As shown, lithium ions (Li⁺) may pass from an anode comprised of aqueous precursor solution 2206 through a solid electrolyte membrane 2204 to a cathode comprised of an aqueous final solution 2210. In operation, lithium hydroxide (LiOH) atoms present in the aqueous precursor solution 2206 may break apart into positively-charged lithium ions and negatively-charged hydroxide (OH⁻) atoms. In addition, the lithium ions may then be drawn across the electrolyte membrane 2204 into the aqueous final solution 2210 where they may recombine with hydroxide atoms to reform into additional lithium hydroxide atoms, thus yielding a higher concentration of lithium hydroxide in the aqueous final solution 2210 upon completion of the ion exchange process. Further, the ion exchange process may simultaneously combine the actions of reduction of H⁺ at a cathode electrode 2208, forming H₂ (sent to an anode), and oxidation of H₂ at the anode electrode 2202, forming H⁺ in the precursor solution 2206.

In one embodiment, redox electrode modules 2200 may relate to a membrane-based ion exchange system. In use, an ion exchange system includes an anode, and a cathode, where the anode is configured for oxidation and the cathode is configured for reduction. Additionally, migration of a predetermined alkali metal cation through an ion-selective solid electrolyte membrane is driven by a current across the anode and the cathode. Further, the ion-selective solid electrolyte membrane may be selectively permeable to the predetermined alkali metal cation. The ion exchange system further includes a first active material associated with the anode, a second active material associated with the cathode, an anolyte solution comprising the predetermined alkali metal cation and a first anion, and a catholyte solution comprising the migrated predetermined alkali metal cation and a second anion, where the migrated predetermined alkali metal cation and the second anion are configured to combine to form a dissolved salt in the catholyte solution.

In various embodiments, the catholyte solution may include H₂O or HCl. Additionally, the H₂O or the HCl may be added at the same rate at which the predetermined alkali metal cation passes through the ion-selective solid electrolyte membrane. The catholyte solution may comprise the H₂O or the HCl as a reagent. Further, the formation may be based on a reduction of LiOH.

In various embodiments, the second anion may comprise a hydroxyl group, the predetermined alkali metal cation may comprise Li⁺, and the first anion may differ from the second anion. Additionally, the first anion and/or the second anion may include one or more of: CO₃²⁻, HCO₃⁻, NO₃⁻, PO₄³⁻, OH⁻, Cl⁻, Br⁻, or I⁻. Further, the anolyte solution and the catholyte each independently may comprise a solvent comprising one or more of: water, alcohol, ester, ether, carbonate, or hydrocarbon.

In various embodiments, the first active material includes one or more of: H₂, H₂O, OH⁻, Cl⁻, Br⁻, or I⁻; and the second active material may include one or more of: H+, H₂O, O₂, Cl₂, Br₂, or I₂. Further, the ion exchange system may include a buffer in one or more of the anolyte and the catholyte. Additionally, a second ion-selective solid electrolyte membrane may be configured to selectively allow passage of the migrated predetermined alkali metal cation, and a third solution may include the allowed migrated predetermined alkali metal ion.

In various embodiments, the dissolved salt may be an alkali metal salt, and a purity of the alkali metal salt in the catholyte may be less than a purity of the dissolved salt in the third solution. Additionally, the alkali metal salt may be insoluble in the third solution.

In various embodiments, input energy used to migrate the predetermined metal alkali ion may be saved and recovered, at least in part, as electrochemical energy of the migrated predetermined metal alkali ion at the cathode. Additionally, the input energy may correspond with an electric charge process and the electrochemical energy may correspond with an electric discharge process. Further, the recovery of the input energy may reduce a carbon footprint of a manufacturing facility.

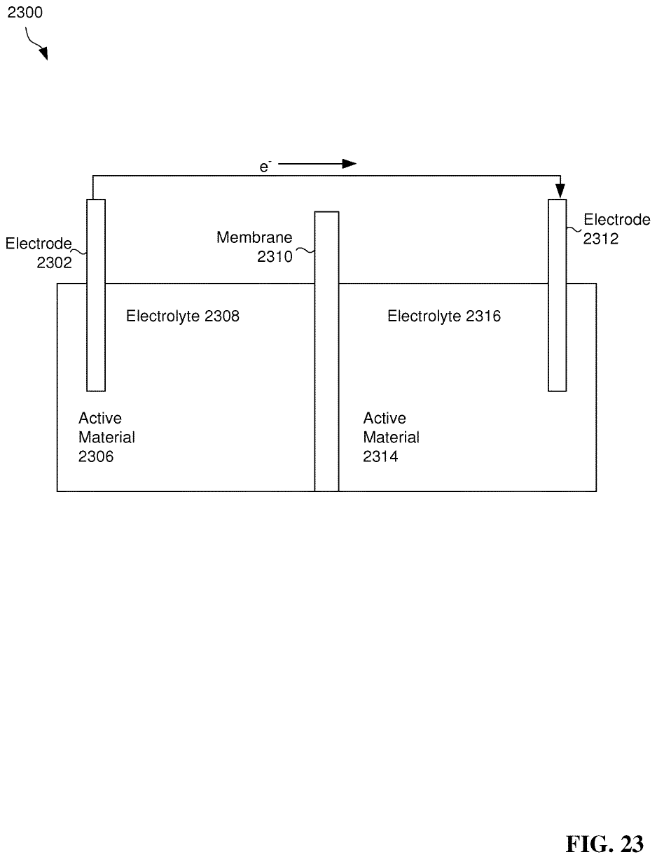

FIG. 23 illustrates a membrane separation system 2300, in accordance with one embodiment. As an option, the membrane separation system 2300 may be implemented in the context of any one or more of the embodiments set forth in any previous and/or subsequent figure(s) and/or description thereof. Of course, however, the membrane separation system 2300 may be implemented in the context of any desired environment. Further, the aforementioned definitions may equally apply to the description below.

As shown, an ion-selective solid electrolyte membrane 2310 separates anode electrolyte 2308 containing an active material 2306 from cathode electrolyte 2316 containing another active material 2314 in an exemplary system. In addition, anode electrode 2302 and cathode electrode 2312 may be in contact with anode electrolyte 2308 and anode electrolyte 2316 within the exemplary system, respectively.

In one embodiment, the ion-selective solid electrolyte membrane 2310 may facilitate various ion-oriented processes including, but not limited to purification, salt precipitation, ion exchange, ion extraction, and/or electrolysis. In a related embodiment, the ion-selective solid electrolyte membrane 2310 may comprise two or more layers of membrane to help control various aspects of ion-oriented processes including, but not limited to, increased purity of allowable ion transfer and/or rate of reaction. Additionally, the membrane separate system 2300 may be further configured as needed, including having three solutions (similar to a configuration found in FIG. 15), depending on the needs of the input feed(s), and the needs of the output. For example, a three solution separation system (such as that found in FIG. 15) may be more efficient, in one embodiment, for an assembly for continuous processing.

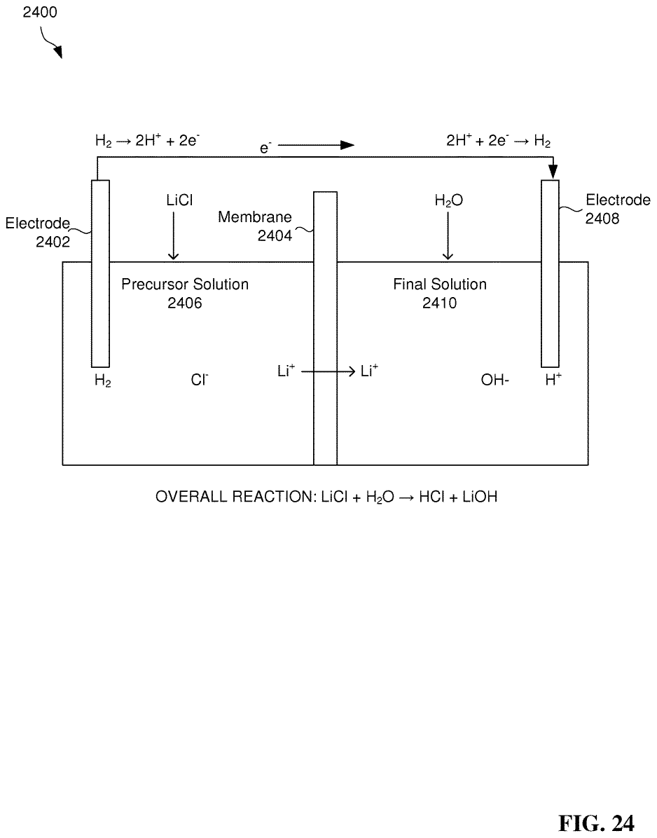

FIG. 24 illustrates redox electrode modules 2400 for ion exchange, in accordance with one embodiment. As an option, the redox electrode modules 2400 may be implemented in the context of any one or more of the embodiments set forth in any previous and/or subsequent figure(s) and/or description thereof. Of course, however, the redox electrode modules 2400 may be implemented in the context of any desired environment. Further, the aforementioned definitions may equally apply to the description below.

As shown, lithium ions (Li⁺) may pass from an anode comprised of aqueous precursor solution 2406 through a solid electrolyte membrane 2404 to a cathode comprised of an aqueous final solution 2410. In operation, lithium hydroxide (LiOH) atoms present in the aqueous precursor solution 2406 may break apart into positively-charged lithium ions and negatively-charged hydroxide (OH) atoms. In addition, the lithium ions may then be drawn across the electrolyte membrane 2404 into the aqueous final solution 2410 where they may recombine with hydroxide atoms to reform into additional lithium hydroxide atoms, thus yielding a higher concentration of lithium hydroxide in the aqueous final solution 2410 upon completion of the ion exchange process. Further, the ion exchange process may simultaneously combine the actions of reduction of H⁺ at a cathode electrode 2408, forming H₂ (sent to an anode), and oxidation of H₂ at the anode electrode 2402, forming H⁺ in the precursor solution 2406.

In conventional systems, cations and/or anions may be exchanged by the use of ion-exchange resins. However, use of these resins may limit the extent of ion exchange (i.e., the resulting materials are less pure than they could be). Additionally, ion exchange resins for lithium, specifically, are far less successful compared to other ions. In contrast, the processes detailed herein enable enabling the ability to exchange cations and/or anions of various ionic compounds, including lithium compounds, in a cost-effective and highly-selective, complete manner which can simplify the processing of a wide range of materials, reduce costs, and allow for a wider range of material precursors to fit into current processes that require specific cations and/or anions.

In one embodiment, a system for ion exchange of ionic compounds containing an alkali metal cation may comprise two electrodes including a carbon rod with a platinum catalyst on the anode side and a carbon or metal rod and/or mesh on the cathode side, two active materials (including, but not limited to hydrogen on the anode side and hydrogen ions on the cathode side, etc.), two liquid electrolytes (including but not limited to an anode electrolyte, anolyte, containing a solvent like water), a cation (including but not limited to hydrogen ions, lithium ions, sodium ions, potassium ions, etc.), anions (including but not limited to carbonate, bicarbonate (HCO₃⁻), nitrate (NO₃⁻), phosphate (PO₄³⁻), hydroxide, chlorine ions, bromine ions, iodine ions, etc.), a buffer (optional), and/or feed salt dissolved in the solvent, a cathode liquid electrolyte (catholyte) containing a solvent like water, a final anion (which is the desired target product of the ion exchange system), an ion-selective solid electrolyte membrane (including solid electrolyte particles such as but not limited to lithium, aluminum, titanium phosphate, lithium aluminum, germanium phosphate, NASICON, potassium Ferrate (K₂Fe₄O₇), etc.), a matrix of epoxy and/or polymers, and mechanical fillers like carbon and/or ceramic particles.

In one embodiment, the anode active material may include, but not be limited to, hydroxide, chlorine ions, bromine ions, and/or iridium ions. In a related embodiment, the cathode active material may include, but not be limited to, oxygen, chlorine, bromine, and/or iodine. In another embodiment, the anolyte may include, but not be limited to, alcohols, esters, ethers, carbonates, and/or hydrocarbons. In yet another embodiment, the feed salt may be the source of one or more of the cations, anions, the buffer, and/or anode active material. In still another embodiment, the catholyte may also include, but not be limited to, alcohols, esters, ethers, carbonates, and/or hydrocarbons. In one embodiment, the final anion may be in the form of an acid (for example, if the final anion is bromine ions, then hydrogen bromide (HBr) may be dissolved in the liquid electrolyte to provide bromine ions, etc.). In a related embodiment, the final anion may be the source of one or more of the anions, buffer, and/or cathode active material.

In operation, the process for ion exchange of ionic compounds containing an alkali metal cation may include passing current from the anode to cathode, which may result in reduction of the cathode active material and oxidation of the anode active material. This current may also cause a spontaneous migration of the target cations (e.g., lithium ions) across the solid electrolyte membrane from the anolyte to the catholyte, resulting in the catholyte (which may initially contain the “final anion”) containing a dissolved salt of the alkali metal cation and target anion.

In one embodiment, the process for ion exchange of ionic compounds containing an alkali metal cation may be performed in series or in parallel with other separation processes using the ion-selective solid electrolyte membrane, such as alkali metal purification, direct lithium extraction, salt precipitation, or alkali metal production. In another embodiment, if the product at the cathode is a gas (such as hydrogen, for example), the product may be transferred to the anode and function as the active material, thereby enabling partial recovery of the energy required to drive the cathode side reaction.

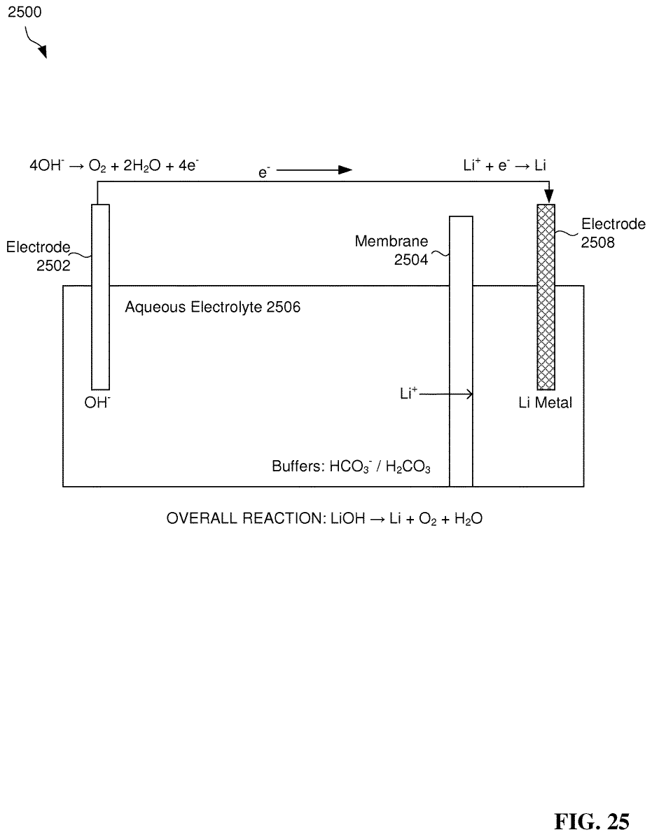

FIG. 25 illustrates membrane-based alkali metal production 2500, in accordance with one embodiment. As an option, the membrane-based alkali metal production 2500 may be implemented in the context of any one or more of the embodiments set forth in any previous and/or subsequent figure(s) and/or description thereof. Of course, however, the membrane-based alkali metal production 2500 may be implemented in the context of any desired environment. Further, the aforementioned definitions may equally apply to the description below.

As shown, lithium ions (Li⁺) may pass from an anode comprised of aqueous electrolyte 2506 through a solid electrolyte membrane 2504 to a cathode comprised of an alkali metal—in this instance, lithium metal. In operation, lithium hydroxide atoms present in the aqueous electrolyte 2506 may break apart into positively-charged lithium ions and negatively-charged hydroxide (OH⁻) atoms. In addition, the lithium ions may then be drawn across the electrolyte membrane 2504 to the cathode containing the aggregated alkali metal (such as Li+ metal). Additionally, the alkali metal production may simultaneously combine the actions of reduction of Li+ at a cathode electrode 2508, forming lithium metal, and oxidation of OH— at the anode electrode 2502, forming O₂ and/or H₂O waste. Further, to prevent corrosion and degradation of the effectiveness of the solid electrolyte membrane 2504, a suitable buffer may be used to coat the solid electrolyte membrane 2504 in the case of contact with the aqueous electrolyte 2506. By way of example, the compound used to comprise the buffer in the aqueous electrolyte 2506 may include bicarbonate (HCO₃⁻) and/or carbonic acid (H₂CO₃).

In one embodiment, the resulting alkali metal may be in solid and/or liquid metal form upon completion of the alkali metal production process.

In one embodiment, the membrane-based alkali metal production 2500 may relate to a membrane-based alkali metal production system. In use, an alkali metal production system includes an anode, and a cathode, where the anode is configured for oxidation and the cathode is configured for reduction. Additionally, migration of a predetermined metal ion through an ion-selective solid electrolyte membrane is driven by a current across the anode and the cathode. Further, the ion-selective solid electrolyte membrane is selectively permeable to the predetermined metal ion. The alkali metal production system further includes at least one active material, a first solution comprising an aqueous electrolyte (where the aqueous electrolyte includes the predetermined metal ion), and a second solution comprising a metal atom based on the migrated predetermined metal ion, wherein the second solution is at least partially disposed in a liquid state of the metal atom.

In various embodiments, the at least one active material includes a hydroxyl group for the anode, and/or the at least one active material includes lithium metal for the cathode. Additionally, the liquid state is a molten solution of the metal atom.

In various embodiments, the anode is a carbon rod, and/or the carbon rod includes a Pt catalyst. Additionally, the cathode may comprise a carbon rod or mesh, or a metal rod or mesh. Further, the at least one active material for the anode may include at least one of: H₂, OH⁻, Cl⁻, Br⁻, or I⁻.

In various embodiments, the at least one active material for the cathode may include a liquid metal. The liquid metal may within the temperature range of 25° C.-250° C. Additionally, the liquid metal may be configured to form a molten alloy with lithium. The liquid metal may include one of: Ga, Ga—In, Na—K alloys, Na—K—Cs alloys, or Ga—In—Sn alloys.

In another embodiment, a system for alkali metal production is provided, which includes a first electrode, a first electrolyte comprising an alkali metal salt, where the first electrolyte is configured to be in contact with the first electrode, and a second electrode, where when a current is passed from the first electrode to the second electrode, the current causes migration of an alkali metal ion of the alkali metal salt. Additionally, an ion-selective solid electrolyte membrane is configured to selectively allow the alkali metal ion to migrate. A second solution includes an alkali metal atom based on the migrated alkali metal ion and galinstan (i.e. Ga—In—Sn alloy). Additionally, the system includes a third electrode, where when a second current passed from the second electrode to the third electrode, the second current causes second migration of the alkali metal atom of the second solution. A second ion-selective solid electrolyte membrane is configured to selectively allow the alkali metal atom to migrate, and a third solution includes the second migrated alkali metal atom.

In various embodiments, the second migrated alkali metal atom may be in a molten state. Additionally, the migration may occur at ambient conditions, and/or the second migration may occur at controlled conditions, wherein the controlled conditions include at least one of: an inert environment, or Ar atmosphere.

In various embodiments, a thickness of the second ion-selective solid electrolyte membrane may be configured to increase a purity of the second migrated alkali metal atom. Additionally, the migration and the second migration may occur concurrently, and/or the migration and the second migration may occur in series or a batch configuration.

In various embodiments, the alkali metal ion may be Li⁺, and/or the second solution may include lithiated galinstan. Further, the third solution may include only the second migrated alkali metal atom.

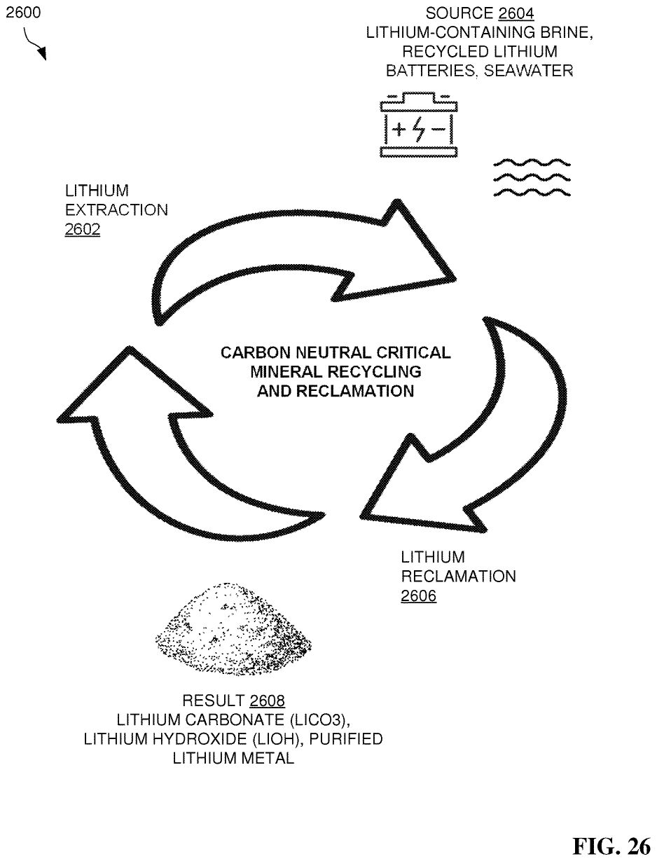

FIG. 26 illustrates a process 2600 for carbon neutral critical mineral recycling and reclamation, in accordance with one embodiment. As an option, the process 2600 may be implemented in the context of any one or more of the embodiments set forth in any previous and/or subsequent figure(s) and/or description thereof. Of course, however, the process 2600 may be implemented in the context of any desired environment. Further, the aforementioned definitions may equally apply to the description below.

As shown, a process for carbon neutral critical mineral recycling and reclamation 2600 may include cyclical steps including, but not limited to, a critical mineral (in this instance, lithium) source 2604, lithium reclamation 2606, a critical mineral and result 2608, and lithium extraction 2602. In operation, the process 2600 may begin with the lithium source(s) from which lithium metal may ultimately be extracted in the form of lithium-containing brine, recycled lithium batteries, and/or seawater. Additionally, lithium reclamation 2606 subprocesses may be employed to produce resulting materials (the result 2608) including, but not limited to, lithium carbonate (LiCO₃), lithium hydroxide (LiOH), and purified lithium metal. In addition, lithium extraction 2602 may be employed to provide raw lithium metal and/or other forms of lithium for use in products and/or processes such as new lithium battery electrolytes for anodes and cathodes, by way of one example. Further, once such new lithium-based products have reached the end of their practical and/or useful life, those products may again become lithium source 2604 materials to initiate another process for carbon neutral critical mineral recycling and reclamation 2600. In this manner, the lithium extraction 2602 and the lithium reclamation 2606 steps may provide for a near carbon neutral system for extracting lithium from sources, and producing a lithium that can be reused. Additionally, although the process 2600 is discussed in particular with respect to lithium, it is to be appreciated that the process 2600 may apply in like manner to any critical mineral.

In one embodiment, the process 2600 may relate to an energy reclamation and carbon-neutral system for critical mineral extraction. In use, a method for critical mineral reclamation includes driving migration of lithium ions using a current passing from an anode to cathode, where the current is driven by a redox configuration of the anode and the cathode. Additionally, the lithium ions are extracted from a first solution into a second solution through an ion-selective solid electrolyte membrane, where the ion-selective solid electrolyte membrane is configured to selectively allow the lithium ions to pass. Further, an input of energy is provided for the extraction, and after the extraction, a reclamation of the lithium ions is caused, where the reclamation recovers at least a portion of the input of energy.

In various embodiments, the reclamation may include converting the lithium ions to lithium carbonate or lithium hydroxide. Additionally, the reclamation may include purifying the lithium ions to a minimum of 99.9% desired lithium salt, or 99.9% lithium trace metals basis. Further, the input of energy may be stored as electrochemical energy of the lithium ions.

In various embodiments, recovering the at least a portion of the input of energy may reduce a carbon footprint of a manufacturing facility. Additionally, the first solution may be based on at least one of lithium minerals, lithium-containing brines, recycled lithium batteries, geothermal brines, salar brines, or seawater.

In various embodiments, the ion-selective solid electrolyte membrane may be water impermeable. Additionally, the reclamation may include transporting the lithium ions from the second solution to a third solution via the ion-selective solid electrolyte membrane, and/or transporting second ions from the third solution to a fourth solution via a second ion-selective solid electrolyte membrane, wherein the transporting of the second ions from the third solution to the fourth solution coincides with the transporting of the lithium ions from the second solution to the third solution. Still yet, extracting the lithium ions from the first solution to the second solution may coincide with an uptake of second ions from a third solution to the first solution.

In various embodiments, the first solution may be a feed solution, the second solution may be an anolyte, a third solution may be a catholyte, and a second ion-selective solid electrolyte membrane may be selectively permeable to sodium. The anolyte may include a lithium electrolyte and the catholyte may include a sodium electrolyte. Additionally, at least one of the anode or the cathode may be made of stainless steel mesh. The extraction of the lithium ions from the first solution to the second solution may coincide with an extraction of sodium ions from the third solution to the first solution, and the reclamation of the lithium ions may include transporting the lithium ions from the second solution to a fourth solution which may coincide with transporting the sodium ions from the fourth solution to the third solution. Further, the transporting of the lithium ions may coincide with an electric discharge of electrochemical energy of the lithium ions.

In various embodiments, the extraction and reclamation may be performed, at least in part, using a lithium module which includes the ion-selective solid electrolyte membrane, the second solution (where the second solution includes a lithium electrolyte), and an active material electrode in direct contact with the second solution. Additionally, the extraction and reclamation may be further performed, at least in part, using a sodium module which includes a second ion-selective solid electrolyte membrane (where the second ion-selective solid electrolyte membrane is sodium selective), a third solution (where the third solution includes a sodium electrolyte), and a second active material electrode in direct contact with the third solution. Further, the lithium module and the sodium module may be configured to be part of a module array, the module array configured to have multiple lithium modules comprising the lithium module, and multiple sodium modules comprising the sodium module.

In various embodiments, the first solution may be a feed solution that flows into the module array and between each of the multiple lithium modules and each of the multiple sodium modules. Additionally, the first solution may be used for the extraction, and a fourth solution may be used for the reclamation, where the first solution differs from the fourth solution, and the fourth solution replaces the third solution after the extraction. Further, the first solution may comprise at least one of lithium minerals, lithium-containing brines, recycled lithium batteries, geothermal brines, salar brines, or seawater, and the fourth solution may comprise a Na₂CO₃ feed.

In various embodiments, the multiple lithium modules and the multiple sodium modules may be configured to be connected in, at least one of, series, parallel, or a combination of series and parallel. Further, the extraction and the reclamation may facilitate recycling of lithium ions, which in turn may reduce a carbon footprint of a manufacturing facility and may allow for sustainable reuse of lithium batteries.

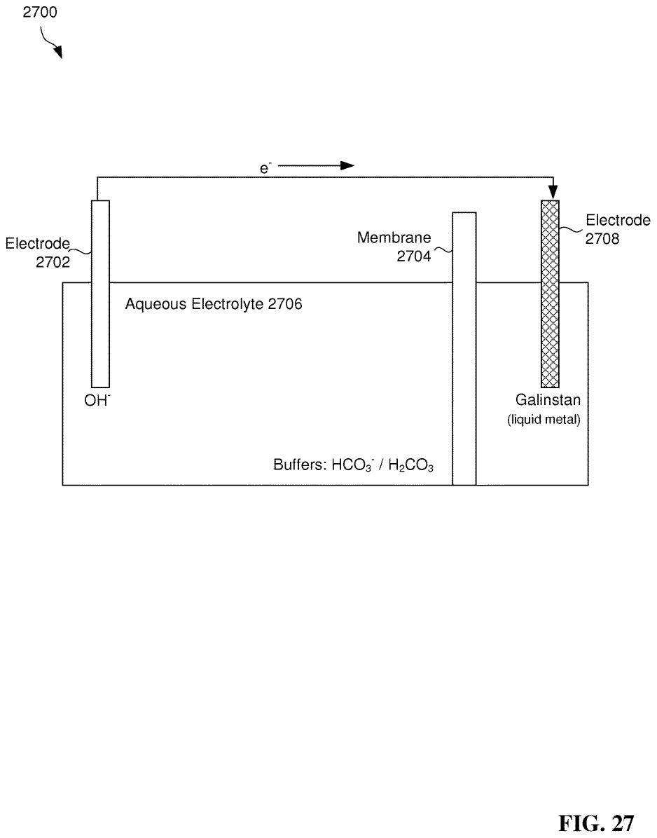

FIG. 27 illustrates membrane-based alkali metal production 2700, in accordance with one embodiment. As an option, the membrane-based alkali metal production 2700 may be implemented in the context of any one or more of the embodiments set forth in any previous and/or subsequent figure(s) and/or description thereof. Of course, however, the membrane-based alkali metal production 2700 may be implemented in the context of any desired environment. Further, the aforementioned definitions may equally apply to the description below.

As shown, lithium ions (Li⁺) may pass from an anode comprised of aqueous electrolyte 2706 through a lithium ion-selective solid electrolyte membrane 2704 to a cathode comprised of lithiated galinstan (Ga—In—Sn) liquid metal. In operation, lithium hydroxide atoms present in the aqueous electrolyte 2706 may break apart into positively-charged lithium ions and negatively-charged hydroxide (OH) atoms. In addition, the lithium ions may then be drawn across the lithium ion-selective solid electrolyte membrane 2704 into the cathode containing the lithiated galinstan liquid metal. Additionally, the alkali metal production may simultaneously combine the actions of reduction of galinstan at a carbon/metal rod/metal mesh 2708, resulting in the recombination of lithium ions and electrons to form a lithiated galinstan liquid metal, and oxidation of OH— at a carbon rod with Pt catalyst 2702, producing oxygen gas (O₂), water (H₂O), and electrons. Further, to prevent corrosion and degradation of the effectiveness of the lithium ion-selective solid electrolyte membrane 2704, a suitable buffer may be used to coat the lithium ion-selective solid electrolyte membrane 2704 in the case of contact with the aqueous electrolyte 2706. By way of example, the compound used to comprise the buffer in the aqueous electrolyte 2706 may include bicarbonate (HCO₃⁻) and/or carbonic acid (H₂CO₃).

In various embodiments, conventional lithium precursors may undergo a series of many complex steps to be converted and purified into lithium chloride (LiCl) and may be separated from any associated solution (i.e., dry), which can be expensive, as lithium chloride and other precursors are hygroscopic, making water difficult and expensive to remove. In addition, downs cell electrolysis is currently only possible via high-temperature electrolysis of a lithium chloride/potassium chloride (KCl) eutectic system, producing toxic chlorine gas as a byproduct. Yet, the downs cell electrolysis system remains the only current economically feasible method for producing lithium metal. In contrast, using lithium salt of any purity as a precursor for lithium metal electrolysis (metal production), as shown in the membrane-based alkali metal production 2700 allows for the entire lithium metal value chain to be much more simple and cheaper and may have fewer points of potential failure. Additionally, the lithium salt may be processed at lower temperatures that do not require distillation for removal, do not introduce potassium impurities, and/or do not affect treatment of undesired chlorine byproducts, thus making the cost of production much cheaper and remove many safety concerns.

It is to be appreciated that within the context of the present description, the term electrolysis refers to any system where an electric current is passed through a substance to effect a chemical change. Further metal electrolysis may include metal production such that, as a result of the electrolysis, compounds may be separated into their discrete parts (including a molten liquid form of metal). The term metal electrolysis and metal production may therefore be used interchangeably within the context of the present description.

In one embodiment, the metal electrolysis process may consist of different designs for an ion-selective solid electrolyte membrane separator and a process for the production of lithium metal from any aqueous precursor. For example, a first separator design may comprise two electrodes, including an anode in the form of a carbon rod with a platinum catalyst, and a cathode in the form of a carbon/metal rod and/or mesh. In addition, the first separator may comprise two active materials, including hydroxide (OH⁻) anions, as well as other materials such as hydrogen gas (H₂), chlorine ions (Cl—), bromine ions (Br—), and/or iridium ions (I—) on the anode side and a metal that remains in liquid state and features low volatility in the 25-250 Celsius temperature range, and may form a molten alloy with lithium. The range of solubility of lithium in the alloy may include at least a small region where the alloy remains molten and has a high reduction potential on the cathode side. In one embodiment, materials comprising the cathode may include gallium, gallium-indium, and gallium-indium alloys (galinstan). It is envisioned that other materials (for active materials, cathode, anode, etc.) may be selected.

The first separator may comprise a liquid electrolyte (anolyte) of, in one embodiment, water, cations including lithium ions (which also may also be used for sodium ions and potassium ions for the production of sodium and potassium, respectively), anions including hydroxide and carbonate (CO3²⁻), a buffer of carbonic acid/bicarbonate, and/or an ion-selective solid electrolyte membrane. In an alternate embodiment, the liquid electrolyte (anolyte) may also contain alcohols, carbonates, ethers, hydrocarbons, esters, and ionic liquids. In a related embodiment, other potential anions may include bicarbonate, chloride, bromide, iodide, perchlorate, nitrate, sulfate, and/or phosphate. In another embodiment, the buffer may be comprised of lead sulfide (PBS), HEPES, and/or acetate.

In various embodiment, the second separator may comprise two electrodes including an anode in the form of a stainless steel slab and a cathode in the form of a carbon rod and/or mesh, two active materials including lithiated liquid metal on the anode side and molten lithium metal on the cathode side, and/or an ion-selective solid electrolyte membrane. The ion-selective solid electrolyte membrane may be composed of ion-selective solid electrolyte material including, but not limited to Li₁₀GeP₂S₁₂ (LGPS), Li₇La₃Zr₂O₁₂ (LLZO), lithium aluminum titanium phosphate (LATP), and/or lithium aluminum germanium phosphate (LAGP), a matrix (which may or may not include solid electrolyte material). The ion-selective solid electrolyte membrane may also include a lithium-stable layer of lithium fluoride and/or lithium oxide (Li₂O) in contact with the molten lithium-facing (cathode) side, and/or additives (including but not limited to one or more of a variety of carbons including graphene, graphite, cyanate, diamond, and/or boron nitride). In one embodiment, the anode may also comprise metals such as aluminum, copper, titanium, nickel, and/or carbon.

In one embodiment, lithium metal production may include two steps. It is acknowledged that the lithium metal production process may be set up in series or parallel (for continuous processing). In any event, it is to be understood that the number of steps may fluctuate (increase or decrease) depending on the setup and implementation of the process. As such, in an exemplary configuration, the first step may include a process wherein lithium salt may be fed to the electrolyte, and current may be passed from an anode to a cathode. In one embodiment, the feeding in of the lithium salt to the electrolyte may occur continuously. This first step may result in: oxidation of the active material (such as hydroxide) and formation of electrons at the anode, a potential (electric and/or chemical) forming across the ion-selective membrane, migration of alkali metal ions across the membrane as a result of the potential, and/or reduction of the active material (such as galinstan) at the cathode. As such, this first step may result in the recombination of the lithium ions with electrons and the lithiation of galinstan. In the exemplary configuration, a second step may include a process where lithiated galinstan (from the first step) may be fed to the anode (of a separate cell), and a current may be passed from the anode to the cathode. This second step may result in: oxidation of the active material (such as lithiated galinstan) and the formation of electrons at the anode, a potential forming across the ion-selective membrane, migration of alkali metal ions across the membrane as a result of the potential, and/or reduction of the active material (such as molten lithium) at the cathode. As such, this second step may result in the recombination of lithium ions with electrons and the production of additional molten lithium. In one embodiment, the feeding of the lithiated galinstan to the anode may occur continuously.

In one embodiment, the first and second steps in the exemplary lithium metal production process may be performed concurrently, where the product of the first step (lithiated galinstan) may be continuously fed and/or circulated back to the anode for the second step. In a related embodiment, both steps may also be performed in a batch process, where the active material may be first fully transferred into a separation system before a current is applied. In another embodiment, the first step may be done in an inert environment (for example, an argon atmosphere). Additionally, the first step may also be performed in a dry room environment and/or in ambient conditions. In still another embodiment, the second step may also be performed in an inert argon atmosphere.

In one embodiment, each membrane may be substituted for a thicker membrane and/or multiple membranes in series to increase the purity of the final product (and/or to protect the integrity of the membrane from the harsh conditions of the lithiated galinstan).

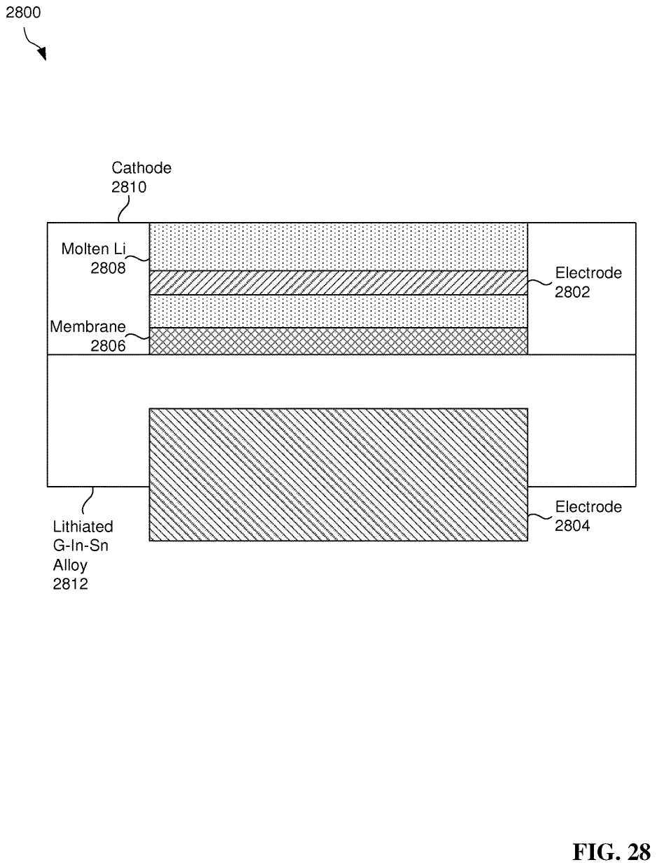

FIG. 28 illustrates another implementation of membrane-based alkali metal production 2800, in accordance with one embodiment. As an option, the other implementation of membrane-based alkali metal production 2800 may be implemented in the context of any one or more of the embodiments set forth in any previous and/or subsequent figure(s) and/or description thereof. Of course, however, the other implementation of membrane-based alkali metal production 2800 may be implemented in the context of any desired environment. Further, the aforementioned definitions may equally apply to the description below.

As shown, lithium ions (Li+) may pass from an anode comprised of lithiated galinstan (Ga—In—Sn) alloy 2812 through a lithium ion-selective solid electrolyte membrane 2806 to a cathode 2810 comprised of molten lithium 2808. In operation, lithiated galinstan alloy may be continuously fed into the anode (if an adequate amount of such lithiated galinstan alloy is not already present) where lithium ions may then be drawn across the lithium ion-selective solid electrolyte membrane 2806 into the cathode comprised of molten lithium 2808. Additionally, the alkali metal production process may simultaneously combine the actions of oxidation of galinstan-Li at a stainless steel slab electrode 2804, resulting in lithium ions and electrons, and reduction at the carbon rod/metal mesh 2802 where lithium ions are recombined with electrons to form the new lithium metal.

In one embodiment, the lithium ion-selective solid electrolyte membrane 2806 may comprise a layer of Li₁₀GeP₂S₁₂ (LGPS) with a lithium-stable coating of, for example, lithium fluoride (LiF) and/or lithium oxide (Li₂O).

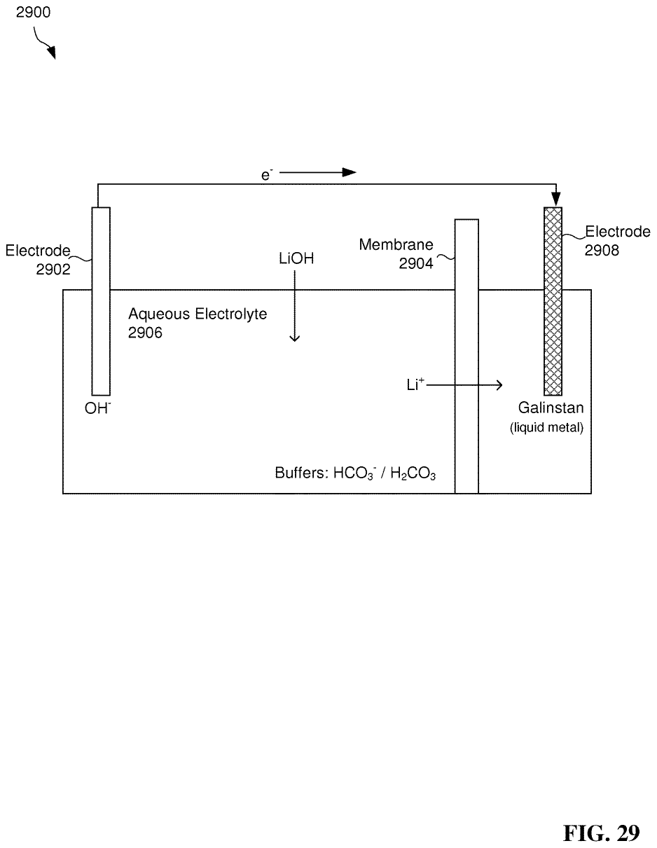

FIG. 29 illustrates membrane-based alkali metal production 2900, in accordance with one embodiment. As an option, the membrane-based alkali metal production 2900 may be implemented in the context of any one or more of the embodiments set forth in any previous and/or subsequent figure(s) and/or description thereof. Of course, however, the membrane-based alkali metal production 2900 may be implemented in the context of any desired environment. Further, the aforementioned definitions may equally apply to the description below.

As shown, lithium ions (Li⁺) may pass from an anode comprised of aqueous electrolyte 2906 through a lithium ion-selective solid electrolyte membrane 2904 to a cathode comprised of lithiated galinstan (Ga—In—Sn) liquid metal. In operation, lithium hydroxide atoms may be continuously fed into the aqueous electrolyte 2906 (if an adequate amount of lithium hydroxide is not already present) and may break apart into positively-charged lithium ions and negatively-charged hydroxide (OH) atoms. In addition, the lithium ions may then be drawn across the lithium ion-selective solid electrolyte membrane 2904 into the cathode containing the lithiated galinstan liquid metal. Additionally, the alkali metal production may simultaneously combine the actions of reduction of galinstan at a carbon/metal rod/metal mesh 2908, resulting in the recombination of lithium ions and electrons to form a lithiated galinstan liquid metal, and oxidation of OH— at a carbon rod with Pt catalyst 2902, producing O₂, H₂O, and electrons. Further, to prevent corrosion and degradation of the effectiveness of the lithium ion-selective solid electrolyte membrane 2904, a suitable buffer may be used to coat the lithium ion-selective solid electrolyte membrane 2904 in the case of contact with the aqueous electrolyte 2906. By way of example, the compound used to comprise the buffer in the aqueous electrolyte 2906 may include bicarbonate (HCO₃₋) and/or carbonic acid (H₂CO₃).

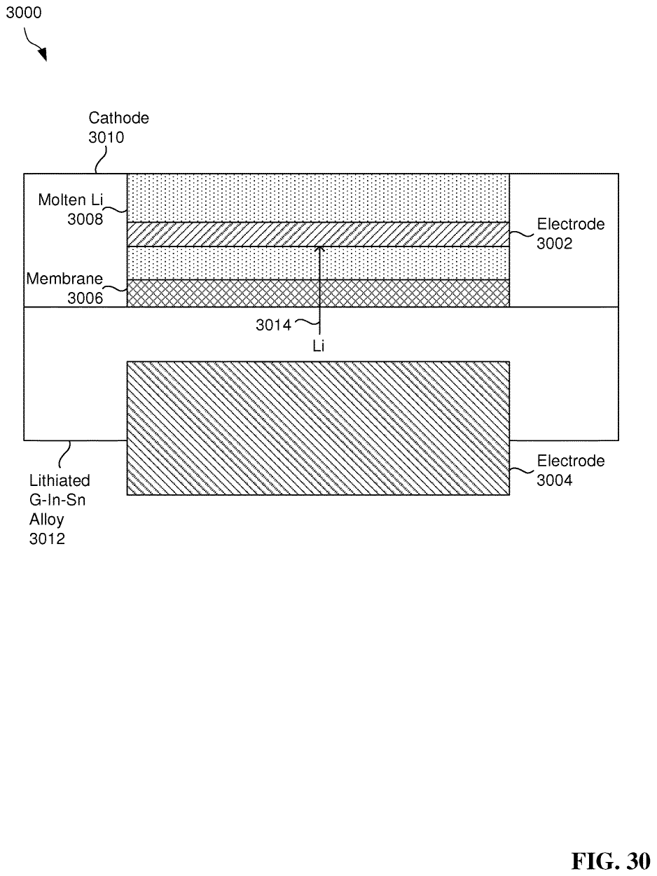

FIG. 30 illustrates another implementation of membrane-based alkali metal production 3000, in accordance with one embodiment. As an option, the other implementation of membrane-based alkali metal production 3000 may be implemented in the context of any one or more of the embodiments set forth in any previous and/or subsequent figure(s) and/or description thereof. Of course, however, the other implementation of membrane-based alkali metal production 3000 may be implemented in the context of any desired environment. Further, the aforementioned definitions may equally apply to the description below.

As shown, lithium ions (Lit) 3014 may pass from an anode comprised of lithiated galinstan (Ga—In—Sn) alloy 3012 through a lithium ion-selective solid electrolyte membrane 3006 to a cathode 3010 comprised of molten lithium 3008. In operation, lithiated galinstan alloy may be continuously fed into the anode (if an adequate amount of such lithiated galinstan alloy is not already present) where lithium ions 3014 may then be drawn across the lithium ion-selective solid electrolyte membrane 3006 into the cathode comprised of molten lithium 3008. Additionally, the alkali metal production process may simultaneously combine the actions of oxidation of galinstan-Li at a stainless steel slab electrode 3004, resulting in lithium ions 3014 and electrons, and reduction at the carbon rod/metal mesh 3002 where lithium ions 3014 are recombined with electrons to form the new lithium metal.

In one embodiment, the lithium ion-selective solid electrolyte membrane 3006 may comprise a layer of Li₁₀GeP₂S₁₂ (LGPS) with a lithium-stable coating of, for example, lithium fluoride (LiF) and/or lithium oxide (Li₂O).

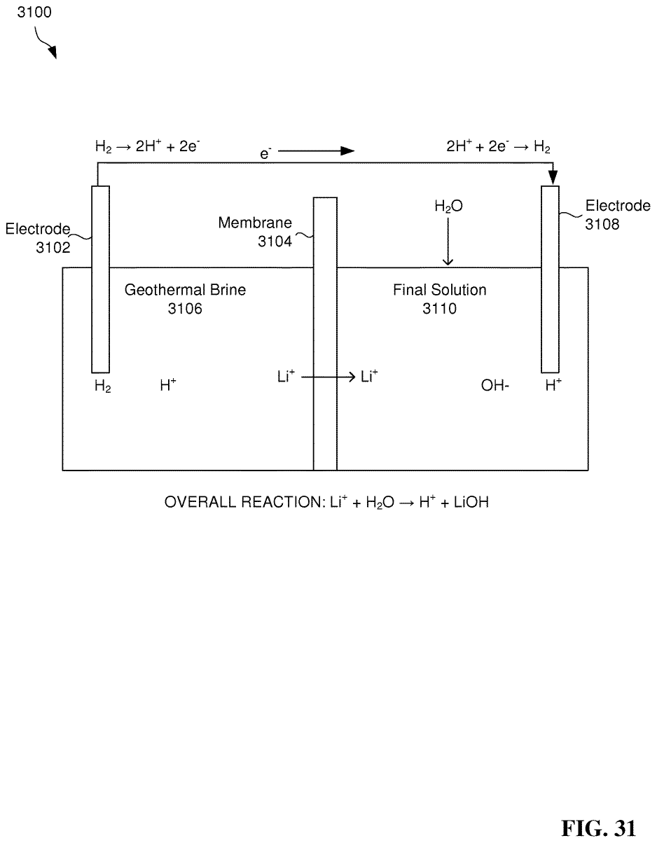

FIG. 31 illustrates a redox electrode system 3100 for alkali metal extraction, in accordance with one embodiment. As an option, the redox electrode system 3100 may be implemented in the context of any one or more of the embodiments set forth in any previous and/or subsequent figure(s) and/or description thereof. Of course, however, the redox electrode system 3100 may be implemented in the context of any desired environment. Further, the aforementioned definitions may equally apply to the description below.

As shown, lithium ions (Li⁺) may pass from an anode comprised of geothermal brine 3106 through a solid electrolyte membrane 3104 to a cathode comprised of an aqueous final solution 3110. In operation, lithium hydroxide (LiOH) atoms present in the geothermal brine 3106 may react with an H₂O reagent and break apart into positively-charged lithium ions and negatively-charged hydroxide (OH) atoms. In addition, the lithium ions may then be drawn across the electrolyte membrane 3104 into the aqueous final solution 3110 where they may recombine with hydroxide atoms to reform into lithium hydroxide atoms, thus yielding a concentration of lithium hydroxide in the aqueous final solution 3110 upon completion of the alkali metal extraction process. Further, the alkali metal extraction process may simultaneously combine the actions of reduction of H⁺ at a cathode electrode 3108, forming H₂ (sent to an anode), and oxidation of H₂ at the anode electrode 3102, forming H⁺ waste.

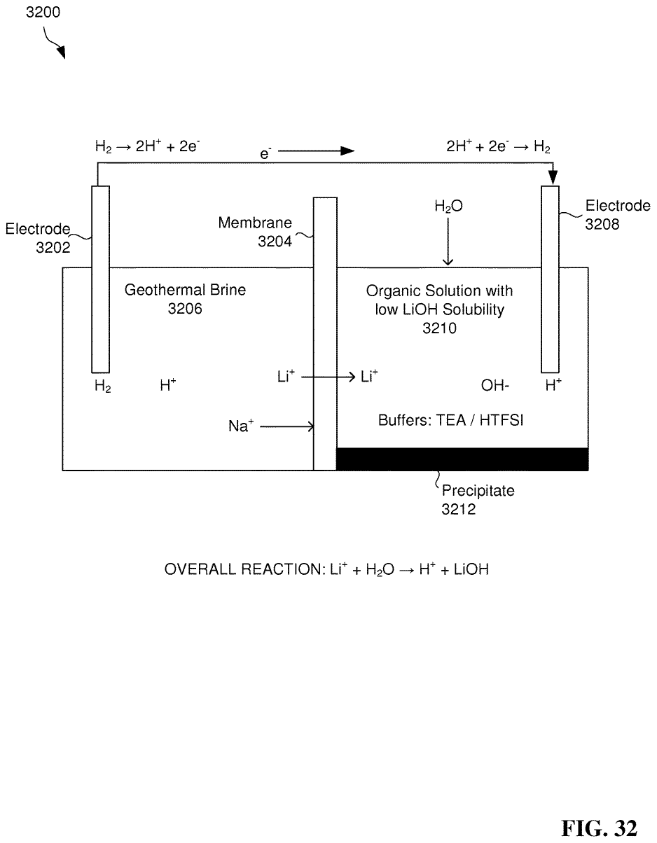

FIG. 32 illustrates a redox electrode system 3200 for alkali metal extraction and precipitation, in accordance with one embodiment. As an option, the redox electrode system 3200 may be implemented in the context of any one or more of the embodiments set forth in any previous and/or subsequent figure(s) and/or description thereof. Of course, however, the redox electrode system 3200 may be implemented in the context of any desired environment. Further, the aforementioned definitions may equally apply to the description below.

As shown, lithium ions (Lit) may pass from an anode comprised of geothermal brine 3206 through a solid electrolyte membrane 3204 to a cathode comprised of an organic solution with low LiOH solubility 3210. In operation, lithium hydroxide (LiOH) atoms present in the geothermal brine 3206 may react with an H₂O reagent and break apart into positively-charged lithium ions and negatively-charged hydroxide (OH⁻) atoms. In addition, the lithium ions may then be drawn across the electrolyte membrane 3204 into the organic solution with low LiOH solubility 3210 where they may recombine with hydroxide atoms to reform into lithium hydroxide atoms, thus yielding a concentration of lithium hydroxide in the organic solution with low LiOH solubility 3210 resulting in the formation of a concentrated precipitate salt 3212 upon completion of the alkali metal extraction process. Additionally, the alkali metal extraction process may simultaneously combine the actions of reduction of H⁺ at a cathode electrode 3208, forming H₂ (sent to an anode), and oxidation of H₂ at the anode electrode 3202, forming H⁺ waste. Further, to prevent corrosion and degradation of the effectiveness of the solid electrolyte membrane 3204, a suitable buffer may be used to coat the solid electrolyte membrane 3204 in the case of contact with the organic solution with low LiOH solubility 3210. By way of example, the compound used to comprise the buffer in the organic solution with low LiOH solubility 3210 may include Triethylamine (TEA) and/or bis(trifluoromethanesulfonyl)imide (HTFSI).

The redox electrode system 3200 shows, in particular, that many of the processes disclosed herein (such as extraction, purification, ion exchange, precipitation, etc.) may be combined together as desired to create an efficient process.

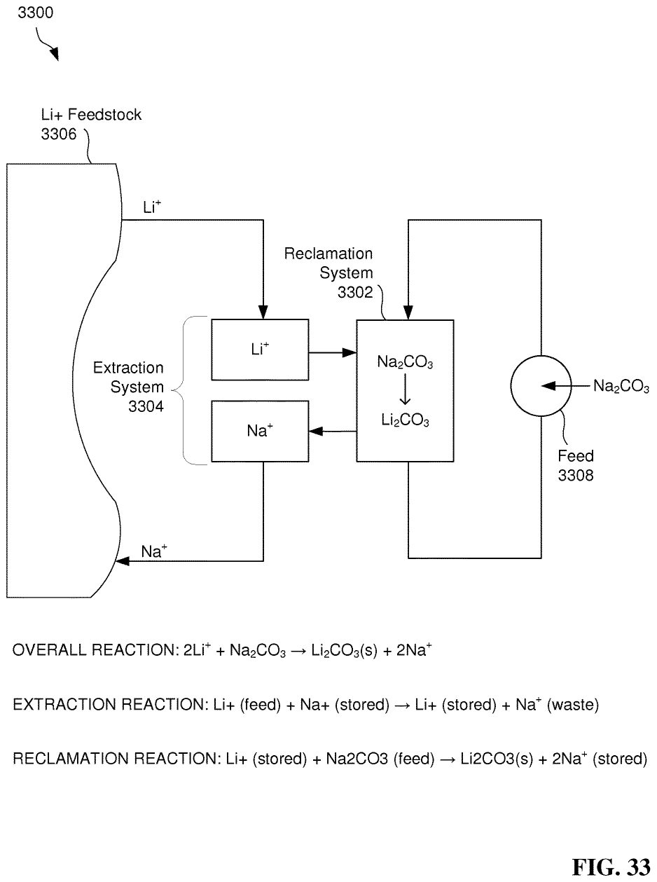

FIG. 33 illustrates a lithium extraction system 3300, in accordance with one embodiment. As an option, the lithium extraction system 3300 may be implemented in the context of any one or more of the embodiments set forth in any previous and/or subsequent figure(s) and/or description thereof. Of course, however, the lithium extraction system 3300 may be implemented in the context of any desired environment. Further, the aforementioned definitions may equally apply to the description below.

As shown, a lithium ion (Li+) feedstock 3306 may contain a collection of lithium ions to be fed into an extraction system 3304 and combined with a sodium carbonate (Na₂CO₃) reagent from another Feed 3308. In operation, the lithium ions fed into the extraction system 3304 chemically react with the sodium carbonate to form lithium carbonate (Li₂CO₃) atoms and a concentration of sodium ions (Na+), which may then ultimately be handled as waste byproduct.

In one embodiment, conversely, a reclamation reaction process may yield a concentration of lithium carbonate solid and a sodium ion concentration which may be stored for another future purpose.

The extraction reaction may include: Li+(feed)+Na+(stored)→Li+(stored)+Na+(waste). The reclamation reaction may include: 2Li+(stored)+Na₂CO₃ (feed)→Li₂CO₃ (s)+2Na+(stored). Additionally, the overall reaction may include: 2Li++Na₂CO₃→Li₂CO₃ (s)+2Na+.

In this manner, the extraction system 3304 may be used to extract lithium from the Li+ feedstock 3306. The lithium ions may be replaced by sodium ions from the feed 3308.

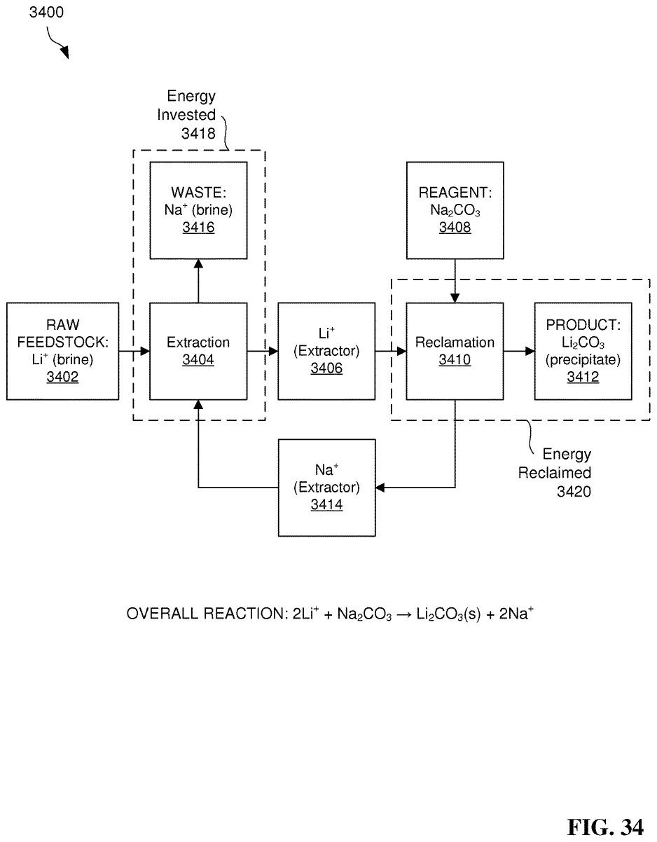

FIG. 34 illustrates an energy reclamation process 3400 for alkali metal extraction, in accordance with one embodiment. As an option, the energy reclamation process 3400 may be implemented in the context of any one or more of the embodiments set forth in any previous and/or subsequent figure(s) and/or description thereof. Of course, however, the energy reclamation process 3400 may be implemented in the context of any desired environment. Further, the aforementioned definitions may equally apply to the description below.

In operation, an alkali metal (in this case, lithium ion (Li+)) raw feedstock 3402, which may take the form of a brine, may feed lithium ions into an extraction subprocess 3404 and extractor 3406. In addition, the lithium ions may be passed from the extractor 3406 into a reclamation subprocess 3410 and combined with a sodium carbonate (Na₂CO₃) reagent 3408, wherein the lithium ions chemically react with the sodium carbonate reagent 3408 to produce a lithium carbonate (Li₂CO₃) precipitate salt 3412 and a concentration of sodium ions (Na+). The reclamation 3410 may also result in a solution which may be passed to an extractor 3414, passed back through the extraction subprocess 3404, and may ultimately be reclaimed in the form of a waste brine comprised of a mass of sodium ions 3416.

In one embodiment, the measure of energy output may be derived by combining the measure of energy invested 3418 with the measure of energy reclaimed 3420. In a related embodiment, the measure of energy invested may be quantified by measuring the waste brine comprised of the mass of sodium ions 3416 produced via the extraction subprocess 3404. In a counterpart embodiment, the measure of energy reclaimed may be quantified by measuring the lithium carbonate (Li₂CO₃) precipitate salt 3412 produced via the reclamation subprocess 3410.

In one exemplary embodiment, the energy reclamation process may include the following overall reaction: 2Li++Na₂CO₃→Li₂CO₃ (s)+2Na⁺.

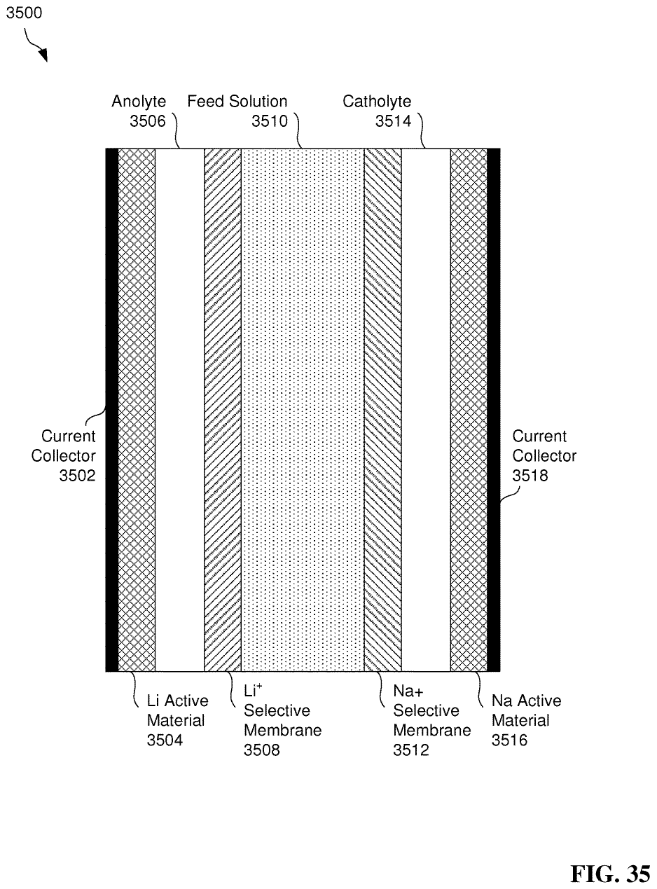

FIG. 35 illustrates a lithium extraction cell 3500, in accordance with one embodiment. As an option, the lithium extraction cell 3500 may be implemented in the context of any one or more of the embodiments set forth in any previous and/or subsequent figure(s) and/or description thereof. Of course, however, the lithium extraction cell 3500 may be implemented in the context of any desired environment. Further, the aforementioned definitions may equally apply to the description below.

As shown an anode-side current collector 3502 may form one outside contact surface of the lithium extraction cell 3500 and be in direct contact with a mass of lithium active material 3504. Additionally, an anolyte 3506 may be situated between the lithium active material 3504 and a lithium ion-selective solid electrolyte membrane 3508. Additionally, a feed solution 3510 may be positioned between the lithium ion-selective solid electrolyte membrane 3508 on the anode side of the lithium extraction cell 3500 and a sodium ion-selective solid electrolyte membrane 3512 on the cathode side of the lithium extraction cell 3500. Further, within the cathode portion of the lithium extraction cell 3500, a catholyte 3514 may be situated between the sodium ion-selective solid electrolyte membrane 3512 and sodium active material 3516. Further still the cathode side of the lithium extraction cell 3500 may be “capped” by another current collector 3518.

In one embodiment, the lithium active material 3504 may be comprised of lithium-titanate or lithium-titanium-oxide (LTO). In another embodiment, the anolyte 3506 may be formed of lithium ion electrolyte. In a likewise embodiment, the catholyte 3514 may be comprised of sodium ion electrolyte. In yet another embodiment, the sodium active material 3516 may be comprised of Prussian Blue (or iron cyanides).

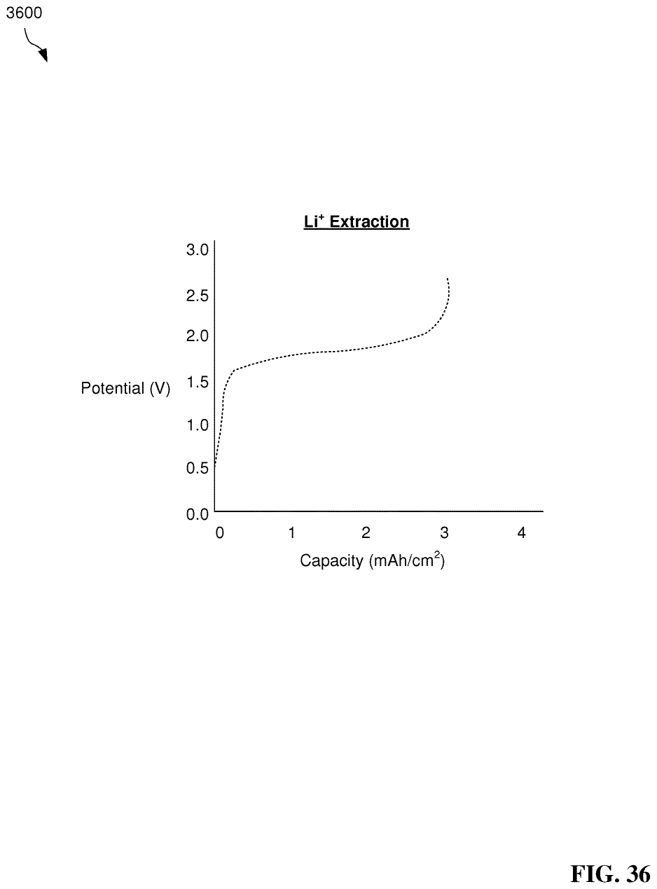

FIG. 36 illustrates a data plot of lithium extraction 3600, in accordance with one embodiment. As an option, the data plot of lithium extraction 3600 may be implemented in the context of any one or more of the embodiments set forth in any previous and/or subsequent figure(s) and/or description thereof. Of course, however, the data plot of lithium extraction 3600 may be implemented in the context of any desired environment. Further, the aforementioned definitions may equally apply to the description below.

As shown, a data plot of lithium extraction 3600 may show relative measures of electrode capacity, measured in mAh/cm², along an x-axis over the course of a lithium extraction reaction, juxtaposed with counterpart voltage potential measurement along a y-axis over the course of the same reaction time.

By way of just one example, in a scenario where 0.78 mg/cm² of lithium extract results from a reaction in which 6.15 mWh/cm² of electrochemical energy has been consumed, approximately 2.5 volts of energy may be generated where 3 mAh/cm2 of capacity is realized.

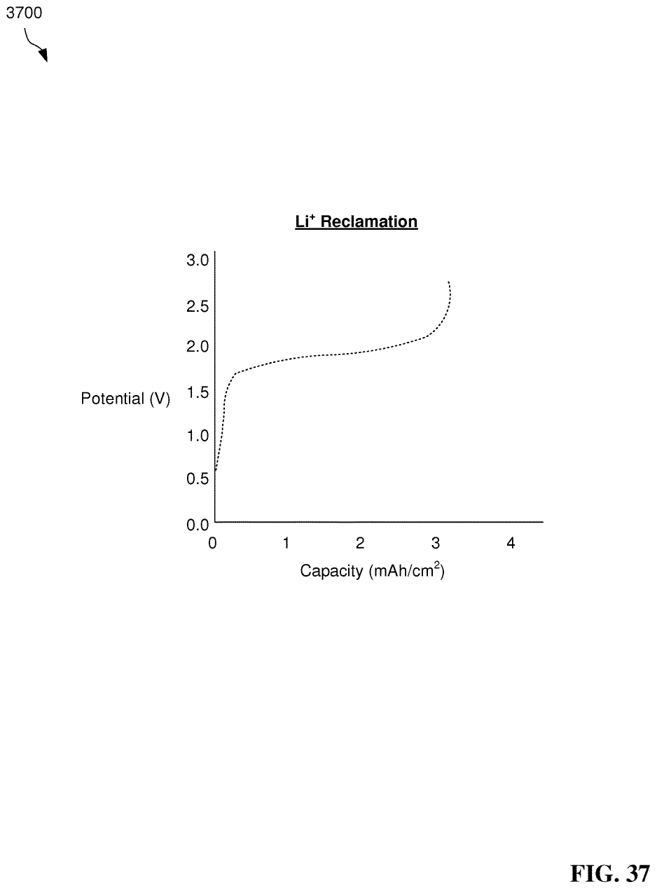

FIG. 37 illustrates a data plot of lithium reclamation 3700, in accordance with one embodiment. As an option, the data plot of lithium reclamation 3700 may be implemented in the context of any one or more of the embodiments set forth in any previous and/or subsequent figure(s) and/or description thereof. Of course, however, the data plot of lithium reclamation 3700 may be implemented in the context of any desired environment. Further, the aforementioned definitions may equally apply to the description below.

As shown, a data plot of lithium reclamation 3700 may show relative measures of electrode capacity, measured in mAh/cm², along an x-axis over the course of a lithium reclamation reaction, juxtaposed with counterpart voltage potential measurement along a y-axis over the course of the same reaction time.

By way of just one example, in a scenario where 0.78 mg/cm² of lithium extract results from a reaction in which 4.95 mWh/cm² of electrochemical energy has been consumed (or invested) and 1.2 mWh/cm² has been irreversibly lost, approximately 2.5 volts of energy may be generated where 3 mAh/cm² of capacity is realized.

In various embodiments, FIG. 36 is intended to show recovered energy, and FIG. 37 is intended to show that which is consumed or invested.

Based on FIGS. 36 and 37, energy associated with effectively extracting lithium may be recoupled via a reclamation step.

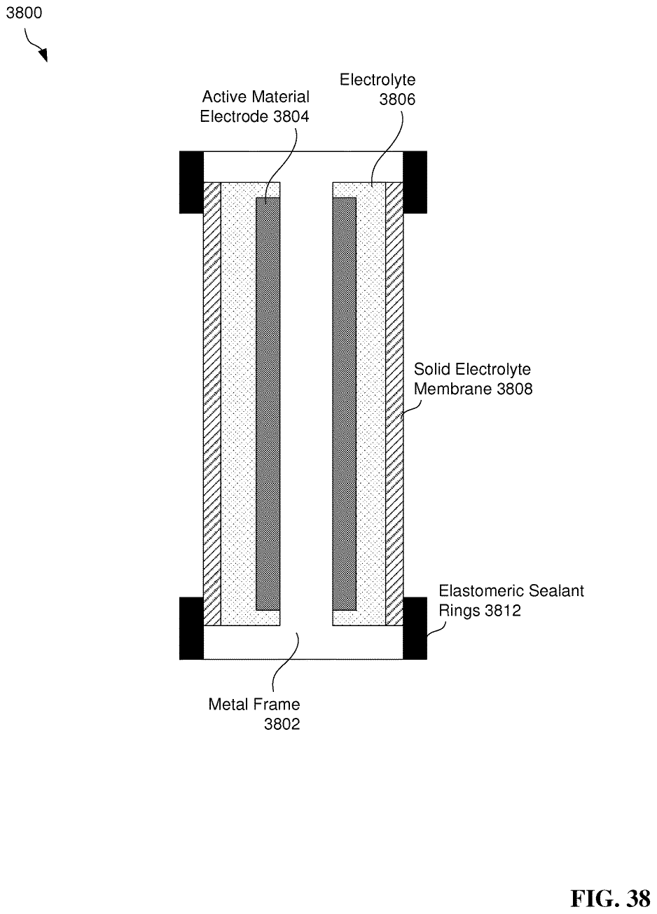

FIG. 38 illustrates an exemplary electrode module 3800, in accordance with one embodiment. As an option, the exemplary electrode module 3800 may be implemented in the context of any one or more of the embodiments set forth in any previous and/or subsequent figure(s) and/or description thereof. Of course, however, the exemplary electrode module 3800 may be implemented in the context of any desired environment. Further, the aforementioned definitions may equally apply to the description below.

As shown, the electrode module 3800 may comprise a solid electrolyte membrane 3808, an interstitial liquid electrolyte 3806, and an active material electrode 3804, all encased by and in direct contact with a metal frame 3802. Additionally, the electrode module 3800 may include elastomeric sealant rings 3812 to bind the electrode module 3800 casing. It is to be appreciated that, in order to function as a redox system, both an anode and a cathode would be needed. For simplicity, the redox electrode module is presented in a singular form (a single module electrode) to describe the elements of the module that are consistent for either and/or both of the anode module and the cathode module.

In one embodiment, the solid electrolyte membrane 3808 may interface with a feed solution. Additionally, the electrolyte 3806 may function as an anolyte on the anode side of the electrode module 3800 and as a catholyte on the cathode side of the electrode module 3800. In addition, the interstitial liquid electrolyte 3806 may comprise one or more electroactive solutes. In one embodiment, each electroactive solute may be characterized by its ability to adopt multiple oxidation states whose relative concentrations within the electrolyte may be manipulated through the addition or removal of charge (electrons) from the interstitial liquid electrolyte 3806. Further, the interstitial liquid electrolyte 3806 may include one or more dissolved alkali metal cations. Further, the interstitial liquid electrolyte 3806 may include one or more dissolved anions to balance the charge of cations in the solution. The current collector may be in direct contact with the interstitial liquid electrolyte 3806.

In a related embodiment, the metal frame 3802 may be comprised of stainless steel, aluminum, and/or a hybrid of both metals.

In operation, the electrode module 3800 may be used to separate lithium from a feed solution (via the solid electrolyte membrane 3808). Additional details relating to the separation of lithium via the solid electrolyte membrane 3808 may be found in relation to the disclosure of FIG. 1-FIG. 6 hereinabove. In practice, the solid electrolyte membrane may interface directly with the interstitial liquid electrolyte 3806, on one side, and a feed solution on the other side. The feed solution may comprise ions which may be effectively separately from the feed solution via the solid electrolyte membrane 3808. The solid electrolyte membrane 3808 may be tuned to selectively separate desired ions from the feed solution. In other words, the solid electrolyte membrane 3808 may be configured to allow selective passage of a specific alkali metal cation.

Further, the electrode module 3800 may be used to reclaim energy used during the separation process. For example, as lithium is extracted, it may be stored in the form of electrochemical energy which may be subsequently released.

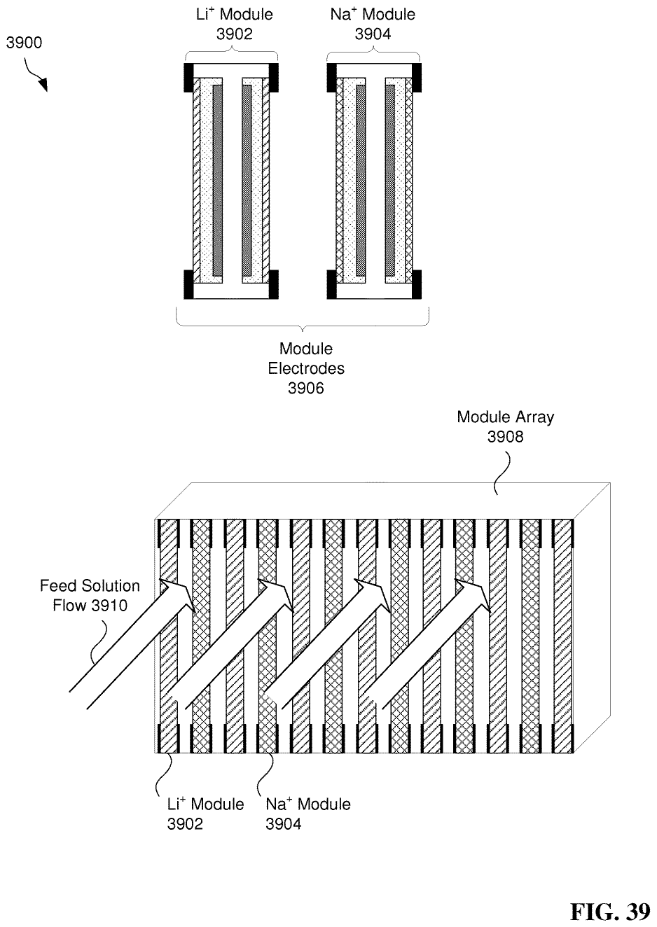

FIG. 39 illustrates an electrode module array 3900, in accordance with one embodiment. As an option, the electrode module array 3900 may be implemented in the context of any one or more of the embodiments set forth in any previous and/or subsequent figure(s) and/or description thereof. Of course, however, the electrode module array 3900 may be implemented in the context of any desired environment. Further, the aforementioned definitions may equally apply to the description below.

As shown, the module electrodes 3906 may include a lithium ion (Li+) module 3902 functioning as an anode and a sodium ion (Na+) module 3904 functioning as a cathode. It is to be appreciated that, in order to function as a redox system, both an anode and a cathode would be needed.

As shown, a module array 3908 may comprise two or more sets of module electrodes 3906 organized into a collection and designed to provide maximum battery storage capacity. In operation, a feed solution 3910 may flow through the module array 3908 with the intention that the feed solution 3910 completely envelop all lithium ion (Li+) module 3902 and sodium ion (Na+) module 3904 pairs.

In one embodiment, the feed solution flow 3910 may comprise ions which may be effectively separated from the feed solution via the solid electrolyte membrane. To facilitate separation of ions from the feed solution flow 3910, a solid electrolyte membrane 3808 may be tuned to selectively separate desired ions (lithium ions and/or sodium ions, for example) from the feed solution. In other words, the solid electrolyte membrane 3808 may be configured to allow selective passage of a specific alkali metal ions. For example, the lithium ion module 3902 may be configured to allow passage of lithium ions, and the sodium module 3904 may be configured to allow passage of sodium ions.

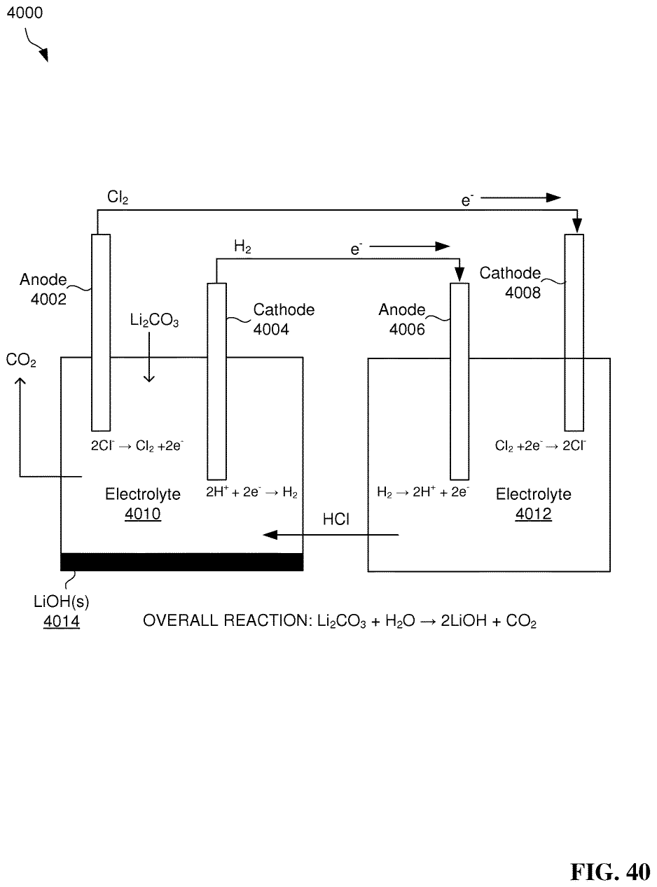

FIG. 40 illustrates an exemplary system 4000 for conversion to lithium hydroxide, in accordance with one embodiment. As an option, the exemplary system 4000 may be implemented in the context of any one or more of the embodiments set forth in any previous and/or subsequent figure(s) and/or description thereof. Of course, however, the exemplary system 4000 may be implemented in the context of any desired environment. Further, the aforementioned definitions may equally apply to the description below.

As shown, a first anode 4002 and a first cathode 4004 are in direct contact with a first electrolyte 4010 to comprise a first battery cell. In addition, a second anode 4006 and a second cathode 4008 are in direct contact with a second electrolyte 4012 to comprise a second battery cell. In operation, the conversion process first goes through a neutralization reaction phase where lithium carbonate (Li₂CO₃) is fed into the first electrolyte 4010 of the first battery cell where the lithium carbonate reacts with hydrogen chloride (HCl). In addition, the conversion process goes through an electrolysis reaction phase from which lithium hydroxide (LiOH), hydrogen (H₂) and chlorine (Cl₂) gases are produced. Additionally, the resulting hydrogen gas may be transferred from the first cell to the second cell via the second anode 4006 by way of the first cathode 4004. Likewise, the resulting chlorine gas may be transferred to the second cell via the second cathode 4008 by way of the first anode 4002. Further, the conversion process includes a hydrogen chloride reclamation reaction phase in which the resultant hydrogen and chlorine gases combine amidst the second electrolyte 4012 to form hydrogen chloride atoms that are ultimately fed back into the first cell to continue to react with lithium carbonate. Further still, a net result of the conversion process yields a mass of solid lithium hydroxide precipitate 4014 as well as a volume of both water (H₂O), which may be filtered out of the first electrolyte 4010, and carbon dioxide (CO₂) gas, which may be vented as byproduct waste.

In one embodiment, the exemplary system 4000 may include the overall reaction: Li₂CO₃+H₂O→2LiOH+CO₂.

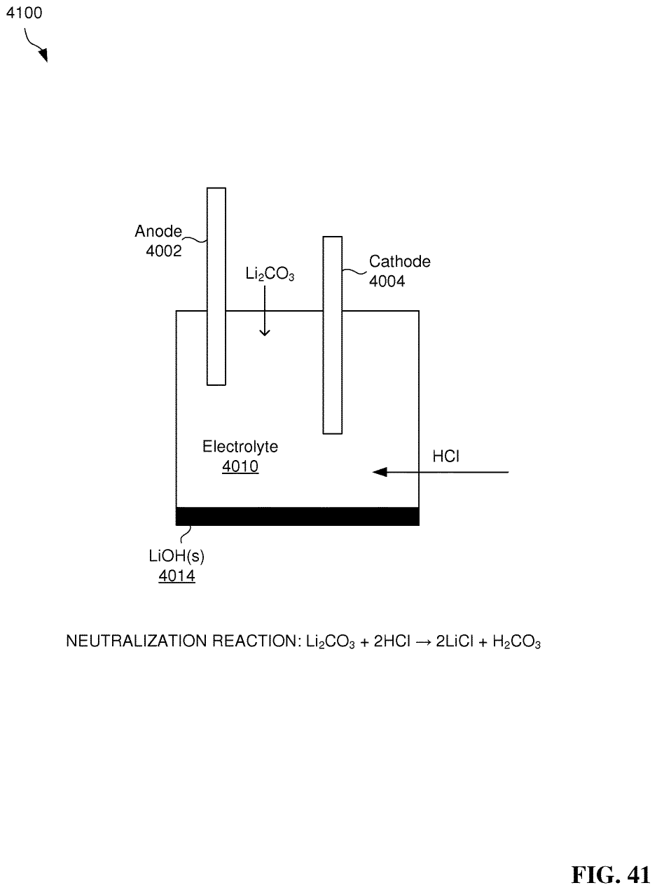

FIG. 41 illustrates a subset 4100 of the exemplary system 4000 for conversion to lithium hydroxide, in accordance with one embodiment. As an option, the subset 4100 may be implemented in the context of any one or more of the embodiments set forth in any previous and/or subsequent figure(s) and/or description thereof. Of course, however, the subset 4100 may be implemented in the context of any desired environment. Further, the aforementioned definitions may equally apply to the description below.

In operation, the neutralization reaction may include lithium carbonate (Li₂CO₃) being fed into the first electrolyte 4010 of the first battery cell where the lithium carbonate reacts with hydrogen chloride (HCl), ultimately producing a mass of solid lithium hydroxide (LiOH) precipitate 4014 (as a result, in one embodiment, of the Cl— anions being removed at the anode, etc.).

In one embodiment, the neutralization reaction may include: Li₂CO3+2HCl→2LiCl+H₂CO₃.

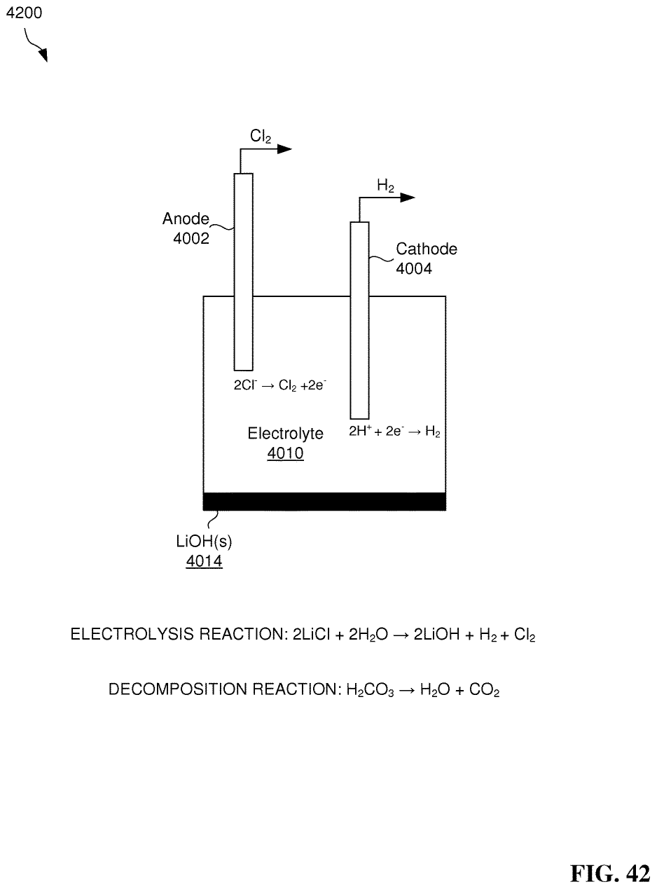

FIG. 42 illustrates a subset 4200 of the exemplary system 4000 for conversion to lithium hydroxide, in accordance with one embodiment. As an option, the subset 4200 may be implemented in the context of any one or more of the embodiments set forth in any previous and/or subsequent figure(s) and/or description thereof. Of course, however, the subset 4200 may be implemented in the context of any desired environment. Further, the aforementioned definitions may equally apply to the description below.

In operation, the electrolysis reaction from which solid lithium hydroxide precipitate 4014 and hydrogen (H₂) and chlorine (Cl₂) gases are produced may include the resulting hydrogen gas being transferred from the first electrolyte 4010 to the second cell via the first cathode 4004. Likewise, the resulting chlorine gas may be transferred to the second cell via the first anode 4002.

In one embodiment, the electrolysis reaction may include 2LiCl+2H₂O→2LiOH+H₂+Cl₂.

It should be noted that cell corresponding with the subset 4200 may include a decomposition reaction wherein a volume of both water (H₂O), which may be filtered out of the first electrolyte 4010, and carbon dioxide (CO₂) gas, which may be vented as byproduct waste, may be produced.

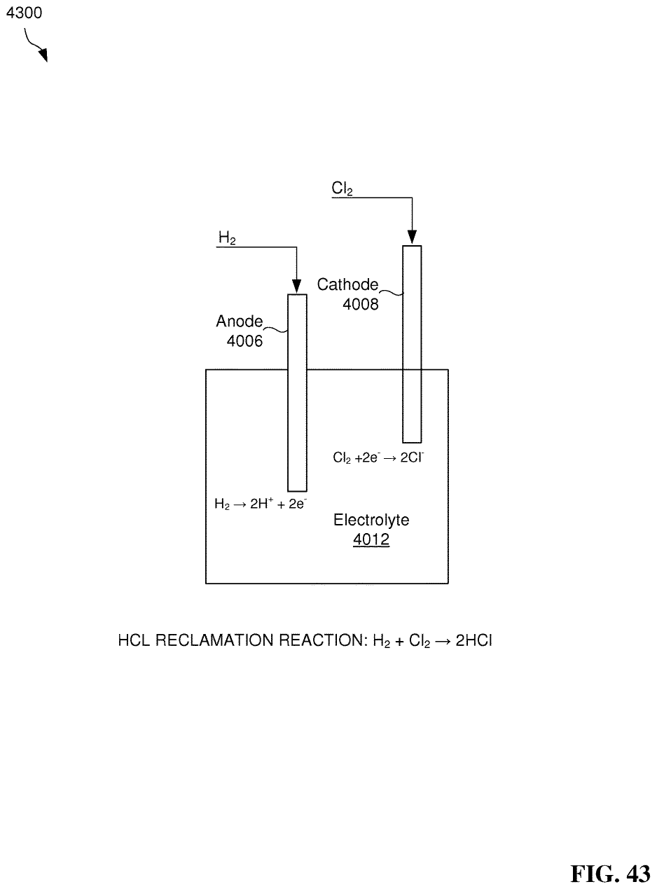

FIG. 43 illustrates a subset 4300 of the exemplary system 4000 for conversion to lithium hydroxide, in accordance with one embodiment. As an option, the subset 4300 may be implemented in the context of any one or more of the embodiments set forth in any previous and/or subsequent figure(s) and/or description thereof. Of course, however, the subset 4300 may be implemented in the context of any desired environment. Further, the aforementioned definitions may equally apply to the description below.

In operation, the hydrogen chloride reclamation reaction may include hydrogen and chlorine gases entering the second cell via anode 4006 and cathode 4008, respectively, and combining with one another in the second electrolyte 4012 to form hydrogen chloride atoms that are ultimately fed back into the first cell to continue to react with lithium carbonate.

In one embodiment, the HCl reclamation reaction may include H₂+Cl₂→2HCl. Additionally, the decomposition reaction may include H₂CO₃→H₂O+CO₂.

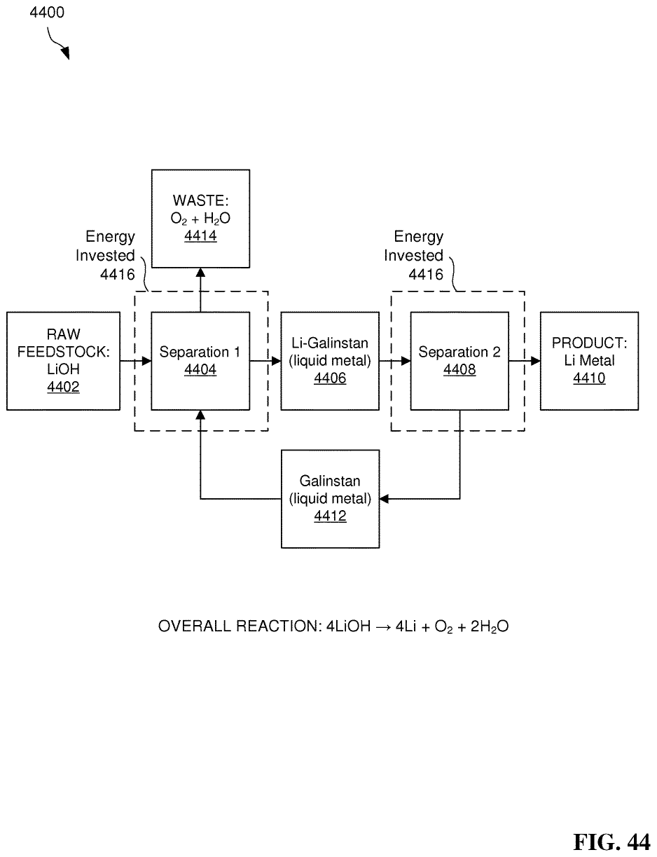

FIG. 44 illustrates an exemplary process 4400 for lithium metal production, in accordance with one embodiment. As an option, the exemplary process 4400 may be implemented in the context of any one or more of the embodiments set forth in any previous and/or subsequent figure(s) and/or description thereof. Of course, however, the exemplary process 4400 may be implemented in the context of any desired environment. Further, the aforementioned definitions may equally apply to the description below.

In operation, a raw feedstock 4402 of lithium hydroxide (LiOH) may feed lithium hydroxide into a separation subprocess 4404 to yield a concentration of lithiated galinstan liquid metal 4406. In addition, the lithiated galinstan liquid metal 4406 may be passed from separation subprocess 4404 into a second separation subprocess 4408, ultimately resulting in a lithium metal salt product 4410 and a concentration of galinstan liquid metal 4412, which may be passed back through the separation subprocess 4404, yielding a measure of O₂ and/or H₂O waste 4414.

In one embodiment, the measure of energy invested 4416 into the process 4400 for lithium metal production may be quantified by measuring the energy levels required to perform separation subprocess 4404 and second separation subprocess 4408.

In one embodiment, the exemplary process 4400 may include: 4LiOH→4Li+O₂+2H₂O.

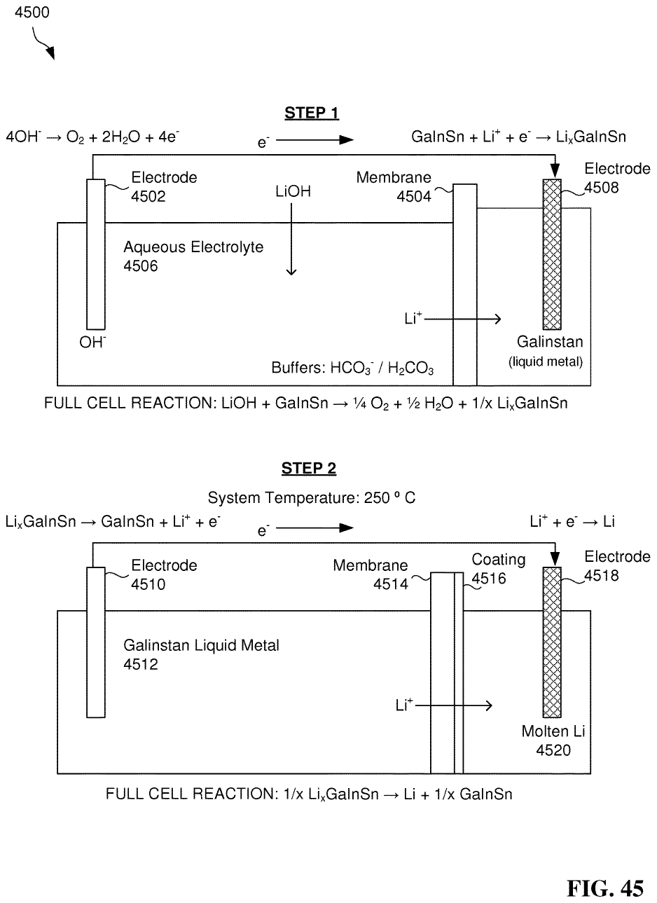

FIG. 45 illustrates an exemplary process 4500 for lithium metal production, in accordance with one embodiment. As an option, the exemplary process 4500 may be implemented in the context of any one or more of the embodiments set forth in any previous and/or subsequent figure(s) and/or description thereof. Of course, however, the exemplary process 4500 may be implemented in the context of any desired environment. Further, the aforementioned definitions may equally apply to the description below.

As shown in step 1, lithium ions (Li⁺) may pass from an anode comprised of aqueous electrolyte 4506 through a lithium ion-selective solid electrolyte membrane 4504 to a cathode comprised of lithiated galinstan (Ga—In—Sn) liquid metal. In operation, lithium hydroxide atoms may be continuously fed into (if not already present in an adequate volume in) the aqueous electrolyte 4506 and may break apart into positively-charged lithium ions and negatively-charged hydroxide (OH) atoms. In addition, the lithium ions may then be drawn across the lithium ion-selective solid electrolyte membrane 4504 into the cathode containing the lithiated galinstan liquid metal. Additionally, the lithium metal production may simultaneously combine the actions of reduction of galinstan at a cathode-side electrode 4508, resulting in the recombination of lithium ions and electrons to form a lithiated galinstan liquid metal, and oxidation of OH— at an anode-side electrode 4502, producing oxygen gas (O₂), water (H₂O), and electrons. Further, to prevent corrosion and degradation of the effectiveness of the lithium ion-selective solid electrolyte membrane 4504, a suitable buffer may be used to coat the lithium ion-selective solid electrolyte membrane 4504 in the case of contact with the aqueous electrolyte 4506. By way of example, the compound used to comprise the buffer in the aqueous electrolyte 4506 may include bicarbonate (HCO₃⁻) and/or carbonic acid (H₂CO₃).

In one embodiment, the full cell reaction for step 1 may include: LiOH+GaInSn→¼O₂+½ H₂O+1/x LixGaInSn.

In one embodiment, the resulting alkali metal may be in solid and/or liquid metal form upon completion of the alkali metal production process.

As shown in step 2, at a system temperature of 250 degrees Celsius, lithium ions (Li⁺) may pass from an anode comprised of lithiated galinstan (Ga—In—Sn) alloy 4512 through a lithium ion-selective solid electrolyte membrane 4514 with a lithium-stable coating 4516 to a cathode comprised of molten lithium 4520. In operation, lithiated galinstan alloy may be continuously fed into the anode (if an adequate amount of such lithiated galinstan alloy is not already present) where lithium ions may then be drawn across the lithium ion-selective solid electrolyte membrane 4514 into the cathode comprised of molten lithium 4520. Additionally, the lithium metal production process may simultaneously combine the actions of oxidation of galinstan-Li at an anode-side electrode 4510, resulting in lithium ions and electrons, and reduction at a cathode-side electrode 4518 where lithium ions are recombined with electrons to form the new lithium metal.

In one embodiment, the lithium ion-selective solid electrolyte membrane 4514 may comprise a layer of Li₁₀GeP₂S₁₂ (LGPS) with a lithium-stable coating 4516 of, for example, lithium fluoride (LiF) and/or lithium oxide (Li₂O).

In one embodiment, the full cell reaction for step 2 may include: 1/x LiₓGaInSn→Li+1/x GaInSn.

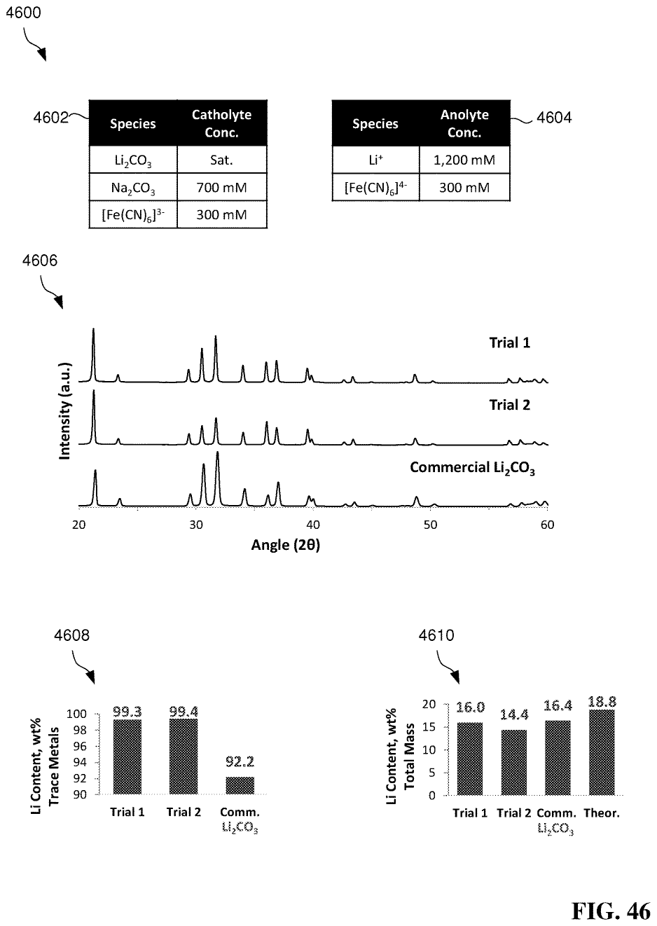

FIG. 46 illustrates results 4600 using redox electrode modules, in accordance with one embodiment. As an option, the results 4600 may be implemented in the context of any one or more of the embodiments set forth in any previous and/or subsequent figure(s) and/or description thereof. Of course, however, the results 4600 may be implemented in the context of any desired environment. Further, the aforementioned definitions may equally apply to the description below.

As shown, the results 4600 include preliminary data. For example, catholyte 4602 and anolyte 4604 show composition of electrolytes used for LCE precipitation test (specifically for Li2CO3). Additionally, graph 4606 shows XRD spectra of product confirming identity of precipitate as Li2CO3 in two separate trials. A graph 4608 shows a purity of Li2CO3 (wt % trace metals basis) analyzed via ICP-OES in two separate trials. Further, graph 4610 shows Li content (wt % total mass) in precipitation based on ICP-OES results compared to theoretical value of 18.8 wt % Li in pure Li2CO3. Commercial Li2CO3 from Sigma-Aldrich was used as a reference where indicated.

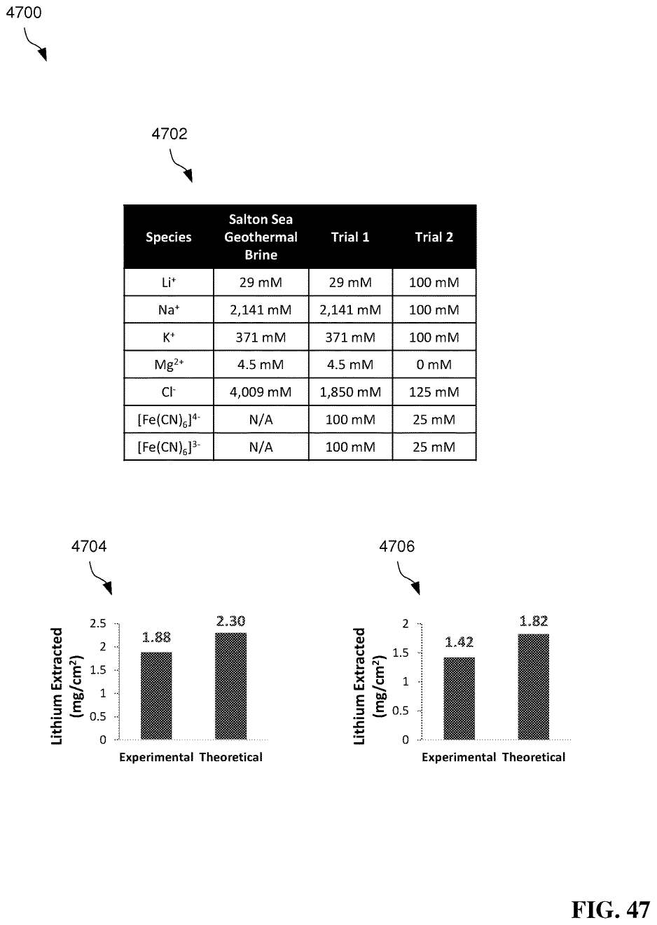

FIG. 47 illustrates results 4700 using redox electrode modules, in accordance with one embodiment. As an option, the results 4700 may be implemented in the context of any one or more of the embodiments set forth in any previous and/or subsequent figure(s) and/or description thereof. Of course, however, the results 4700 may be implemented in the context of any desired environment. Further, the aforementioned definitions may equally apply to the description below.

As shown, the results 4700 include preliminary data. For example, composition 4702 shows compositions of electrolytes used in two selectivity test trials compared to Salton Sea geothermal brine. A graph 4704 shows lithium extracted using Trial 1 electrolyte. Further, a graph 4706 shows lithium extracted using Trial 2 electrolyte. In one embodiment, theoretical values calculated assumed 100% of charge transferred is Li. Additionally, for each trial, the starting catholyte/anolyte were identical.

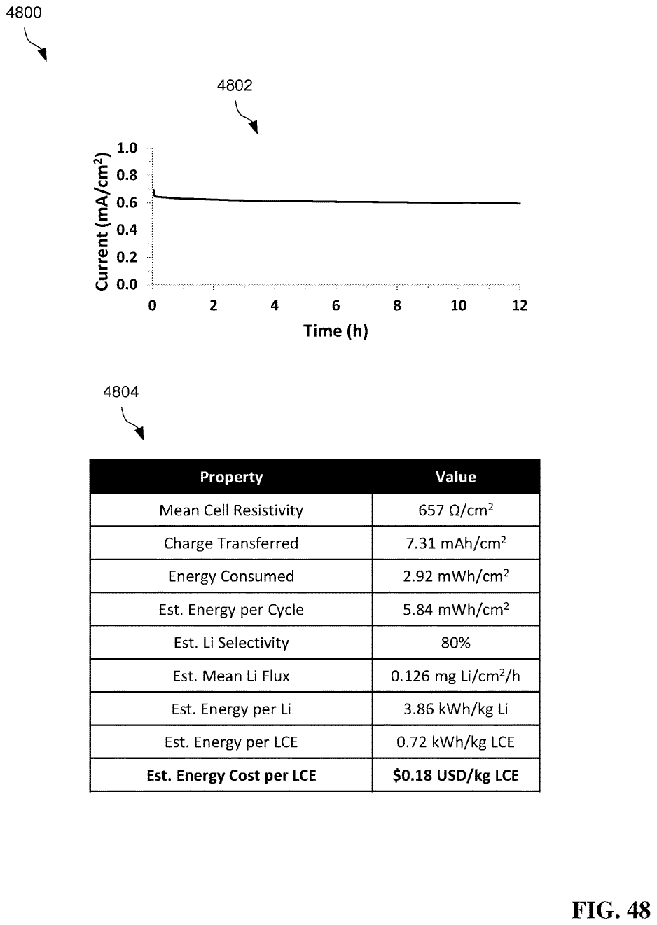

FIG. 48 illustrates results 4800 using redox electrode modules, in accordance with one embodiment. As an option, the results 4800 may be implemented in the context of any one or more of the embodiments set forth in any previous and/or subsequent figure(s) and/or description thereof. Of course, however, the results 4800 may be implemented in the context of any desired environment. Further, the aforementioned definitions may equally apply to the description below.

As shown, the results 4800 include preliminary data. For example, the graph 4802 shows a sample current vs time profiles of ion flow from anolyte to catholyte under constant potential of 0.4 V for 12 h. Additionally, the metrics 4804 show performance metrics calculated from data) associated with the graph 4802). In one embodiment, the estimated energy per cycle assumed a constant power for total of 24 h (12 h extraction, 12 h reclamation). Additionally, the energy cost per LCE produced was estimated using $0.25/kWh.

Membrane-Assisted Lithium Extraction with Foulant Protection

The following embodiments describe membrane-assisted lithium extraction systems configured to extract lithium from lithium-containing brines while protecting lithium-capturing components from exposure to foulant species. Whereas the preceding embodiments describe electrochemically-driven lithium extraction and purification systems utilizing ion-selective solid electrolyte membranes with applied current across electrodes, the following embodiments describe systems in which lithium ion transport through a membrane may be driven by passive diffusion resulting from a concentration gradient maintained by a lithium sink. The membrane-assisted lithium extraction systems described below may utilize polymeric membranes, inorganic membranes, and/or hybrid membranes configured to permit transport of lithium ions while reducing transport of foulant species such as silica species, multivalent cations, organic substances, and hydrogen sulfide. The lithium sink may comprise sorbent materials configured to reduce a concentration of lithium ions in a receiving solution, thereby maintaining the concentration gradient that drives passive lithium transport through the membrane without application of an external electric potential.

The lithium sink may alternatively or additionally comprise one or more lithium intercalation compounds configured to reduce the concentration of lithium ions in the receiving solution by reversibly intercalating lithium ions into a crystal structure of the intercalation compound. The one or more lithium intercalation compounds may comprise lithium iron phosphate (LFP), lithium titanate, lithium manganese oxide, and/or other materials capable of reversibly hosting lithium ions within their crystal lattice. In some aspects, the lithium intercalation compounds may be configured to capture lithium ions from the receiving solution during an intercalation phase and release the captured lithium ions during a deintercalation phase for downstream lithium recovery.

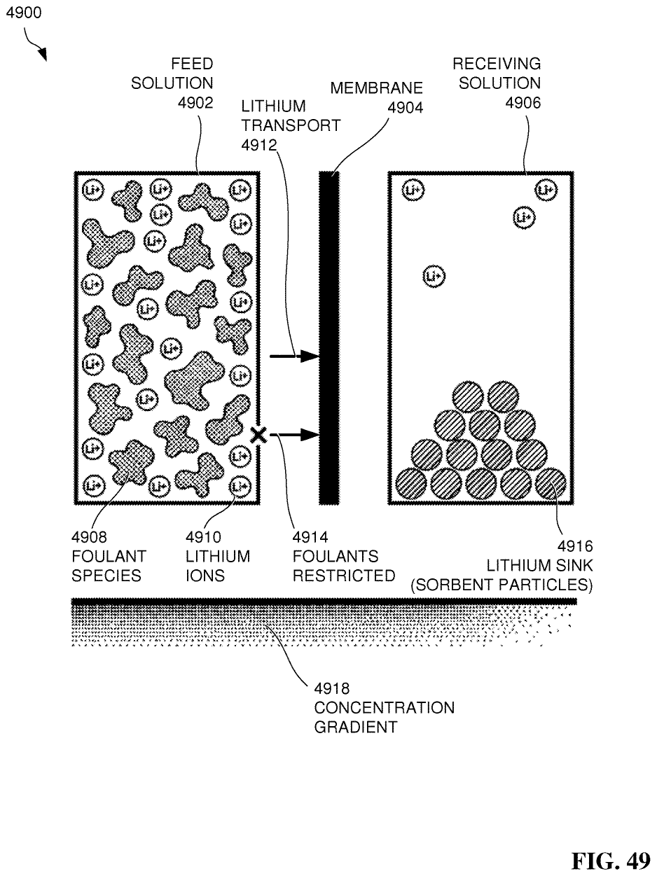

FIG. 49 illustrates a lithium extraction system 4900 configured for membrane-assisted lithium extraction using a lithium sink, in accordance with one embodiment. As an option, the lithium extraction system 4900 may be implemented in the context of any one or more of the embodiments set forth in any previous and/or subsequent Figures and/or description thereof. Of course, however, the lithium extraction system 4900 may be implemented in the context of any desired environment. Further, the aforementioned definitions may equally apply to the description below.

As shown, the lithium extraction system 4900 includes a feed solution 4902, a membrane 4904, a receiving solution 4906, foulant species 4908, lithium ions 4910, lithium transport 4912, foulants restricted 4914, a lithium sink 4916, and a concentration gradient 4918. The feed solution 4902 contains the lithium ions 4910 and the foulant species 4908, where the foulant species 4908 may be distributed throughout the feed solution 4902. The lithium ions 4910 may be dispersed among the foulant species 4908 within the feed solution 4902. The membrane 4904 separates the feed solution 4902 from the receiving solution 4906 and may be configured to permit the lithium transport 4912 of the lithium ions 4910 from the feed solution 4902 to the receiving solution 4906.

In one embodiment, the membrane 4904 may be configured to significantly reduce transport of the foulant species 4908 to the receiving solution 4906 (as shown as the foulants restricted 4914). While some foulant species 4908 may permeate through the membrane 4904 at low rates relative to the lithium ions 4910, the membrane 4904 may be configured such that a transport rate of the foulant species 4908 through the membrane 4904 is substantially lower than a transport rate of the lithium ions 4910. The receiving solution 4906 may receive the lithium ions 4910 that have passed through the membrane 4904 (as shown as the lithium transport 4912). The lithium sink 4916 may be disposed within the receiving solution 4906 or in physical contact with the receiving solution 4906. The lithium sink 4916 may be configured to reduce a concentration of the lithium ions 4910 in the receiving solution 4906 by capturing the lithium ions 4910 as the lithium ions 4910 migrate through the membrane 4904.

The foulant species 4908 may comprise one or more types of impurities that can interfere with lithium extraction operations. In some aspects, the foulant species 4908 may include silica species, multivalent cations, organic substances, and/or hydrogen sulfide. The silica species may comprise SiO2 particles, silicic acid (Si(OH)4, also referred to as monomeric silica), and/or polymeric silica. The multivalent cations may comprise magnesium, calcium, barium, strontium, aluminum, and/or iron. In some cases, the foulant species 4908 may include combinations of silica species, multivalent cations, organic substances, and hydrogen sulfide present in lower-grade brines.

The lithium sink 4916 may comprise one or more materials configured to reduce the concentration of the lithium ions 4910 in the receiving solution 4906. In various embodiments, the lithium sink 4916 may decrease the concentration of the lithium ions 4910 through sorption, electrochemical intercalation, ion exchange, and/or electrochemical-based filtration or extraction, or combinations thereof. The one or more materials may comprise aluminum hydroxide, lithium titanate, lithium iron phosphate, and/or lithium manganese oxide. The one or more materials may be configured to maintain the concentration gradient 4918 by continuously removing the lithium ions 4910 from the receiving solution 4906 as the lithium ions 4910 migrate through the membrane 4904.

The concentration gradient 4918 may be depicted at a bottom portion of the lithium extraction system 4900, illustrating a driving force for passive transport of the lithium ions 4910 through the membrane 4904. The concentration gradient 4918 may show a transition from higher concentration on a side of the feed solution 4902 to lower concentration on a side of the receiving solution 4906. The lithium sink 4916 may maintain the concentration gradient 4918 by continuously removing the lithium ions 4910 from the receiving solution 4906. The lithium transport 4912 through the membrane 4904 may be driven by diffusion resulting from the concentration gradient 4918 between the feed solution 4902 and the receiving solution 4906.

In various embodiments, the system may be configured to operate effectively with feed solutions having lithium ion concentrations above approximately 200 ppm, where the concentration gradient between the feed solution 4902 and the receiving solution 4906 may provide a sufficient driving force for lithium diffusion through the membrane 4904 at practical membrane thicknesses. Feed solutions with lithium ion concentrations below approximately 100 ppm may require thinner membranes to compensate for the reduced driving force, which may introduce trade-offs between lithium transport rate and membrane durability. In principle, the system may operate with any concentration gradient, though the practical viability of the system may depend on the relationship between the lithium ion concentration in the feed solution 4902, the membrane thickness, and the desired lithium recovery rate.

In various embodiments, the lithium extraction system 4900 may be operated in a batch configuration in which the lithium ion concentration in the feed solution 4902 gradually decreases over time as lithium ions are extracted through the membrane 4904. The batch operation may continue until the lithium ion concentration in the feed solution 4902 reaches a target endpoint corresponding to a desired lithium recovery percentage. For example, a feed solution 4902 with an initial lithium ion concentration of 100 ppm and a target lithium recovery of 90% may be processed until the lithium ion concentration in the feed solution 4902 reaches approximately 10 ppm. The effective driving force for the batch process may be characterized by a log-mean concentration difference between the initial and final lithium ion concentrations in the feed solution 4902. A higher target lithium recovery percentage may result in a lower mean concentration difference over the course of the batch, while a lower target lithium recovery percentage may result in a higher mean concentration difference. The membrane thickness and/or the target lithium recovery percentage may be selected to achieve a desired balance between lithium extraction rate and overall lithium recovery.

In various embodiments, the lithium sink 4916 may be configured to maintain the concentration gradient 4918 as high as practically possible rather than at a specific fixed value. Because the lithium ion concentration in the feed solution 4902 may decrease over time during batch operation, the concentration gradient 4918 may correspondingly decrease over the course of a batch cycle even when the lithium sink 4916 maintains the lithium ion concentration in the receiving solution 4906 at or near zero. The lithium sink 4916 may compensate for the decreasing feed concentration by continuing to minimize the lithium ion concentration in the receiving solution 4906, thereby preserving the maximum achievable concentration gradient 4918 at any given point during the batch cycle.

In one embodiment, the transport of the lithium ions 4910 through the membrane 4904 may be passive in nature, driven by diffusion as a result of concentration differences between the feed solution 4902 and the receiving solution 4906. The concentration gradient 4918 may be maintained without application of an external electric potential across the membrane 4904. Additionally, the transport of the lithium ions 4910 through the membrane 4904 may occur without application of a current across an anode and a cathode. The lithium sink 4916 may maintain the concentration gradient 4918 by reducing a concentration of free lithium ions 4910 in the receiving solution 4906 below a concentration of the lithium ions 4910 in the feed solution 4902.

In some aspects, the lithium sink 4916 may reduce the concentration of free lithium ions 4910 in the receiving solution 4906 to near zero. A rate of transport of the lithium ions 4910 through the membrane 4904 may be proportional to the concentration gradient 4918. Because the lithium extraction system 4900 may be operated in a batch configuration in which the lithium ion concentration in the feed solution 4902 decreases over time, the rate of transport of the lithium ions 4910 through the membrane 4904 may vary throughout a batch cycle, and the lithium sink 4916 may be sized to maintain a target mean transport rate averaged over the duration of the batch cycle. The lithium sink 4916 may be sized to maintain a target mean transport rate by reducing the concentration of the lithium ions 4910 in the receiving solution 4906 at a rate at least equal to the rate of transport through the membrane 4904. The lithium sink 4916 may be configured to periodically release accumulated lithium ions 4910 for downstream processing and subsequently resume reducing the concentration of the lithium ions 4910 in the receiving solution 4906.

In various embodiments, the lithium sink may be configured in different physical arrangements relative to the receiving solution. The lithium sink may comprise sorbent particles suspended within the receiving solution, where the sorbent particles are dispersed throughout the receiving solution and capture lithium ions as the lithium ions migrate through the membrane. Alternatively, the lithium sink may comprise a packed bed of sorbent material through which the receiving solution flows, where the receiving solution circulates from a receiving compartment adjacent to the membrane through the packed bed and returns to the receiving compartment with a reduced lithium ion concentration. In other aspects, the lithium sink may comprise sorbent material coated on a surface in contact with the receiving solution, where the coated surface captures lithium ions from the receiving solution as the lithium ions accumulate in the receiving compartment. In still other aspects, the lithium sink may be disposed in a separate vessel in fluid communication with the receiving solution, where the receiving solution is circulated between the receiving compartment and the separate vessel containing the lithium sink. The circulation rate between the receiving compartment and the separate vessel may be selected to maintain the concentration gradient by removing lithium ions from the receiving solution at a rate at least equal to the rate of lithium ion transport through the membrane.

In various embodiments, the lithium sink may comprise one or more electrochemical intercalation compounds configured to capture lithium ions from the receiving solution through electrochemical intercalation. The electrochemical intercalation compounds may be coated on a current collector or other conductive substrate to form an electrode, where the receiving solution is circulated along a surface of the electrode and lithium ions are intercalated into the electrochemical intercalation compounds by applying a charging potential from a power supply. Alternatively, the electrochemical intercalation compounds may be arranged as a packed bed fixed to a conductive surface to form an electrode, where the receiving solution is circulated through the packed bed and lithium ions are intercalated into the electrochemical intercalation compounds under the applied charging potential. In both configurations, the electrochemical intercalation compounds may comprise lithium iron phosphate, lithium titanate, lithium manganese oxide, and/or other materials capable of reversibly intercalating lithium ions. The electrode comprising the electrochemical intercalation compounds may function as a cathode during lithiation, and a counter electrode may function as an anode to complete the electrochemical circuit. The counter electrode may comprise a material configured to undergo a complementary electrochemical reaction during the lithiation of the intercalation compounds. The power supply may be configured to reverse the applied potential during a release phase to deintercalate the accumulated lithium ions from the electrochemical intercalation compounds for downstream lithium recovery.

The lithium extraction system 4900 addresses challenges associated with conventional pretreatment approaches for lithium extraction from brine sources. Conventional sorbent-based direct lithium extraction (DLE) processes may require extensive pretreatment of brine before sorbents can be used effectively, where dissolved foulants such as silica and multivalent ions can foul, poison, or otherwise interfere with sorbent operation. The lithium extraction system 4900 places a membrane-based barrier between raw brine and the lithium sink 4916, such that lithium can be extracted while reducing exposure of the lithium sink 4916 to the foulant species 4908.

The configuration of the lithium extraction system 4900 may reduce process complexity compared to conventional pretreatment approaches. Conventional pretreatment steps may include filtration, chemical precipitation using lime softening or soda ash treatment, pH adjustment, aeration, and/or other conditioning methods. Such pretreatment methods may generate substantial quantities of sludge and solid waste streams that require handling, treatment, and disposal. The lithium extraction system 4900 may simplify DLE flowsheets, reduce sludge generation, and/or enable lithium recovery from resources that may otherwise be difficult to process.

In various embodiments, the membrane 4904 may be polymeric, inorganic, or hybrid/composite in nature. Polymeric membranes may include perfluorosulfonic acid (PFSA) membranes such as Nafion or Aquivion, cation exchange membranes (CEMs) including sulfonated polymers, sulfonated hydrocarbon membranes such as sulfonated polyether ether ketone (SPEEK), nanoporous membranes such as polyamide membranes, and/or fluoropolymers such as polytetrafluoroethylene (PTFE)-based or polyvinylidene fluoride (PVDF) membranes. Inorganic membranes may include lithium-selective ceramics such as garnet-type or NASICON-type ceramics. Hybrid/composite membranes may include polymer-ceramic composites and/or polymer matrices with inorganic fillers.

In various embodiments, the membrane 4904 may be reinforced with porous materials for improved mechanical support and durability. The porous support material may comprise expanded polytetrafluoroethylene (ePTFE). The membrane 4904 may be non-porous, such that fouling is limited to an outermost surface of the membrane 4904 rather than within pores, making removal of foulants from the membrane 4904 easier through cleaning-in-place (CIP) procedures. The concentration gradient 4918 may drive the lithium ions 4910 through a bulk of the membrane 4904 material rather than through pores.

In various embodiments, the membrane 4904 may be configured to undergo a cleaning-in-place procedure comprising treatment with a strong acid, a strong base, a chelator, an oxidizer, and/or a surfactant to remove foulants from a surface of the membrane 4904. The strong acid may comprise hydrochloric acid (HCl). The strong base may comprise sodium hydroxide (NaOH). The chelator may comprise citric acid and/or ethylenediaminetetraacetic acid (EDTA). The oxidizer may comprise hydrogen peroxide (H2O2). The cleaning-in-place procedure may restore functionality of the membrane 4904 after exposure to the foulant species 4908 in the feed solution 4902.

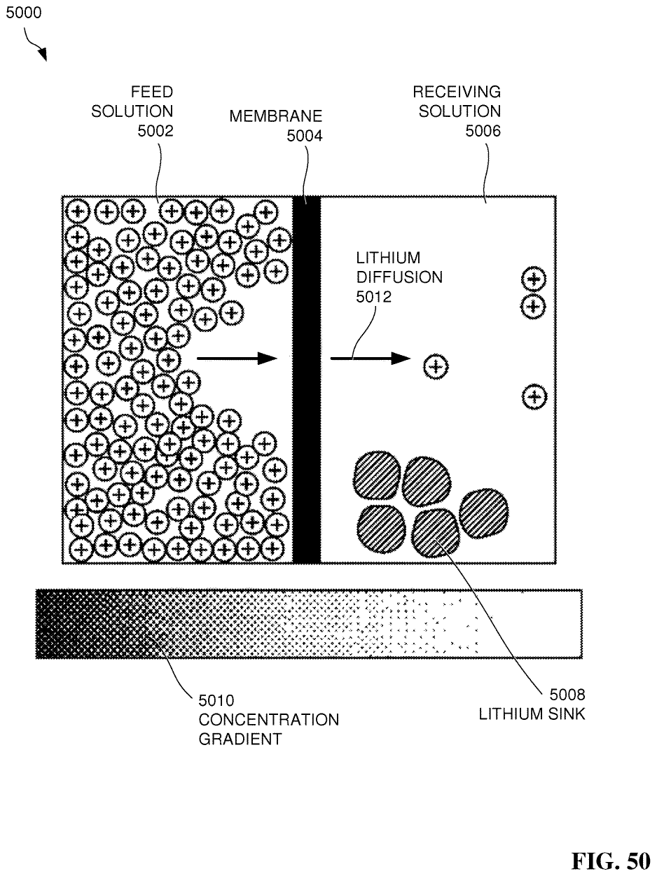

FIG. 50 illustrates a lithium extraction system 5000 configured for passive lithium transport driven by a concentration gradient 5010, in accordance with one embodiment. As an option, the lithium extraction system 5000 may be implemented in the context of any one or more of the embodiments set forth in any previous and/or subsequent Figures and/or description thereof. Of course, however, the lithium extraction system 5000 may be implemented in the context of any desired environment. Further, the aforementioned definitions may equally apply to the description below.

As shown, the lithium extraction system 5000 includes a feed solution 5002, a membrane 5004, a receiving solution 5006, a lithium sink 5008, a concentration gradient 5010, and lithium diffusion 5012. The feed solution 5002 contains lithium ions and may be positioned on a first side of the membrane 5004. The membrane 5004 separates the feed solution 5002 from the receiving solution 5006 and may be configured to permit transport of lithium ions while reducing transport of foulant species present in the feed solution 5002. The receiving solution 5006 may be disposed on a second side of the membrane 5004 opposite the feed solution 5002 and may be configured to receive lithium ions that pass through the membrane 5004.

Taking a step back, FIG. 50 emphasizes the concentration gradient mechanism, in particular, that drives passive lithium transport in the lithium extraction system, providing additional detail on the diffusion-based transport introduced in FIG. 49. While FIG. 49 depicts the overall system configuration including the feed solution, membrane, receiving solution, lithium sink, and foulant blocking function, FIG. 50 focuses specifically on the concentration gradient 5010 and the lithium diffusion 5012 that enable passive lithium ion transport without application of an external electric potential. The concentration gradient 5010 is depicted as a gradual decrease in lithium ion concentration from the feed solution 5002 side toward the receiving solution 5006 side, illustrating how the lithium sink 5008 maintains a low concentration of free lithium ions in the receiving solution 5006 to sustain the driving force for diffusion. By continuously capturing lithium ions as they migrate through the membrane 5004, the lithium sink 5008 prevents equilibration of lithium ion concentrations across the membrane 5004, thereby sustaining the concentration gradient 5010 that drives continued lithium diffusion 5012 from the feed solution 5002 to the receiving solution 5006.

The feed solution 5002, membrane 5004, receiving solution 5006, and lithium sink 5008 correspond to the feed solution 4902, membrane 4904, receiving solution 4906, and lithium sink 4916 described in connection with FIG. 49. The concentration gradient 5010 corresponds to the concentration gradient 4918 of FIG. 49, and the lithium diffusion 5012 corresponds to the lithium transport 4912 of FIG. 49. While FIG. 49 illustrates the foulant blocking function of the membrane 4904 and the various foulant species 4908 present in the feed solution 4902, FIG. 50 omits the foulant species to focus attention on the concentration gradient 5010 as the driving mechanism for passive lithium transport.

In contrast to electrochemically-driven systems that require application of a current across an anode and a cathode, the passive nature of the lithium diffusion 5012 in the lithium extraction system 5000 is driven solely by concentration differences between the feed solution 5002 and the receiving solution 5006. The concentration gradient 5010 may be maintained without application of an external electric potential across the membrane 5004. This passive transport mechanism may reduce energy consumption during lithium extraction operations and may simplify electrical infrastructure requirements by eliminating the need for power supplies, electrodes, and associated control systems.

A rate of transport of lithium ions through the membrane 5004 may be proportional to the concentration gradient 5010. The lithium sink 5008 may be sized to maintain a target transport rate by reducing the concentration of lithium ions in the receiving solution 5006 at a rate at least equal to the rate of transport through the membrane 5004. In some aspects, the lithium sink 5008 may reduce a concentration of free lithium ions in the receiving solution 5006 to near zero, thereby maximizing the concentration gradient 5010 and the corresponding rate of lithium diffusion 5012 through the membrane 5004.

In various embodiments, the lithium ion transport rate through the membrane 5004 may be on the order of 2×10-5 g/m²/s for a feed solution with an initial lithium ion concentration of approximately 150 ppm and a target lithium recovery of approximately 98%, though the transport rate may vary depending on membrane selection and operating conditions. The transport rate may decrease exponentially over the course of a batch cycle as the lithium ion concentration in the feed solution 5002 drops due to extraction, with the transport rate being initially high when the concentration gradient 5010 is at its maximum and decreasing as the feed solution 5002 becomes depleted of lithium ions. The mean concentration difference over the duration of the batch cycle may be approximated by a log-mean of the lithium ion concentration in the feed solution 5002 at the start and end of the batch cycle, reflecting the exponential decay of the transport rate over time.

In various embodiments, the sizing of the lithium sink 5008 may be selected based on a desired lithium processing rate for the lithium extraction system 5000. The lithium sink 5008 may have a capacity sufficient to capture lithium ions at a rate that maintains the concentration gradient 5010 during continuous operation. As has been discussed, the lithium sink 5008 may be configured to maintain the concentration gradient 5010 as high as practically achievable rather than at a fixed value, as the concentration gradient 5010 may vary over the course of a batch cycle due to decreasing lithium ion concentration in the feed solution 5002. The lithium sink 5008 may be configured to operate in cycles comprising a capture phase during which lithium ions are removed from the receiving solution 5006, a saturation phase during which the lithium sink 5008 approaches capacity, and a release phase during which accumulated lithium ions are released for downstream processing.

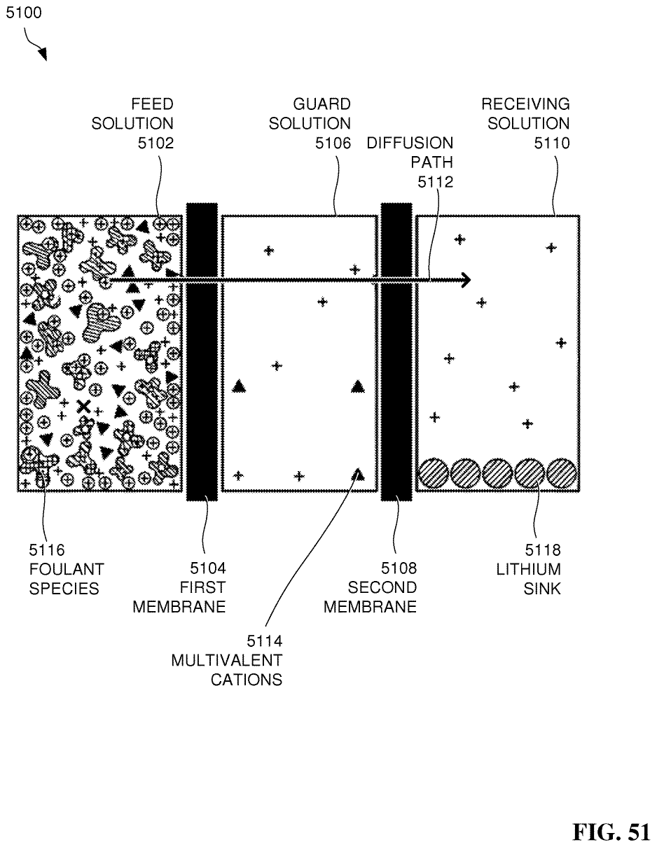

FIG. 51 illustrates a system 5100 for extracting lithium from a lithium-containing brine using multiple membrane barriers and a guard solution configuration, in accordance with one embodiment. As an option, the system 5100 may be implemented in the context of any one or more of the embodiments set forth in any previous and/or subsequent Figures and/or description thereof. Of course, however, the system 5100 may be implemented in the context of any desired environment. Further, the aforementioned definitions may equally apply to the description below.

As shown, the system 5100 includes a feed solution 5102, a first membrane 5104, a guard solution 5106, a second membrane 5108, a receiving solution 5110, a diffusion path 5112, multivalent cations 5114, foulant species 5116, and a lithium sink 5118. The feed solution 5102 may contain lithium ions, the foulant species 5116, and the multivalent cations 5114. The foulant species 5116 may be depicted as various shapes distributed throughout the feed solution 5102. The multivalent cations 5114 may be depicted as triangular markers within the feed solution 5102.

The first membrane 5104 may separate the feed solution 5102 from the guard solution 5106. The first membrane 5104 may be configured to permit transport of lithium ions while reducing transport of at least a portion of the foulant species 5116. In one embodiment, the first membrane 5104 may comprise a perfluorosulfonic acid (PFSA) polymer configured to reduce transport of silica-based foulant species. The silica-based foulant species may include SiO2 particles, silicic acid, and/or polymeric silica.

The guard solution 5106 may be disposed between the first membrane 5104 and the second membrane 5108. The guard solution 5106 may provide an intermediate barrier zone that contains lithium ions and some of the multivalent cations 5114 that may have crossed the first membrane 5104. The guard solution 5106 may receive lithium ions that pass through the first membrane 5104 while the first membrane 5104 reduces transport of the foulant species 5116 from the feed solution 5102.

In various embodiments, lithium ions that enter the guard solution 5106 through the first membrane 5104 may not entirely cross the second membrane 5108, resulting in some lithium remaining in the guard solution 5106 at the end of a batch cycle. However, the volume of the guard solution 5106 may be made as small as practically feasible, because the rate of lithium transport is governed primarily by the membrane interfaces rather than by the volume of the guard solution 5106. By minimizing the volume of the guard solution 5106, the amount of lithium retained in the guard solution 5106 at the end of a batch cycle may be reduced to a small fraction of the total lithium extracted from the feed solution 5102. In some aspects, the lithium loss in the guard solution 5106 may be less than approximately 1% of the total lithium in the feed solution 5102, and the overall lithium recovery of the system 5100 may be at least 90%. Furthermore, the lithium remaining in the guard solution at the end of an extraction step of a given lithium capture cycle may be carried over to and captured in the next extraction cycle, resulting in a larger effective lithium recovery per cycle.

The second membrane 5108 may separate the guard solution 5106 from the receiving solution 5110. The second membrane 5108 may be configured to permit transport of lithium ions while reducing transport of the multivalent cations 5114. In one embodiment, the second membrane 5108 may comprise a monovalent-selective cation exchange membrane configured to reduce transport of divalent cations such as magnesium, calcium, barium, and/or strontium. The second membrane 5108 may permit passage of monovalent lithium ions while reducing passage of the multivalent cations 5114 that may have crossed the first membrane 5104.

It is to be recognized that the first membrane 5104 and/or the second membrane 5108 may be configured in any manner. For example, the first membrane 5104 may be configured specifically for multivalent cations 5114 filtration and the second membrane 5108 may be configured specifically for the foulant species 5116 as an alternative.

The receiving solution 5110 may be disposed on a side of the second membrane 5108 opposite the guard solution 5106. The receiving solution 5110 may contain lithium ions that have migrated through both the first membrane 5104 and the second membrane 5108. The diffusion path 5112 may indicate a direction of lithium ion transport from the feed solution 5102 through the first membrane 5104, through the guard solution 5106, through the second membrane 5108, and into the receiving solution 5110.

The lithium sink 5118 may be in physical contact with the receiving solution 5110. The lithium sink 5118 may be configured to reduce a concentration of lithium ions in the receiving solution 5110, thereby maintaining a concentration gradient that drives passive diffusion of lithium ions through the system 5100. The lithium sink 5118 may comprise one or more sorbent materials configured to reduce the concentration of lithium ions in the receiving solution 5110 by sorption, adsorption, electrochemical intercalation, ion exchange, and/or electrochemical-based filtration or extraction.

In some aspects, the lithium sink 5118 may be disposed within the receiving solution 5110, or the lithium sink 5118 may be disposed in a separate vessel in fluid communication with the receiving solution 5110 via piping, conduits, or other fluid connections configured to circulate the receiving solution 5110 between a receiving compartment and the lithium sink 5118.

In one embodiment, the transport of lithium ions through the first membrane 5104 and the second membrane 5108 may be passive in nature, driven by diffusion as a result of concentration differences between the feed solution 5102 and the receiving solution 5110. The concentration gradient may be maintained without application of an external electric potential across the first membrane 5104 or the second membrane 5108. The lithium sink 5118 may maintain the concentration gradient by continuously removing lithium ions from the receiving solution 5110 as the lithium ions migrate through the system 5100.

The dual membrane configuration with the guard solution 5106 may provide enhanced protection of the lithium sink 5118 from exposure to the foulant species 5116 and the multivalent cations 5114 present in the feed solution 5102. The first membrane 5104 may reduce transport of silica-based foulants while the second membrane 5108 may reduce transport of multivalent cation foulants. The arrangement of foulant-specific membrane layers may enable selective blocking of different types of foulants at different stages of the lithium extraction process.

The system 5100 addresses challenges associated with conventional pretreatment approaches for lithium extraction from brine sources. Conventional sorbent-based direct lithium extraction (DLE) processes may require extensive pretreatment of brine before sorbents can be used effectively, where dissolved foulants such as silica and multivalent ions can foul, poison, or otherwise interfere with sorbent operation. The system 5100 places multiple membrane-based barriers between raw brine and the lithium sink 5118, such that lithium can be extracted while reducing exposure of the lithium sink 5118 to multiple types of foulant species.

The configuration of the system 5100 may reduce process complexity compared to conventional pretreatment approaches. Conventional pretreatment steps may include filtration, chemical precipitation using lime softening or soda ash treatment, pH adjustment, aeration, and/or other conditioning methods. Such pretreatment methods may generate substantial quantities of sludge and solid waste streams that require handling, treatment, and disposal. The system 5100 may simplify DLE flowsheets, reduce sludge generation, and/or enable lithium recovery from resources that may otherwise be difficult to process.

In various embodiments, the system 5100 may include additional membrane layers and additional guard solutions between the feed solution 5102 and the receiving solution 5110. The additional membrane layers may be configured to act as additional barriers for foulants, further protecting the lithium sink 5118 and the receiving solution 5110 from the foulant species 5116. Each additional membrane layer may be configured to reduce transport of a different type of foulant species, providing staged foulant removal as lithium ions migrate through the system 5100. The number of membrane layers and guard solutions may be selected based on the composition of the feed solution 5102 and the types of foulant species present in the lithium-containing brine.

As an alternative to the above arrangement, in various embodiments, the first membrane 5104 and the second membrane 5108 may be housed within a single assembly having three process compartments, where the feed solution 5102, the guard solution 5106, and the receiving solution 5110 each occupy a respective compartment separated by the first membrane 5104 and the second membrane 5108. In this configuration, the first membrane 5104 and the second membrane 5108 may have matched membrane areas within the single assembly.

In other embodiments, the first membrane 5104 and the second membrane 5108 may be housed in separate assemblies. A first assembly may contain the first membrane 5104 separating the feed solution 5102 from the guard solution 5106, and a second assembly may contain the second membrane 5108 separating the guard solution 5106 from the receiving solution 5110. The guard solution 5106 may be circulated between the first assembly and the second assembly via piping or other fluid connections. The separate assembly configuration may enable the first membrane 5104 and the second membrane 5108 to have different membrane areas. For example, where lithium diffusion is slower through one membrane than the other, a larger membrane area may be provided for the slower membrane to balance the overall lithium transport rate through the system 5100.

The separate assembly configuration may also provide advantages for cleaning-in-place procedures. Each membrane may require different cleaning chemicals based on the types of foulant species to which it is exposed. For example, the first membrane 5104, which may be exposed to silica-based foulants from the feed solution 5102, may require more aggressive cleaning chemicals than the second membrane 5108, which may be exposed primarily to multivalent cations that have crossed the first membrane 5104 at low concentrations. In some aspects, the first membrane 5104 may comprise a perfluorosulfonic acid polymer that is capable of withstanding intense chemical cleaning environments, while the second membrane 5108 may comprise a monovalent-selective cation exchange membrane that may have different chemical compatibility requirements. By housing the first membrane 5104 and the second membrane 5108 in separate assemblies, cleaning-in-place procedures may be tailored independently for each membrane without exposing either membrane to cleaning chemicals that are unnecessarily harsh or potentially damaging.

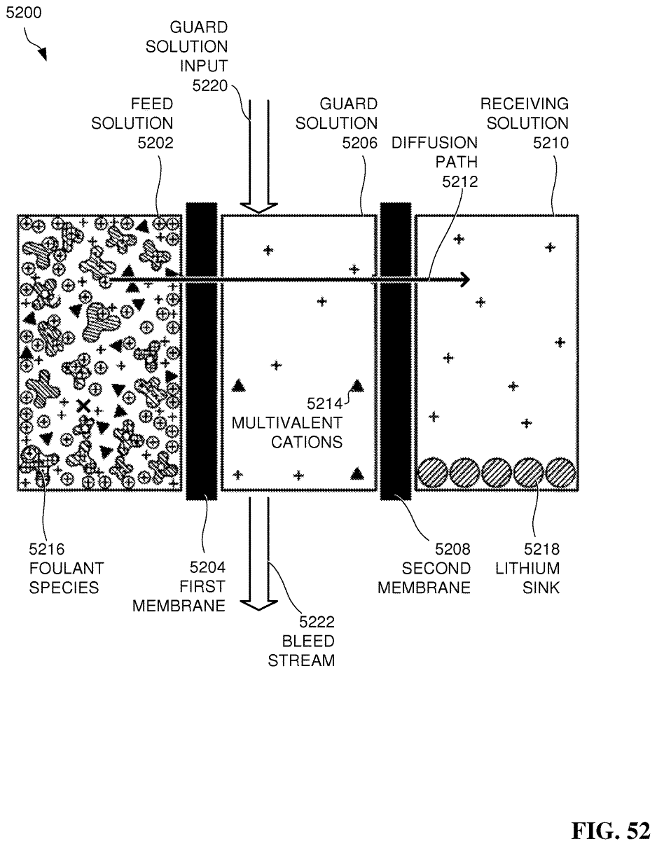

FIG. 52 illustrates a system 5200 for extracting lithium from a lithium-containing brine using multiple membrane barriers and a guard solution with a bleed stream configuration, in accordance with one embodiment. As an option, the system 5200 may be implemented in the context of any one or more of the embodiments set forth in any previous and/or subsequent Figures and/or description thereof. Of course, however, the system 5200 may be implemented in the context of any desired environment. Further, the aforementioned definitions may equally apply to the description below.

As shown, FIG. 52 illustrates a system 5200 that builds upon the dual membrane and guard solution configuration of FIG. 51 by adding a guard solution input 5220 and a bleed stream 5222 for managing foulant accumulation within the guard solution compartment. The feed solution 5202, first membrane 5204, guard solution 5206, second membrane 5208, receiving solution 5210, diffusion path 5212, multivalent cations 5214, foulant species 5216, and lithium sink 5218 correspond to the feed solution 5102, first membrane 5104, guard solution 5106, second membrane 5108, receiving solution 5110, diffusion path 5112, multivalent cations 5114, foulant species 5116, and lithium sink 5118 described in connection with FIG. 51, and may be configured with the same characteristics and functions as described above.

The guard solution input 5220 may provide fresh guard solution to a compartment containing the guard solution 5206. In some aspects, the guard solution input 5220 may be configured to supply guard solution at a controlled rate to maintain a desired volume and/or composition within the guard solution 5206 compartment. The guard solution input 5220 may be connected to a reservoir containing guard solution of a predetermined composition.

The bleed stream 5222 may be configured to periodically or continuously remove a portion of the guard solution 5206 from the system 5200. In one embodiment, the bleed stream 5222 may prevent accumulation of foulant species and/or multivalent cations 5214 that may have crossed the first membrane 5204. By removing a portion of the guard solution 5206, the bleed stream 5222 may reduce a concentration of foulants within the guard solution 5206 compartment over time. In some aspects, the lithium sink 5218 may be disposed within the receiving solution 5210, or the lithium sink 5218 may be disposed in a separate vessel in fluid communication with the receiving solution 5210 via piping, conduits, or other fluid connections configured to circulate the receiving solution 5210 between a receiving compartment and the lithium sink 5218.

In various embodiments, the bleed stream 5222 may be converted into a recycle stream configured to selectively remove foulant species from the removed guard solution 5206 and return the treated solution to the guard solution 5206 compartment via the guard solution input 5220. The selective removal of foulant species from the recycle stream may be accomplished through chemical precipitation using reagents such as lime and/or soda ash to precipitate silica, magnesium, calcium, and other multivalent ions from the removed guard solution 5206. While the chemical precipitation may generate a waste stream and consume reagents, the quantity of reagents required may be substantially lower than would be required to pretreat the feed solution 5202 directly, because only a fraction of the foulant species from the feed solution 5202 enter the guard solution 5206 through the first membrane 5204. The recycle stream configuration may reduce lithium loss compared to disposing of the bleed stream, because the lithium remaining in the removed guard solution 5206 may be returned to the guard solution 5206 compartment after foulant removal.

In various embodiments, the composition of the guard solution 5206 may be controlled to reduce the quantity of reagents required for foulant precipitation in the recycle stream. Because the initial composition of the guard solution 5206 may be selected independently of the feed solution 5202, the alkalinity of the guard solution 5206 may be tuned to a low level that requires less reagent per unit of foulant to achieve precipitation. This may create a compound effect in which the system not only has fewer foulants to precipitate compared to direct pretreatment of the feed solution 5202, but also requires less reagent per foulant to achieve precipitation due to the controlled alkalinity of the guard solution 5206.

In other embodiments, the bleed stream 5222 may be directed back to the feed solution 5202 or to a brine effluent stream without chemical treatment. This configuration may avoid the need for precipitation reagents and associated waste streams. However, directing the bleed stream 5222 back to the feed solution 5202 may result in loss of lithium ions present in the removed guard solution 5206. The rate at which the guard solution 5206 is bled relative to the guard solution 5206 volume may affect the amount of lithium lost through the bleed stream 5222. In this configuration, the guard solution input 5220 may require a source of fresh or foulant-free water, and the guard solution input 5220 may include sufficient sodium chloride or other salts to match an osmotic pressure of the guard solution 5206 with the osmotic pressures of the feed solution 5202 and the receiving solution 5210, as mismatched osmotic pressures may drive unwanted bulk flow of solution between compartments.

In various embodiments, the expected foulant concentrations in the guard solution 5206 may be substantially lower than in the feed solution 5202. For example, a silica concentration in the guard solution 5206 may be on the order of ten times lower than a silica concentration in the feed solution 5202, a magnesium concentration may be on the order of five to ten times lower, and a calcium concentration may be on the order of two to three times lower, depending on the diffusivities of the respective species through the first membrane 5204. The lithium concentration in the guard solution 5206 may be between the lithium concentration in the feed solution 5202 and the lithium concentration in the receiving solution 5210.

In various embodiments, the system 5200 may include a lithium output stream (not shown) in fluid communication with the receiving solution 5210 and/or the lithium sink 5218. The lithium output stream may be configured to transfer lithium ions from the receiving solution 5210 to downstream processing equipment for recovery of lithium products. In some aspects, the lithium output stream may be configured to receive lithium ions released from the lithium sink 5218 during a release phase and convey the released lithium ions to a lithium recovery vessel. The lithium output stream may operate continuously or periodically based on the operational cycle of the lithium sink 5218. In other aspects, the lithium output stream may comprise a circulation loop configured to continuously transfer a portion of the receiving solution 5210 to a downstream lithium recovery system, where lithium ions are removed from the circulated portion, and the lithium-depleted solution is returned to the receiving solution 5210 compartment. The continuous circulation may maintain a low lithium ion concentration in the receiving solution 5210 without requiring batch release cycles from the lithium sink 5218.

In some aspects, the system 5200 may be configured for continuous guard bleed operation. During continuous guard bleed operation, the bleed stream 5222 may continuously remove a portion of the guard solution 5206 while the guard solution input 5220 continuously supplies fresh guard solution. The continuous removal and replenishment of the guard solution 5206 may maintain a low concentration of foulant species within the guard solution 5206 compartment, thereby reducing the likelihood of foulant species crossing the second membrane 5208 and reaching the receiving solution 5210.

In other aspects, the system 5200 may be configured for periodic guard bleed operation. During periodic guard bleed operation, the bleed stream 5222 may remove a portion of the guard solution 5206 at predetermined intervals. The predetermined intervals may be based on elapsed time, accumulated foulant concentration within the guard solution 5206, and/or other operational parameters. Between bleed intervals, the guard solution 5206 may accumulate foulant species that have crossed the first membrane 5204, and the periodic bleed may reduce the accumulated foulant concentration.

The addition of the guard solution input 5220 and the bleed stream 5222 may provide enhanced protection of the lithium sink 5218. While the dual membrane configuration of FIG. 51 reduces transport of foulant species through the first membrane 5104 and the second membrane 5108, foulant species that do cross the first membrane 5104 may accumulate in the guard solution 5106 over time. The bleed stream 5222 of the system 5200 addresses this accumulation by removing foulants that have collected in the guard solution 5206, thereby further reducing the likelihood of foulant species reaching the receiving solution 5210.

In various embodiments, the bleed stream 5222 may be configured to remove the guard solution 5206 at a rate selected based on a foulant loading rate of the feed solution 5202. A higher foulant loading rate in the feed solution 5202 may correspond to a higher bleed rate for the bleed stream 5222. The bleed rate may be adjusted during operation based on measured foulant concentrations within the guard solution 5206 and/or based on observed performance of the system 5200.

In various embodiments, the system 5200 may include a precipitation stream configured to remove foulant species from the guard solution 5206 through chemical precipitation. The precipitation stream may be used as an alternative to or in combination with the bleed stream 5222. Chemical precipitation within the guard solution 5206 compartment may convert dissolved foulant species into solid precipitates that can be removed from the system 5200. Following removal of the solid precipitates, the treated guard solution may be recycled back into the guard solution 5206 compartment via the guard solution input 5220, thereby recovering lithium ions remaining in the treated solution and reducing consumption of fresh guard solution.

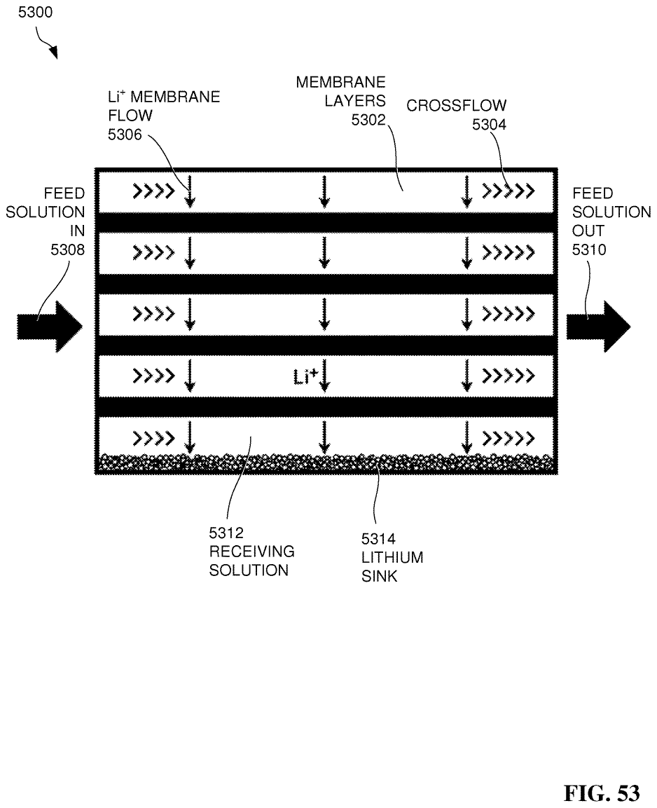

FIG. 53 illustrates a membrane stack 5300 configured for lithium extraction from a lithium-containing brine in a crossflow configuration, in accordance with one embodiment. As an option, the membrane stack 5300 may be implemented in the context of any one or more of the embodiments set forth in any previous and/or subsequent Figures and/or description thereof. Of course, however, the membrane stack 5300 may be implemented in the context of any desired environment. Further, the aforementioned definitions may equally apply to the description below.

As shown, the membrane stack 5300 includes a plurality of membrane layers 5302, a crossflow 5304, a lithium ion membrane flow 5306, a feed solution in 5308, a feed solution out 5310, a receiving solution 5312, and a lithium sink 5314. The plurality of membrane layers 5302 may be arranged in a stacked configuration with flow compartments disposed between adjacent membrane layers 5302. The flow compartments may be configured to allow process solutions, including feed solutions and receiving solutions, to flow through the membrane stack 5300.

The feed solution in 5308 may enter the membrane stack 5300 from a first side of the membrane stack 5300. The feed solution may flow through the flow compartments in the crossflow 5304 configuration parallel to surfaces of the plurality of membrane layers 5302. The feed solution out 5310 may exit the membrane stack 5300 from a second side of the membrane stack 5300 opposite the first side. In one embodiment, the crossflow 5304 arrangement may facilitate high shear forces at surfaces of the plurality of membrane layers 5302.

It is to be appreciated that, in various embodiments, the membrane stack 5300 may be configured with multiple independent feed solution streams, where each flow compartment or a subset of flow compartments receives a separate feed solution stream rather than a single feed solution stream being distributed across all flow compartments. The multiple independent feed solution streams may enable more uniform flow distribution across the plurality of membrane layers 5302, which may provide more consistent shear forces at the membrane surfaces and more uniform lithium extraction rates across the membrane stack 5300. Each independent feed solution stream may have a dedicated feed solution inlet and a dedicated feed solution outlet, allowing independent control of flow rates through individual flow compartments or groups of flow compartments. The multiple feed solution stream configuration may also enable different flow compartments to process feed solutions of different compositions or at different stages of lithium depletion.

The lithium ion membrane flow 5306 may occur through each of the plurality of membrane layers 5302 in a direction perpendicular to the crossflow 5304. Lithium ions may pass from the feed solution through the plurality of membrane layers 5302 toward the receiving solution 5312. The receiving solution 5312 may be disposed below the membrane stack 5300 and may be in communication with the lithium sink 5314. The lithium sink 5314 may be configured to reduce a concentration of lithium ions in the receiving solution 5312.

In various embodiments, the flow compartments between adjacent membrane layers 5302 may have a spacing of approximately 0.3 mm to 1 mm or greater, and may include a spacer mesh disposed between adjacent membrane layers 5302 to maintain the spacing and promote turbulence within the flow compartments. The spacer mesh may comprise polypropylene or other chemically resistant materials. The feed solution may flow through the flow compartments at a velocity of approximately 0.1 m/s to 0.5 m/s, corresponding to a Reynolds number of approximately 100 to 500 within the flow compartments. Higher Reynolds numbers within this range may indicate more turbulent flow conditions at the membrane surfaces, which may increase shear forces and reduce accumulation of foulant species on the surfaces of the plurality of membrane layers 5302. The spacing between adjacent membrane layers 5302 and the crossflow velocity may be selected in combination to achieve a target Reynolds number that provides sufficient turbulence to reduce fouling while maintaining acceptable pressure drop across the membrane stack 5300.

In one embodiment, the crossflow 5304 configuration may prevent fouling of the plurality of membrane layers 5302 due to the high shear forces generated at surfaces of the plurality of membrane layers 5302. The high shear forces may sweep foulant species away from the surfaces of the plurality of membrane layers 5302 as the feed solution flows parallel to the surfaces. The crossflow 5304 configuration may reduce accumulation of foulant species on the surfaces of the plurality of membrane layers 5302 compared to configurations where process solutions flow perpendicular to membrane surfaces.

In some aspects, membrane-based technologies for brine and/or water treatment may flow process solutions through membranes in a dead-end or perpendicular flow configuration. Dead-end flow configurations may actively encourage fouling that is often irreversible. The crossflow 5304 configuration of the membrane stack 5300 may reduce fouling compared to dead-end flow configurations by maintaining continuous movement of the feed solution parallel to the surfaces of the plurality of membrane layers 5302. The tangential flow of the feed solution may continuously remove foulant species from the membrane surfaces before the foulant species can accumulate and cause irreversible fouling.

The lithium sink 5314 may maintain a concentration gradient between the feed solution and the receiving solution 5312. The concentration gradient may drive passive diffusion of lithium ions through the plurality of membrane layers 5302. In one embodiment, the lithium sink 5314 may comprise one or more materials configured to reduce the concentration of lithium ions in the receiving solution 5312 by sorption, electrochemical intercalation, ion exchange, and/or electrochemical-based filtration or extraction. The one or more materials may comprise aluminum hydroxide, lithium titanate, lithium iron phosphate, and/or lithium manganese oxide.

In various embodiments, the membrane stack 5300 may be modular such that a lithium processing rate is scalable by adjusting a number of membrane stack modules. A given lithium processing rate may be met by scaling up the number of individual membrane stack modules to meet a throughput target. The modular configuration of the membrane stack 5300 may enable adjustment of the number of membrane stack modules to meet varying throughput requirements for lithium extraction operations.

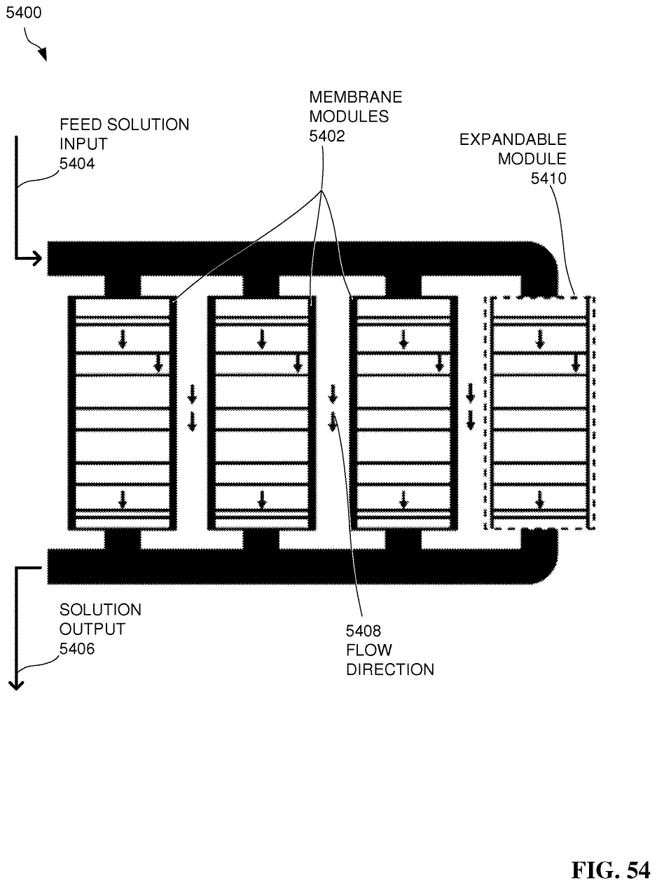

FIG. 54 illustrates a membrane system 5400 configured for lithium extraction from a lithium-containing brine, in accordance with one embodiment. As an option, the membrane system 5400 may be implemented in the context of any one or more of the embodiments set forth in any previous and/or subsequent Figures and/or description thereof. Of course, however, the membrane system 5400 may be implemented in the context of any desired environment. Further, the aforementioned definitions may equally apply to the description below.

As shown, the membrane system 5400 includes a plurality of membrane modules 5402, a feed solution input 5404, a solution output 5406, a flow direction 5408, and an expandable module 5410. The plurality of membrane modules 5402 may be arranged in a parallel configuration within a housing structure. The feed solution input 5404 may be positioned at an upper portion of the membrane system 5400, through which a lithium-containing feed solution enters the membrane system 5400. The solution output 5406 may be positioned at a lower portion of the membrane system 5400, through which processed solution exits the membrane system 5400.

The flow direction 5408 may indicate a path of solution movement through the membrane system 5400. In one embodiment, the flow direction 5408 may show the feed solution moving vertically downward through the plurality of membrane modules 5402 and then horizontally along a lower channel before exiting through the solution output 5406. The plurality of membrane modules 5402 may be configured as rectangular units with internal flow channels that permit the feed solution to pass through while enabling lithium ion transport across membrane surfaces within each of the plurality of membrane modules 5402.

It is to be appreciated that any number of membrane modules 5402 may be included and positioned within the membrane system 5400. To that end, the expandable module 5410 may represent additional filtration module units that can be added to the membrane system 5400. In some aspects, the expandable module 5410 may be depicted with dashed lines to indicate an optional or modular nature of the expandable module 5410. The expandable module 5410 may demonstrate a scalable architecture of the membrane system 5400, allowing additional membrane modules to be added to increase lithium processing capacity as needed. The modular configuration of the membrane system 5400 may enable adjustment of the number of membrane modules 5402 to meet varying throughput requirements for lithium extraction operations.

In one embodiment, the membrane system 5400 may be configured such that a given lithium processing rate can be met by scaling up the number of individual membrane modules 5402 to meet a throughput target. The modular architecture may allow operators to add or remove membrane modules 5402 based on production requirements without redesigning the membrane system 5400. Each of the plurality of membrane modules 5402 may function independently while sharing common feed solution input 5404 and solution output 5406 connections.

By one of a specific example (which it is to be understood the present disclosure shall not be limited solely thereto), in various embodiments, a single membrane module of approximately 0.5 m3 in volume may be configured to process on the order of 1.6 metric tons of lithium carbonate equivalent (LCE) per year, depending on factors such as lithium concentration in the feed solution, membrane thickness, membrane properties, and operating temperature. A commercial-scale facility targeting approximately 500 metric tons of LCE per year may require on the order of 300 membrane modules in this configuration. The number of membrane modules required may vary by an order of magnitude or more depending on the lithium concentration in the feed solution, the membrane thickness selected, and the operating conditions of the system. Higher lithium concentrations in the feed solution and thinner membranes may increase the processing capacity of each individual membrane module, thereby reducing the total number of modules required to meet a given throughput target.

In some aspects, the plurality of membrane modules 5402 may each contain one or more membrane layers configured to permit transport of lithium ions while reducing transport of foulant species present in the feed solution.

In various embodiments, each of the plurality of membrane modules 5402 may be in communication with a lithium sink configured to reduce a concentration of lithium ions in a receiving solution. The lithium sink may maintain a concentration gradient that drives passive diffusion of lithium ions through the membrane layers within each of the plurality of membrane modules 5402. Transport of lithium ions through the membrane layers may be driven by diffusion resulting from the concentration gradient between the feed solution and the receiving solution, without application of an external electric potential across the membrane layers.

In various embodiments, the plurality of membrane modules 5402 may be connected in series, parallel, or a combination of series and parallel configurations. A series configuration may allow sequential processing of the feed solution through multiple membrane modules 5402, while a parallel configuration may allow simultaneous processing of the feed solution through multiple membrane modules 5402. The combination of series and parallel configurations may provide flexibility in optimizing lithium extraction efficiency and throughput for the membrane system 5400.

In various embodiments, the membrane system 5400 may be configured to accommodate process solutions flowing parallel to the membrane surfaces within each of the plurality of membrane modules 5402 in a crossflow or tangential flow configuration. The crossflow configuration may prevent fouling due to high shear forces at the surfaces of the membrane layers. In particular, in the crossflow or tangential flow configuration, the direction of fluid flow is parallel to the membrane surfaces, as opposed to perpendicular flow through the membranes, such that the feed solution moves along the membrane surfaces rather than being forced through the membrane material. The tangential flow of the feed solution may continuously remove foulant species from the membrane surfaces before the foulant species can accumulate and cause irreversible fouling.

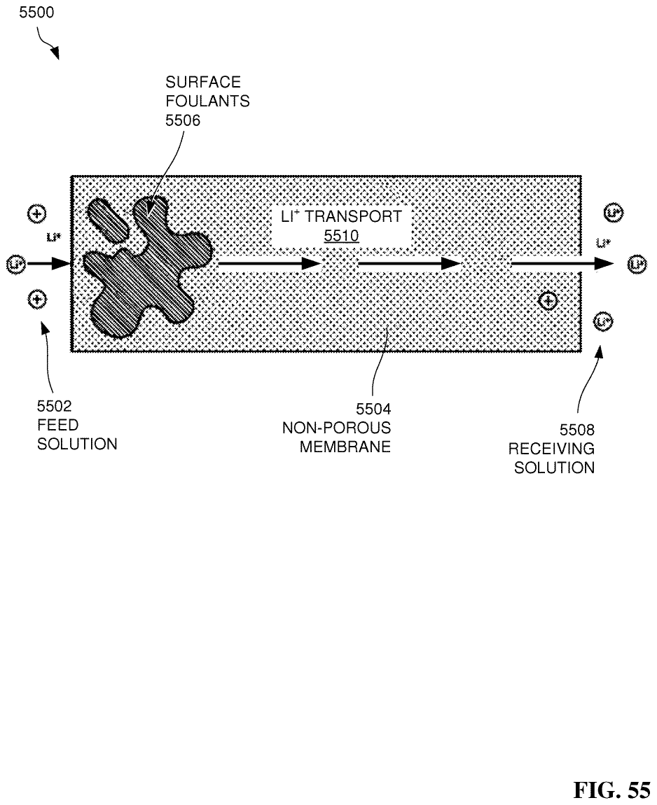

FIG. 55 illustrates a lithium extraction system 5500 configured for lithium extraction using a non-porous membrane 5504, in accordance with one embodiment. As an option, the lithium extraction system 5500 may be implemented in the context of any one or more of the embodiments set forth in any previous and/or subsequent Figures and/or description thereof. Of course, however, the lithium extraction system 5500 may be implemented in the context of any desired environment. Further, the aforementioned definitions may equally apply to the description below.

As shown, the lithium extraction system 5500 includes a feed solution 5502, a non-porous membrane 5504, surface foulants 5506, a receiving solution 5508, and lithium ion transport 5510. The feed solution 5502 may be positioned on a first side of the non-porous membrane 5504 and may contain lithium ions along with various foulant species. The foulant species may include, but not be limited solely to, silica species, multivalent cations, organic substances, and/or hydrogen sulfide. The non-porous membrane 5504 may separate the feed solution 5502 from the receiving solution 5508.

As used herein, the term “non-porous” when used to describe a membrane refers to a membrane that is designed to be substantially free of through-pores, such that ion transport occurs through hydrated ionic domains of the polymer rather than through convective flow in pore channels. It is understood that polymeric membranes may contain hydration within interstitial spaces between polymer segments and may include diffusion pathways through the bulk of the membrane material; however, these hydrated ionic domains and diffusion pathways are distinct from through-pores that would permit convective transport of foulant species into or through the membrane structure. Accordingly, a non-porous membrane as described herein may limit fouling to an outermost surface of the membrane because foulant species are unable to enter through-pores and instead accumulate only on the external surface of the membrane.

The surface foulants 5506 may accumulate on a surface of the non-porous membrane 5504 that faces the feed solution 5502. Because the non-porous membrane 5504 lacks pores, the surface foulants 5506 may be restricted to an outermost surface of the non-porous membrane 5504 rather than penetrating into a structure of the non-porous membrane 5504. In one embodiment, the non-porous configuration of the non-porous membrane 5504 may limit fouling to the outermost surface of the non-porous membrane 5504, which may facilitate removal of the surface foulants 5506 through cleaning procedures.

The receiving solution 5508 may be positioned on a second side of the non-porous membrane 5504 opposite the feed solution 5502. The lithium ion transport 5510 may occur through a bulk of the non-porous membrane 5504 from the feed solution 5502 to the receiving solution 5508. In one embodiment, the lithium ion transport 5510 may be driven by a concentration gradient between the feed solution 5502 and the receiving solution 5508, with lithium ions migrating from a higher concentration in the feed solution 5502 toward a lower concentration in the receiving solution 5508.

In various embodiments, the mechanism of lithium ion transport through the bulk of the non-porous membrane 5504 may comprise ion hopping through a hydrated polymer network. For polymeric membranes with fixed anionic charge groups, such as perfluorosulfonic acid membranes, lithium ions may hop through hydrated ionic domains from one fixed sulfonate group to the next within the polymer structure. This ion hopping mechanism through hydrated domains is distinct from transport mechanisms in porous membranes, where ions may diffuse or be convected through pore channels, and is also distinct from transport mechanisms in solid electrolyte membranes, where ions hop through a crystal lattice structure rather than through hydrated domains. In general, non-porous polymeric membranes with fixed anionic charge groups may transport lithium ions through ion hopping in hydrated domains, regardless of the specific polymer chemistry employed.

The non-porous membrane 5504 may be configured to permit the lithium ion transport 5510 while blocking or reducing transport of the surface foulants 5506 to the receiving solution 5508. The concentration gradient may drive lithium ions through the bulk of the non-porous membrane 5504 material rather than through pores. In some aspects, the lithium ion transport 5510 may occur without application of an external electric potential across the non-porous membrane 5504. The passive nature of the lithium ion transport 5510 may be driven by diffusion as a result of concentration differences between the feed solution 5502 and the receiving solution 5508.

In one embodiment, the lithium extraction system 5500 may include a lithium sink in physical contact with the receiving solution 5508. The lithium sink may be configured to reduce a concentration of lithium ions in the receiving solution 5508, thereby maintaining the concentration gradient that drives the lithium ion transport 5510 through the non-porous membrane 5504. The lithium sink may comprise one or more materials configured to reduce the concentration of lithium ions in the receiving solution 5508 by sorption, electrochemical intercalation, ion exchange, and/or electrochemical-based filtration or extraction.

The non-porous configuration of the non-porous membrane 5504 may facilitate cleaning-in-place (CIP) procedures for removal of the surface foulants 5506. Because the surface foulants 5506 accumulate on the outermost surface of the non-porous membrane 5504 rather than within pores, the surface foulants 5506 may be removed through treatment with cleaning agents without requiring removal of foulants from within a pore structure. In some aspects, the non-porous membrane 5504 may be configured to undergo a cleaning-in-place procedure comprising treatment with a strong acid, a strong base, a chelator, an oxidizer, and/or a surfactant to remove the surface foulants 5506 from the surface of the non-porous membrane 5504.

In various embodiments, the strong acid may comprise hydrochloric acid (HCl). The strong base may comprise sodium hydroxide (NaOH). The chelator may comprise citric acid and/or ethylenediaminetetraacetic acid (EDTA). The oxidizer may comprise hydrogen peroxide (H2O2). The cleaning-in-place procedure may restore functionality of the non-porous membrane 5504 after exposure to foulant species in the feed solution 5502.

In various embodiments, the lithium extraction system 5500 may be configured such that process solutions flow parallel to a surface of the non-porous membrane 5504 in a crossflow or tangential flow configuration. The crossflow configuration may further reduce fouling due to high shear forces at the surface of the non-porous membrane 5504. The tangential flow of the feed solution 5502 may continuously sweep foulant species away from the surface of the non-porous membrane 5504 before the foulant species can accumulate and cause irreversible fouling.

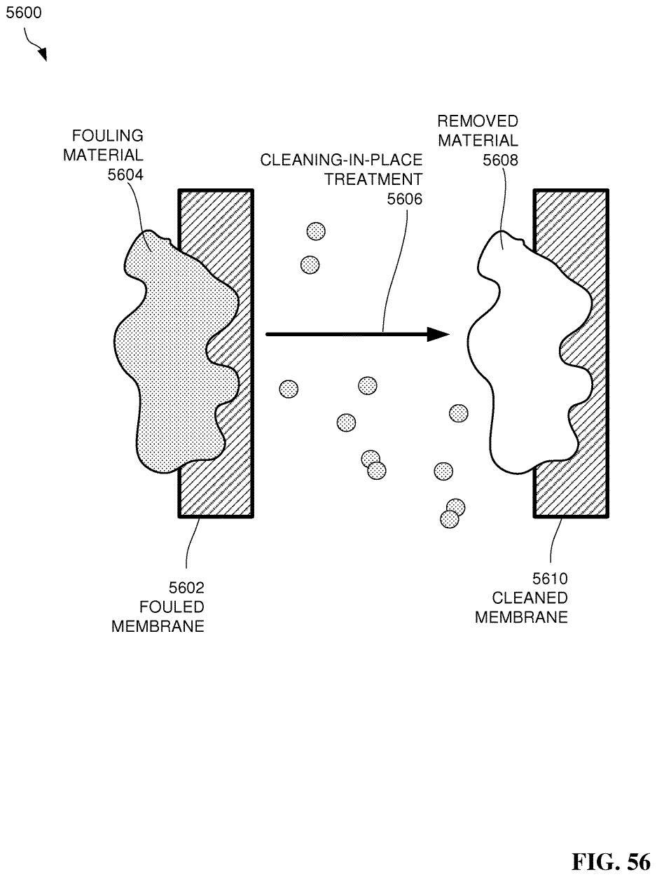

FIG. 56 illustrates a membrane cleaning process 5600 for cleaning-in-place procedures in a lithium extraction system, in accordance with one embodiment. As an option, the membrane cleaning process 5600 may be implemented in the context of any one or more of the embodiments set forth in any previous and/or subsequent Figures and/or description thereof. Of course, however, the membrane cleaning process 5600 may be implemented in the context of any desired environment. Further, the aforementioned definitions may equally apply to the description below.

As shown, the membrane cleaning process 5600 includes a fouled membrane 5602, fouling material 5604, a cleaning-in-place treatment 5606, removed material 5608, and a cleaned membrane 5610. The fouled membrane 5602 may represent a membrane that has been exposed to a feed solution containing foulant species during lithium extraction operations. The fouling material 5604 may accumulate on a surface of the fouled membrane 5602 as a result of exposure to the feed solution. The fouling material 5604 may comprise but not be limited solely to silica species, multivalent cations, organic substances, hydrogen sulfide, and/or other impurities present in the feed solution. The cleaning-in-place treatment 5606 may be applied to the fouled membrane 5602 to remove the fouling material 5604 from the surface of the fouled membrane 5602. In one embodiment, the cleaning-in-place treatment 5606 may comprise treatment with one or more cleaning agents configured to dissolve, dislodge, and/or chemically react with the fouling material 5604. The cleaning-in-place treatment 5606 may be performed without removing the fouled membrane 5602 from a membrane housing or membrane stack, thereby reducing downtime and maintenance complexity.

The removed material 5608 may represent the fouling material 5604 that has been dislodged from the surface of the fouled membrane 5602 as a result of the cleaning-in-place treatment 5606. In one embodiment, the removed material 5608 may be dispersed into a surrounding solution and subsequently flushed from the membrane system. The cleaned membrane 5610 may represent the fouled membrane 5602 after the cleaning-in-place treatment 5606 has removed the fouling material 5604 from the surface of the fouled membrane 5602.

In various embodiments, the cleaning-in-place treatment 5606 may be performed at intervals ranging from approximately every 1,000 hours of operation to every 3 to 12 months, depending on the type of membrane process, the composition of the feed solution, and the rate of fouling material 5604 accumulation on the membrane surface. The frequency of the cleaning-in-place treatment 5606 may be brine-specific, as feed solutions with higher foulant loading rates may require more frequent cleaning cycles than feed solutions with lower foulant loading rates.

In one embodiment, the cleaning-in-place treatment 5606 may comprise treatment with a strong acid. The strong acid may comprise hydrochloric acid (HCl). Treatment with the strong acid may dissolve mineral scale deposits and/or inorganic foulants that have accumulated on the surface of the fouled membrane 5602. The strong acid treatment may be effective for removing calcium-based and/or magnesium-based deposits from the membrane surface.

In one embodiment, the cleaning-in-place treatment 5606 may comprise treatment with a strong base. The strong base may comprise sodium hydroxide (NaOH). Treatment with the strong base may dissolve organic foulants and/or biological materials that have accumulated on the surface of the fouled membrane 5602. The strong base treatment may saponify organic compounds and/or hydrolyze proteins and other organic substances present in the fouling material 5604.

In one embodiment, the cleaning-in-place treatment 5606 may comprise treatment with a chelator. The chelator may comprise citric acid and/or ethylenediaminetetraacetic acid (EDTA). Treatment with the chelator may sequester metal ions present in the fouling material 5604, thereby facilitating removal of metal-containing deposits from the surface of the fouled membrane 5602. The chelator may form soluble complexes with multivalent cations such as calcium, magnesium, barium, strontium, aluminum, and/or iron, enabling removal of the multivalent cations from the membrane surface.

In one embodiment, the cleaning-in-place treatment 5606 may comprise treatment with an oxidizer. The oxidizer may comprise hydrogen peroxide (H2O2). Treatment with the oxidizer may oxidize organic foulants and/or biological materials that have accumulated on the surface of the fouled membrane 5602. The oxidizer may break down complex organic molecules into smaller, more soluble fragments that can be flushed from the membrane system.

In various embodiments, the cleaning-in-place treatment 5606 may further comprise treatment with hydrofluoric acid (HF) for removal of silica-based foulants and/or precipitated silicates from the surface of the fouled membrane 5602. Treatment with hydrofluoric acid may dissolve silica deposits that are resistant to other acid treatments. In some aspects, the cleaning-in-place treatment 5606 may further comprise treatment with one or more detergents configured to solubilize and remove organic foulants from the surface of the fouled membrane 5602.

In one embodiment, the cleaning-in-place treatment 5606 may comprise treatment with a surfactant. Treatment with the surfactant may reduce surface tension and/or emulsify hydrophobic foulants present on the surface of the fouled membrane 5602. The surfactant may facilitate wetting of the membrane surface and/or dispersion of the fouling material 5604 into the surrounding solution for removal from the membrane system.

The membrane cleaning process 5600 may restore functionality of the cleaned membrane 5610 after exposure to foulant species in the feed solution. In some aspects, the cleaning-in-place treatment 5606 may be performed periodically based on elapsed time, observed membrane performance, and/or measured foulant accumulation. The frequency of the cleaning-in-place treatment 5606 may be adjusted based on the composition of the feed solution and/or the rate of fouling material 5604 accumulation on the membrane surface.

The membrane cleaning process 5600 addresses challenges associated with membrane fouling in lithium extraction systems. Conventional membrane-based processes may experience irreversible fouling when foulant species penetrate into pore structures of porous membranes. The membrane cleaning process 5600 may be particularly effective when applied to non-porous membranes, where the fouling material 5604 accumulates on an outermost surface of the membrane rather than within pores. The surface-limited fouling of non-porous membranes may facilitate removal of the fouling material 5604 through the cleaning-in-place treatment 5606.

The configuration of the membrane cleaning process 5600 may reduce process complexity compared to membrane replacement approaches. Membrane replacement may require system shutdown, disassembly of membrane housings, and installation of new membrane components. The cleaning-in-place treatment 5606 may extend the operational lifetime of membranes in lithium extraction systems by periodically restoring membrane performance without requiring membrane replacement.

In various embodiments, the cleaning-in-place treatment 5606 may comprise a sequence of treatments with multiple cleaning agents. A multi-step cleaning sequence may comprise an initial treatment with a strong acid followed by a treatment with a strong base, or an initial treatment with a chelator followed by a treatment with an oxidizer. The sequence of treatments may be selected based on the composition of the fouling material 5604 and/or the types of foulant species present in the feed solution.

In various embodiments, the cleaning-in-place treatment 5606 may be performed at elevated temperatures or pressures to enhance cleaning effectiveness. For example, elevated temperatures may increase the solubility of the fouling material 5604 and/or increase the reaction rate between the cleaning agents and the fouling material 5604. The temperature of the cleaning-in-place treatment 5606 may be selected based on the thermal stability of the membrane material and/or the cleaning agents being used.

In various embodiments, the membrane cleaning process 5600 may be integrated with automated control systems configured to monitor membrane performance and initiate the cleaning-in-place treatment 5606 when membrane performance falls below a threshold value. The automated control systems may monitor parameters such as lithium ion transport rate, pressure differential across the membrane, and/or electrical conductivity of the receiving solution to determine when the cleaning-in-place treatment 5606 is needed.

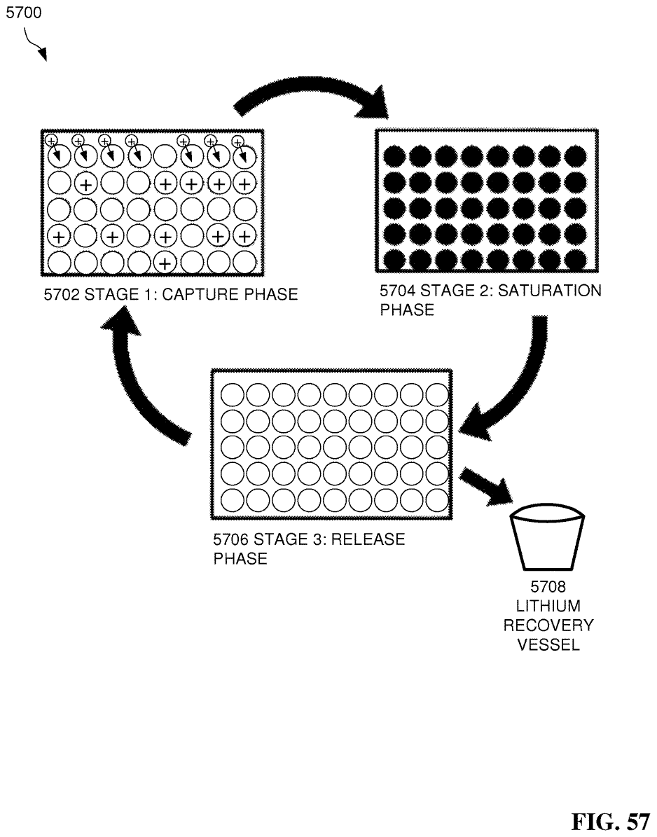

FIG. 57 illustrates a lithium extraction process 5700 comprising a cyclic operation with capture, saturation, and release phases, in accordance with one embodiment. As an option, the lithium extraction process 5700 may be implemented in the context of any one or more of the embodiments set forth in any previous and/or subsequent Figures and/or description thereof. Of course, however, the lithium extraction process 5700 may be implemented in the context of any desired environment. Further, the aforementioned definitions may equally apply to the description below.

As shown, the lithium extraction process 5700 includes a capture phase 5702, a saturation phase 5704, a release phase 5706, and a lithium recovery vessel 5708. The capture phase 5702, the saturation phase 5704, and the release phase 5706 may be arranged in a cyclic sequence, with arrows connecting the three phases to indicate progression through the cycle. The lithium recovery vessel 5708 may be positioned adjacent to the release phase 5706 and may be configured to collect lithium ions released from a lithium sink during the release phase 5706.

In various embodiments (which are provided solely as exemplary configurations, the disclosure of which shall not limit the disclosure provided), the duration of the capture phase 5702 may range from approximately 10 minutes to approximately 4 hours, depending on the type of lithium sink and the lithium ion concentration in the receiving solution. The duration of the release phase 5706 may range from approximately 30 minutes to approximately 3 hours, depending on the release mechanism and the quantity of accumulated lithium ions. The saturation phase 5704 may represent a transition between the capture phase 5702 and the release phase 5706, where the lithium sink approaches capacity and the rate of lithium ion capture decreases.

In various embodiments, the method used to release accumulated lithium ions during the release phase 5706 may depend on the type of lithium sink. For ion-exchange sorbent materials, the release phase 5706 may comprise acid elution, in which an acidic solution is introduced to displace lithium ions from the sorbent material. For adsorbent materials such as aluminum hydroxide, the release phase 5706 may comprise exposure to a low ionic strength solution such as neutral water, which may cause the lithium ions to desorb from the adsorbent material without requiring pH adjustment or chemical reagents.

In various embodiments, the lithium sink may comprise one or more electrochemical intercalation compounds such as lithium iron phosphate (LFP), and the release of accumulated lithium ions during the release phase 5706 may be accomplished through electrochemical discharge. During the capture phase 5702, the electrochemical intercalation compounds may be charged by applying electrical energy to intercalate lithium ions from the receiving solution into the crystal structure of the intercalation compounds. During the release phase 5706, the electrochemical intercalation compounds may be discharged to release the intercalated lithium ions to the lithium recovery vessel 5708. The electrochemical approach may avoid the need to alter pH or use chemical reagents for lithium release. In some aspects, the duration of the capture phase 5702 using electrochemical intercalation may range from approximately 30 minutes to approximately 10 hours, and the duration of the release phase 5706 may be similar in duration to the capture phase 5702.

During the capture phase 5702, a lithium sink may remove lithium ions from a receiving solution. In one embodiment, the lithium sink may comprise one or more materials configured to reduce a concentration of lithium ions in the receiving solution by sorption, adsorption, electrochemical intercalation, ion exchange, and/or electrochemical-based filtration or extraction. The one or more materials may comprise aluminum hydroxide, lithium titanate, lithium iron phosphate, and/or lithium manganese oxide. The capture phase 5702 may be depicted as a grid of circles, where some circles contain plus signs representing lithium ions being captured by the sorbent material and some circles are filled with downward arrows indicating active capture of lithium ions.

In one embodiment, the capture phase 5702 may maintain a concentration gradient between a feed solution and the receiving solution by continuously removing lithium ions from the receiving solution as the lithium ions migrate through a membrane. The concentration gradient may drive passive diffusion of lithium ions through the membrane from the feed solution to the receiving solution. The capture phase 5702 may reduce a concentration of free lithium ions in the receiving solution to near zero, thereby sustaining the concentration gradient that drives lithium transport through the membrane. In practice, and in various embodiments, the concentration of free lithium ions in the receiving solution during the capture phase 5702 may be reduced to a practical floor of approximately 10 ppm or less, depending on the capacity and kinetics of the lithium sink, though lower concentrations may be achievable with higher-capacity or faster-kinetics lithium sink materials.

The saturation phase 5704 may occur when the lithium sink approaches a capacity for capturing lithium ions. In one embodiment, the saturation phase 5704 may be depicted as a grid where all circles are filled, indicating that the sorbent material has reached saturation with lithium ions. During the saturation phase 5704, the lithium sink may have accumulated a quantity of lithium ions approaching a maximum capacity of the one or more sorbent materials.

In some aspects, the transition from the capture phase 5702 to the saturation phase 5704 may be determined based on elapsed time, measured lithium ion concentration in the receiving solution, and/or observed transport rate of lithium ions through the membrane. The saturation phase 5704 may indicate that the lithium sink is ready to proceed to the release phase 5706 for downstream processing of the accumulated lithium ions.

The release phase 5706 may occur when the lithium sink releases accumulated lithium ions for downstream processing. In one embodiment, the release phase 5706 may be depicted as a grid of empty circles, indicating that the lithium ions have been released from the sorbent material. During the release phase 5706, the lithium sink may transfer the accumulated lithium ions to the lithium recovery vessel 5708 for collection and further processin.

In various embodiments, the release of accumulated lithium ions during the release phase 5706 may be initiated by changing conditions within the receiving solution and/or the lithium sink. The conditions may include pH adjustment, temperature change, application of an electric potential, and/or introduction of a displacement solution configured to displace lithium ions from the one or more sorbent materials. The release phase 5706 may enable recovery of lithium ions in a concentrated form suitable for downstream processing into lithium products.

The lithium recovery vessel 5708 may be configured to collect the lithium ions released from the lithium sink during the release phase 5706. In one embodiment, the lithium recovery vessel 5708 may contain a solution configured to receive the released lithium ions. The solution within the lithium recovery vessel 5708 may be processed to produce lithium salts, lithium carbonate, lithium hydroxide, and/or other lithium products for use in battery manufacturing and/or other applications.

In some aspects, the lithium recovery vessel 5708 may be connected to downstream processing equipment configured to convert the collected lithium ions into solid lithium products. The downstream processing equipment may include precipitation systems, crystallization systems, and/or evaporation systems configured to produce lithium salts from the collected lithium ions.

Following the release phase 5706, the lithium extraction process 5700 may return to the capture phase 5702. In one embodiment, the lithium sink may subsequently resume reducing the concentration of lithium ions in the receiving solution after releasing the accumulated lithium ions during the release phase 5706. The cyclic nature of the lithium extraction process 5700 may enable continuous lithium extraction from a feed solution over extended periods of operation.

In various embodiments, the duration of each phase within the lithium extraction process 5700 may be selected based on the capacity of the lithium sink, the concentration of lithium ions in the feed solution, and/or the transport rate of lithium ions through the membrane. A lithium sink with a larger capacity may have a longer capture phase 5702 before reaching the saturation phase 5704. The duration of the release phase 5706 may be selected based on the rate at which the lithium sink can release accumulated lithium ions to the lithium recovery vessel 5708.

In various embodiments, the lithium extraction process 5700 may be configured for automated operation. Automated control systems may monitor parameters such as lithium ion concentration in the receiving solution, transport rate through the membrane, and/or saturation level of the lithium sink to determine when to transition between the capture phase 5702, the saturation phase 5704, and the release phase 5706. The automated control systems may initiate the release phase 5706 when the lithium sink reaches a predetermined saturation threshold and may initiate the capture phase 5702 when the release phase 5706 is complete.

In various embodiments, multiple lithium sinks may be operated in a staggered configuration such that at least one lithium sink is in the capture phase 5702 while another lithium sink is in the release phase 5706. The staggered configuration may enable continuous lithium extraction from the feed solution without interruption during the release phase 5706 of any individual lithium sink. The staggered operation may maintain a consistent concentration gradient across the membrane throughout the lithium extraction process 5700.

In various embodiments, the lithium extraction process 5700 may be integrated with the membrane systems described in connection with any of the foregoing Figures. The cyclic operation of the lithium extraction process 5700 may be coordinated with membrane cleaning-in-place procedures, guard solution bleed operations, and/or other maintenance activities to optimize overall system performance and lithium recovery efficiency.

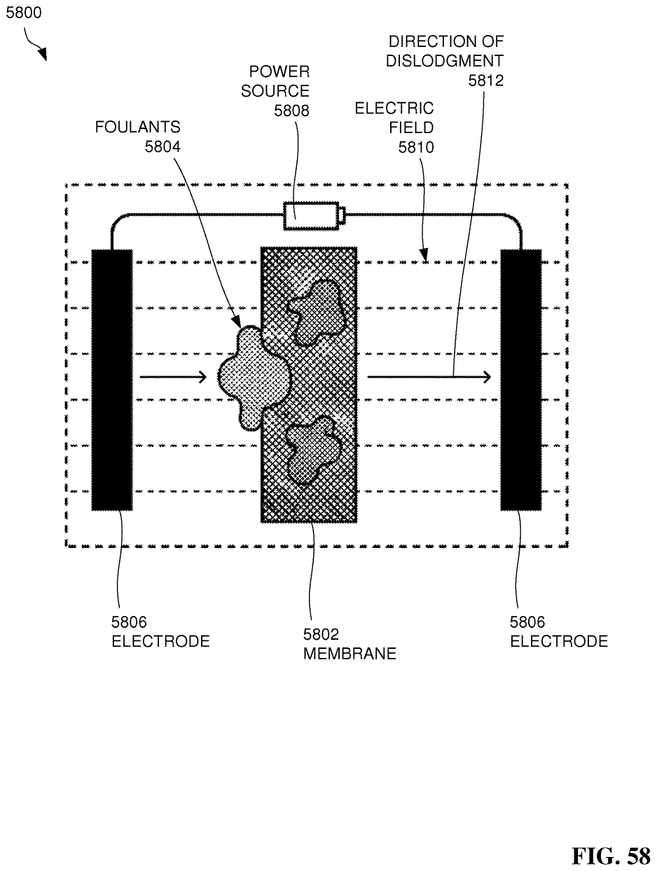

FIG. 58 illustrates a system 5800 for electrochemical foulant removal from a membrane 5802 in a lithium extraction system, in accordance with one embodiment. As an option, the system 5800 may be implemented in the context of any one or more of the embodiments set forth in any previous and/or subsequent Figures and/or description thereof. Of course, however, the system 5800 may be implemented in the context of any desired environment. Further, the aforementioned definitions may equally apply to the description below.

As shown, the system 5800 includes a membrane 5802, foulants 5804, one or more electrodes 5806, a power source 5808, an electric field 5810, and a direction of dislodgment 5812. The membrane 5802 may be positioned within a membrane housing and may be configured to permit transport of lithium ions from a feed solution to a receiving solution while reducing transport of foulant species. The foulants 5804 may accumulate on a surface of the membrane 5802 during lithium extraction operations. The foulants 5804 may comprise silica species, multivalent cations, organic substances, hydrogen sulfide, and/or other impurities present in the feed solution.

The one or more electrodes 5806 may be disposed within a housing of the membrane 5802. In one embodiment, the one or more electrodes 5806 may be positioned on opposite sides of the membrane 5802, with a first electrode 5806 on a first side and a second electrode 5806 on a second side of the system 5800. The one or more electrodes 5806 may comprise electrically conductive materials configured to generate the electric field 5810 when an electric potential is applied across the one or more electrodes 5806.

The power source 5808 may be connected to the one or more electrodes 5806 and may be configured to supply electrical energy to the one or more electrodes 5806. In some aspects, the power source 5808 may be positioned external to the membrane housing and may be electrically coupled to the one or more electrodes 5806 through electrical connections. The power source 5808 may supply a direct current (DC) voltage, an alternating current (AC) voltage, and/or a pulsed voltage to the one or more electrodes 5806.

The electric field 5810 may be generated across the membrane 5802 when the power source 5808 applies an electric potential to the one or more electrodes 5806. In one embodiment, the electric field 5810 may extend horizontally across the system 5800 between the one or more electrodes 5806. The electric field 5810 may act upon the foulants 5804 that have accumulated on the surface of the membrane 5802.

The direction of dislodgment 5812 may indicate movement of the foulants 5804 away from the surface of the membrane 5802 in response to the applied electric field 5810. In one embodiment, the electric field 5810 may exert a force on charged foulant species, causing the foulants 5804 to be dislodged from the surface of the membrane 5802. The dislodged foulants 5804 may be swept away from the membrane 5802 by flow of the feed solution and/or may be removed from the system 5800 through a drain or bleed stream.

In some aspects, the foulants 5804 may include charged species that respond to the electric field 5810. Multivalent cations such as magnesium, calcium, barium, strontium, aluminum, and/or iron may be dislodged from the surface of the membrane 5802 when the electric field 5810 is applied. Silica species and/or organic substances that have accumulated on the surface of the membrane 5802 may also be dislodged through electrophoretic forces generated by the electric field 5810.

In one embodiment, the system 5800 may operate by applying an electric potential through the power source 5808 to the one or more electrodes 5806 during a cleaning cycle. The cleaning cycle may be initiated periodically based on elapsed time, observed membrane performance, and/or measured foulant accumulation on the surface of the membrane 5802. During the cleaning cycle, the electric field 5810 may cause the foulants 5804 to be dislodged from the surface of the membrane 5802 in the direction of dislodgment 5812, thereby cleaning the membrane 5802 and restoring functionality of the membrane 5802 for lithium ion transport.

In some aspects, the system 5800 may be configured to reverse a polarity of the electric field 5810 during the cleaning cycle. Reversing the polarity of the electric field 5810 may dislodge foulants 5804 of different charge types from the surface of the membrane 5802. The polarity reversal may be performed in a sequence to remove both positively charged and negatively charged foulant species from the membrane 5802.

In various embodiments, the system 5800 may be combined with cleaning-in-place (CIP) procedures for enhanced foulant removal. The electrochemical foulant removal may be performed as a first step to dislodge loosely bound foulants 5804 from the surface of the membrane 5802, followed by chemical treatment to remove remaining foulants 5804 that are more strongly adhered to the membrane 5802. The combination of electrochemical and chemical cleaning may provide more complete removal of the foulants 5804 compared to either method alone.

In various embodiments, the one or more electrodes 5806 may be configured to generate the electric field 5810 at varying intensities. A higher intensity electric field 5810 may be applied to dislodge more strongly adhered foulants 5804, while a lower intensity electric field 5810 may be applied for routine maintenance cleaning. The intensity of the electric field 5810 may be adjusted based on the composition of the foulants 5804 and/or the degree of fouling on the surface of the membrane 5802.

In various embodiments, the system 5800 may be integrated with automated control systems configured to monitor membrane performance and initiate electrochemical cleaning when membrane performance falls below a threshold value. The automated control systems may monitor parameters such as lithium ion transport rate, pressure differential across the membrane 5802, and/or electrical conductivity of the receiving solution to determine when electrochemical cleaning is needed. The automated control systems may control the power source 5808 to apply the electric potential to the one or more electrodes 5806 when the cleaning cycle is initiated.

In various embodiments, the system 5800 may be configured to combine electrochemical driving forces with passive diffusion driving forces for lithium ion transport through the membrane 5802. The power source 5808 may apply an electric potential to the one or more electrodes 5806 to actively drive lithium ions through the membrane 5802 while a concentration gradient between the feed solution and the receiving solution simultaneously provides a passive diffusion driving force for lithium ion transport. The combination of active electrochemical transport and passive concentration-gradient-driven transport may increase an overall rate of lithium ion transport through the membrane 5802 compared to either driving force alone.

In various embodiments, the system 5800 may be operated in a hybrid mode in which the electrochemical driving force and the passive diffusion driving force operate concurrently. A lithium sink in communication with the receiving solution may reduce a concentration of lithium ions in the receiving solution, thereby maintaining the concentration gradient that provides the passive diffusion component of lithium ion transport. The one or more electrodes 5806 may simultaneously provide an applied electric potential that supplements the passive diffusion with active electrochemical migration of lithium ions through the membrane 5802. The hybrid mode may enable higher lithium extraction rates during periods of high throughput demand while the passive diffusion component may sustain baseline lithium transport during periods when the electric potential is reduced or removed.

In various embodiments, the system 5800 may be transitioned between an active mode, a passive mode, and the hybrid mode based on operational requirements. In the active mode, the power source 5808 may apply an electric potential to the one or more electrodes 5806 to drive lithium ion transport electrochemically. In the passive mode, the electric potential may be removed and lithium ion transport may be driven solely by diffusion resulting from the concentration gradient maintained by the lithium sink. In the hybrid mode, both the electric potential and the concentration gradient may contribute to lithium ion transport simultaneously. The ability to transition between modes may provide operational flexibility to optimize energy consumption, lithium extraction rate, and membrane cleaning schedules based on varying process conditions and throughput requirements.

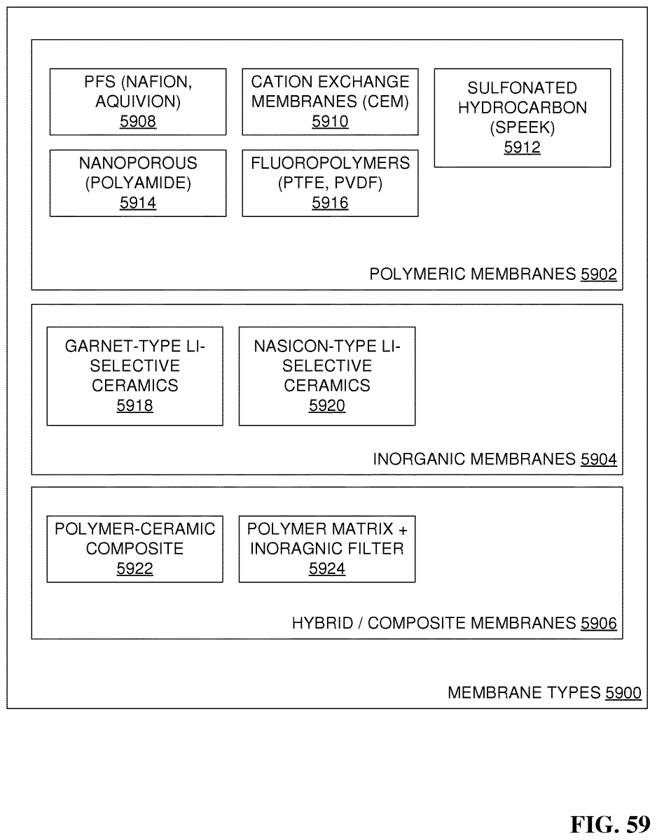

FIG. 59 illustrates membrane types 5900 suitable for use in lithium extraction systems, in accordance with one embodiment. As an option, the membrane types 5900 may be implemented in the context of any one or more of the embodiments set forth in any previous and/or subsequent Figures and/or description thereof. Of course, however, the membrane types 5900 may be implemented in the context of any desired environment. Further, the aforementioned definitions may equally apply to the description below.

As shown, the membrane types 5900 are organized into three main categories: polymeric membranes 5902, inorganic membranes 5904, and hybrid/composite membranes 5906. The hierarchical organization of the membrane types 5900 provides a framework for selecting membrane materials based on the specific requirements of a lithium extraction system. Each category of membrane types 5900 may offer different characteristics with respect to lithium ion transport, foulant rejection, chemical stability, and/or mechanical durability.

In various embodiments, the polymeric membranes 5902 may further comprise zwitterionic membranes such as poly(2-methacryloyloxyethyl phosphorylcholine) (poly (MPC)) and/or poly(sulfobetaine) membranes. The zwitterionic membranes may exhibit anti-fouling properties due to a strong affinity for water, which may form a hydration layer on the membrane surface that reduces adsorption of foulant species. The anti-fouling characteristics of the zwitterionic membranes may reduce the frequency of cleaning-in-place procedures and extend operational periods between cleaning cycles when used in the lithium extraction systems described herein.

The polymeric membranes 5902 may include PFS 5908, cation exchange membranes 5910, sulfonated hydrocarbon 5912, nanoporous 5914, and/or fluoropolymers 5916. The polymeric membranes 5902 may be configured to permit transport of lithium ions from a feed solution to a receiving solution while reducing transport of foulant species present in the feed solution. The polymeric membranes 5902 may be selected based on compatibility with the composition of the feed solution and/or the types of foulant species to be rejected.

The PFS 5908 may include perfluorosulfonic acid (PFSA) membranes such as Nafion and/or Aquivion. Nafion PFSA membranes may comprise a perfluorinated polymer backbone with sulfonic acid functional groups that facilitate cation transport. Aquivion PFSA membranes may comprise a similar perfluorinated structure with shorter side chains compared to Nafion, which may provide different ion transport characteristics. The PFS 5908 membranes may be configured to reduce transport of silica-based foulant species while permitting transport of lithium ions through the membrane material.

In one embodiment, the Nafion PFSA membrane may be non-porous such that fouling is limited to an outermost surface of the membrane rather than within pores. The non-porous configuration of the Nafion PFSA membrane may facilitate removal of foulants through cleaning-in-place (CIP) procedures. The Aquivion PFSA membrane may similarly be configured as a non-porous membrane, where a concentration gradient drives lithium ions through a bulk of the membrane material rather than through pores.

The cation exchange membranes 5910 may include sulfonated polymers configured to permit transport of cations while reducing transport of anions and/or neutral species. In one embodiment, the cation exchange membranes 5910 may comprise sulfonated polymer CEMs used in electrodialysis applications. The sulfonated polymer CEMs may be configured as monovalent-selective cation exchange membranes that permit transport of monovalent cations such as lithium ions while reducing transport of divalent and higher-valence cations such as magnesium, calcium, barium, strontium, aluminum, and/or iron.

The sulfonated hydrocarbon 5912 may include sulfonated polyether ether ketone (SPEEK) membranes. The SPEEK membrane material may comprise a hydrocarbon-based polymer backbone with sulfonic acid functional groups attached to aromatic rings within the polymer structure. The SPEEK membrane material may provide an alternative to perfluorinated membranes for applications where hydrocarbon-based materials are preferred. In some aspects, the SPEEK membrane material may be configured to permit transport of lithium ions while reducing transport of foulant species present in the feed solution.

The nanoporous 5914 may include polyamide membranes configured with nanoscale pore structures. The polyamide nanoporous membrane may be configured to permit transport of lithium ions based on size exclusion and/or charge-based selectivity mechanisms. In one embodiment, the polyamide nanoporous membrane may be configured to reduce transport of larger foulant species such as polymeric silica and/or organic substances while permitting transport of smaller lithium ions through the nanoscale pore structure.

The fluoropolymers 5916 may include polytetrafluoroethylene (PTFE)-based membranes and/or polyvinylidene fluoride (PVDF) membranes. The PTFE-based membrane may comprise a fluorinated polymer with high chemical resistance and thermal stability. In some aspects, the PTFE-based membrane may be configured as a porous support material for reinforcing other membrane types within the membrane types 5900. The PVDF membrane material may comprise a partially fluorinated polymer that may be configured as a membrane layer and/or as a polymeric binder within composite membrane structures.

In one embodiment, the fluoropolymers 5916 may include fluorinated ionomer membranes. The fluorinated ionomer membrane may comprise a fluorinated polymer backbone with ionic functional groups that facilitate selective ion transport. The fluorinated ionomer membrane may be configured to permit transport of lithium ions while reducing transport of foulant species based on charge-based selectivity and/or size exclusion mechanisms.

The inorganic membranes 5904 may include garnet-type Li-selective ceramics 5918 and/or NASICON-type Li-selective ceramics 5920. The inorganic membranes 5904 may comprise ceramic materials with crystal structures that provide selective pathways for lithium ion transport. The ceramic membrane materials may offer high selectivity for lithium ions over other cations present in the feed solution.

The garnet-type Li-selective ceramics 5918 may comprise lithium-containing oxide ceramics with a garnet crystal structure. In one embodiment, the garnet-type Li-selective ceramics 5918 may include lithium lanthanum zirconium oxide (Li7La3Zr2O12, also referred to as LLZO) and/or doped variants thereof. The garnet-type Li-selective ceramics 5918 may be configured to permit transport of lithium ions through the crystal lattice while reducing transport of other cations and/or foulant species.

The NASICON-type Li-selective ceramics 5920 may comprise lithium-containing phosphate ceramics with a sodium super ionic conductor (NASICON) crystal structure. In one embodiment, the NASICON-type Li-selective ceramics 5920 may include lithium aluminum titanium phosphate (LATP) and/or lithium aluminum germanium phosphate (LAGP). The NASICON-type Li-selective ceramics 5920 may be stable in aqueous solutions and may have high charge-transport selectivity for lithium ions over common ions such as sodium and/or magnesium.

In some aspects, the ceramic membrane materials may be embedded in an impermeable matrix to form a composite membrane structure. The impermeable matrix may provide mechanical support and/or may prevent passage of species around the ceramic particles. The ceramic membrane materials may be configured to permit selective transport of lithium ions through the ceramic crystal structure while the impermeable matrix prevents transport of foulant species through gaps between ceramic particles.

The hybrid/composite membranes 5906 may include polymer-ceramic composite 5922 and/or polymer matrix+inorganic filler 5924. The hybrid/composite membranes 5906 may combine characteristics of polymeric and inorganic membrane materials to provide enhanced performance for lithium extraction applications.

The polymer-ceramic composite 5922 may comprise ceramic particles dispersed within a polymer matrix. In one embodiment, the polymer-ceramic composite 5922 may include NASICON-type ceramic particles such as LATP and/or LAGP dispersed within a polymer matrix such as an epoxy and/or a polymeric binder. The polymer-ceramic composite 5922 may provide the lithium selectivity of ceramic materials combined with the mechanical flexibility and processability of polymer materials.

The polymer matrix+inorganic filler 5924 may comprise a polymer matrix with inorganic filler particles configured to modify the properties of the membrane. In some aspects, the inorganic filler particles may include ceramic particles, carbon particles, and/or other inorganic materials. The polymer matrix+inorganic filler 5924 may be configured to provide enhanced mechanical strength, improved chemical resistance, and/or modified ion transport characteristics compared to unfilled polymer membranes.

In various embodiments, the hybrid/composite membranes 5906 may be configured with multiple layers comprising different materials. A first layer may comprise a polymer material configured to provide mechanical support and/or chemical resistance, while a second layer may comprise a ceramic material configured to provide lithium selectivity. The multilayer configuration may enable optimization of different membrane properties through selection of appropriate materials for each layer.

In various embodiments, the membrane types 5900 may be selected based on the composition of the feed solution. A feed solution containing silica-based foulant species may be processed using a PFS 5908 membrane such as Nafion and/or Aquivion configured to reduce transport of silica species. A feed solution containing multivalent cation foulant species may be processed using a cation exchange membrane 5910 configured as a monovalent-selective membrane to reduce transport of divalent and higher-valence cations.

In various embodiments, the membrane types 5900 may be combined in a multi-membrane configuration. A first membrane may comprise a PFS 5908 membrane configured to reduce transport of silica-based foulant species, while a second membrane may comprise a cation exchange membrane 5910 configured to reduce transport of multivalent cation foulant species. The multi-membrane configuration may provide staged foulant removal as lithium ions migrate through the system.

In various embodiments, the membrane types 5900 may be reinforced with porous support materials for improved mechanical support and durability. The porous support material may comprise expanded polytetrafluoroethylene (ePTFE). The reinforced configuration may provide enhanced mechanical strength and longevity to the membrane structure while maintaining the ion transport characteristics of the membrane material. The porous support material may be positioned between polymer layers to form a sandwich structure that combines the mechanical properties of the support material with the ion selectivity of the polymer layers.

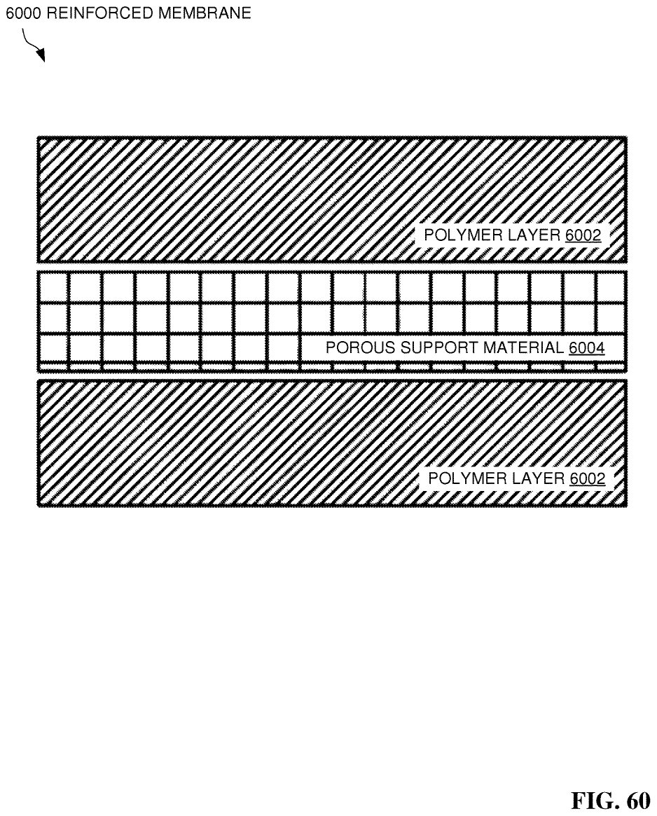

FIG. 60 illustrates a reinforced membrane 6000 suitable for use in lithium extraction systems, in accordance with one embodiment. As an option, the reinforced membrane 6000 may be implemented in the context of any one or more of the embodiments set forth in any previous and/or subsequent Figures and/or description thereof. Of course, however, the reinforced membrane 6000 may be implemented in the context of any desired environment. Further, the aforementioned definitions may equally apply to the description below.

As shown, the reinforced membrane 6000 comprises a layered structure including a porous support material 6004 and one or more polymer layers 6002. The porous support material 6004 may be positioned between two polymer layers 6002 in a sandwich configuration. The polymer layers 6002 may be disposed on both a top surface and a bottom surface of the porous support material 6004. The layered structure of the reinforced membrane 6000 may combine the mechanical properties of the porous support material 6004 with the ion transport characteristics of the polymer layers 6002.

The porous support material 6004 may provide mechanical support and durability to the reinforced membrane 6000. In one embodiment, the porous support material 6004 may comprise expanded polytetrafluoroethylene (ePTFE). The ePTFE material may comprise a fluorinated polymer with a porous microstructure that provides a scaffold for the polymer layers 6002. The porous support material 6004 may be configured with a regular pattern of openings that allow the polymer layers 6002 to bond to and/or interpenetrate the porous support material 6004.

The polymer layers 6002 may comprise ion-selective polymeric materials configured to permit transport of lithium ions while reducing transport of foulant species. In various embodiments, the polymer layers 6002 may comprise perfluorosulfonic acid (PFSA) polymers such as Nafion and/or Aquivion. The polymer layers 6002 may comprise cation exchange membrane materials, sulfonated hydrocarbon materials such as sulfonated polyether ether ketone (SPEEK), and/or other polymeric materials configured for selective ion transport.

In one embodiment, the polymer layers 6002 may be non-porous such that fouling is limited to an outermost surface of the reinforced membrane 6000 rather than within pores. The non-porous configuration of the polymer layers 6002 may facilitate removal of foulants through cleaning-in-place (CIP) procedures. A concentration gradient may drive lithium ions through a bulk of the polymer layers 6002 rather than through pores.

The sandwich configuration of the reinforced membrane 6000 may allow the reinforced membrane 6000 to maintain structural integrity while permitting selective ion transport through the polymer layers 6002. The porous support material 6004 may provide a framework that distributes mechanical stresses across the reinforced membrane 6000. The polymer layers 6002 may be bonded to the porous support material 6004 through chemical bonding, mechanical interlocking within the porous structure, and/or other attachment mechanisms.

In various embodiments, the reinforced membrane 6000 may provide improved mechanical support compared to unsupported membrane structures. The porous support material 6004 may increase a tensile strength of the reinforced membrane 6000 compared to a membrane comprising only the polymer layers 6002. The mechanical reinforcement may enable the reinforced membrane 6000 to withstand pressure differentials, flow forces, and/or handling stresses during installation and operation in lithium extraction systems.

In various embodiments, the reinforced membrane 6000 may provide improved durability and longevity compared to unsupported membrane structures. The porous support material 6004 may reduce degradation of the polymer layers 6002 over extended periods of operation. The ePTFE material of the porous support material 6004 may provide chemical resistance to the feed solutions and/or cleaning agents used in lithium extraction operations. The reinforced configuration may extend an operational lifetime of the reinforced membrane 6000 in lithium extraction applications involving exposure to brine solutions containing various foulant species.

In various embodiments, the thickness of the porous support material 6004 and/or the polymer layers 6002 may be selected based on the mechanical requirements and/or ion transport requirements of the lithium extraction system. A thicker porous support material 6004 may provide increased mechanical strength, while a thinner porous support material 6004 may reduce a total thickness of the reinforced membrane 6000. The thickness of the polymer layers 6002 may be selected to provide a desired lithium ion transport rate while maintaining sufficient mechanical integrity and foulant rejection characteristics.

### Additional Embodiments

In various embodiments, the passive transport mechanism of the membrane-assisted lithium extraction system may provide economic advantages compared to electrochemically-driven systems. By driving lithium ion transport through diffusion resulting from a concentration gradient rather than through application of an external electric potential, the system may reduce energy consumption during lithium extraction operations. The passive transport mechanism may simplify electrical infrastructure requirements by eliminating the need for power supplies, electrodes, and associated control systems that would otherwise be required for electrochemically-driven transport. The reduced energy consumption and simplified infrastructure may lower both capital costs and operational costs for lithium extraction facilities, potentially making lithium recovery from lower-grade brine resources commercially viable.

In various embodiments, the membrane may comprise fluorinated ionomer materials. The fluorinated ionomer membrane may comprise a fluorinated polymer backbone with ionic functional groups that facilitate selective ion transport. The fluorinated ionomer membrane may be configured to permit transport of lithium ions while reducing transport of foulant species based on charge-based selectivity and/or size exclusion mechanisms. The fluorinated ionomer materials may provide chemical resistance to the feed solutions and/or cleaning agents used in lithium extraction operations.

In various embodiments, the crossflow configuration may provide advantages over dead-end flow configurations for membrane-based lithium extraction. Dead-end flow configurations, in which process solutions flow perpendicular to and through the membrane, may actively encourage fouling that is often irreversible. In contrast, the crossflow configuration, in which process solutions flow parallel to the membrane surface, may reduce fouling through high shear forces at the membrane surface that continuously sweep foulant species away before the foulant species can accumulate. The tangential flow of the feed solution in the crossflow configuration may enable extended operation periods between cleaning cycles compared to dead-end flow configurations.

In various embodiments, the membrane-assisted lithium extraction system may enable utilization of domestic lithium resources that were previously considered commercially impractical due to high foulant content. By reducing the need for extensive upstream pretreatment, the system may enable lithium recovery from lower-grade geothermal brines, produced water from oil and gas operations, and other domestic brine sources. The ability to process domestic lithium resources may reduce reliance on imported lithium materials and diversify lithium supply chains for battery manufacturing and energy storage applications. The simplified process flowsheet and reduced sludge generation may make extraction from previously uneconomical domestic resources commercially viable.

In various embodiments, the reinforced membrane configuration may extend operational lifetime of the membrane in lithium extraction applications. The porous support material may reduce degradation of the polymer layers over extended periods of operation, thereby reducing membrane replacement frequency. The extended operational lifetime may lower maintenance costs and reduce system downtime associated with membrane replacement. The reinforced membrane may sustain consistent lithium transport performance over extended operation periods even when exposed to brine solutions containing various foulant species.

In various embodiments, the lithium sink may comprise an electrochemical filtration or extraction system configured to reduce the concentration of lithium ions in the receiving solution. The electrochemical filtration or extraction system may comprise one or more electrodes configured to capture lithium ions through electrochemical intercalation into electrode materials. The electrode materials may comprise lithium titanate, lithium manganese oxide, lithium iron phosphate, graphite, or other materials capable of reversibly intercalating lithium ions under applied potential. The electrochemical lithium sink may be configured to periodically release accumulated lithium ions by reversing the applied potential, enabling recovery of lithium for downstream processing.

In various embodiments, the lithium sink may comprise alternative configurations beyond sorbent materials. The lithium sink may comprise a precipitation-based system configured to reduce the concentration of lithium ions in the receiving solution by precipitating lithium salts such as lithium carbonate or lithium phosphate. The lithium sink may comprise an electrodeposition system configured to reduce the concentration of lithium ions by depositing lithium metal onto a cathode surface. The lithium sink may comprise a continuous lithium removal system configured to continuously transfer lithium ions from the receiving solution to a downstream processing stream, thereby maintaining a low lithium ion concentration in the receiving solution and sustaining the concentration gradient that drives passive transport through the membrane.

### Use Case Scenario

By way of a use-case scenario, and in various embodiments, a lithium extraction facility operator implements the membrane-assisted lithium extraction system to process lower-grade domestic brine resources that were previously considered commercially impractical due to high foulant content and/or low lithium content. The system places a membrane-based barrier between the raw brine and the lithium-capturing sink, enabling lithium extraction while reducing exposure of the sink to dissolved impurities such as silica species, multivalent cations, organic substances, and hydrogen sulfide. By utilizing passive diffusion driven by a concentration gradient rather than requiring extensive upstream pretreatment, the facility operator may simplify the direct lithium extraction flowsheet, reduce sludge generation, and decrease the capital and operating costs associated with chemical precipitation, filtration, and solids handling equipment. The modular configuration of the membrane system allows the operator to scale lithium processing capacity by adjusting the number of membrane modules to meet varying throughput requirements, while cleaning-in-place procedures enable restoration of membrane performance without requiring system shutdown or membrane replacement.

In the energy storage and battery manufacturing industry, the membrane-assisted lithium extraction system may enable production of lithium from a wider range of lithium resources, including geothermal brines and other dilute sources that contain foulant species incompatible with conventional sorbent-based extraction methods. By reducing reliance on high-grade brine sources and extensive pretreatment processes, battery manufacturers may diversify their lithium supply chains and reduce dependence on imported lithium materials. The system may support production of lithium salts, lithium carbonate, lithium hydroxide, and other lithium products suitable for use in lithium-ion battery production for electric vehicles and grid-scale energy storage applications.

In the critical minerals processing industry, the membrane-assisted lithium extraction system may address challenges associated with extracting lithium from resources that would otherwise be difficult to process due to the presence of dissolved foulants. Conventional extraction methods from ore and clay may require large volumes of water and produce toxic waste streams, while evaporative methods from brines may only be economically viable when lithium concentrations are high. The membrane-based approach disclosed herein may enable lithium recovery from more dilute sources using less energy input and fewer chemical reagents, potentially making extraction from previously uneconomical resources commercially viable while reducing environmental impact through decreased sludge generation and waste stream production.

In various embodiments, the membrane-assisted lithium extraction system may also be applied to conventional hard rock mining processes in which solid lithium-bearing minerals are leached in acid at elevated temperatures to release lithium ions into solution. The resulting leach solution may contain high concentrations of dissolved impurities such as silica, aluminum, iron, and other species that are released from the mineral matrix during the leaching process. The membrane-based barrier may be configured to selectively extract lithium ions from the leach solution while reducing exposure of the lithium sink to the dissolved impurities, thereby simplifying downstream purification of the lithium product and reducing the need for extensive chemical treatment of the leach solution.

In the water treatment and resource recovery industry, the membrane-assisted lithium extraction system may provide a platform for recovering lithium from industrial process streams, produced water from oil and gas operations, and other aqueous sources containing lithium ions along with various impurities. The crossflow configuration of the membrane system may reduce fouling by maintaining high shear forces at membrane surfaces, while the guard solution and bleed stream configurations may provide additional protection against foulant accumulation. The ability to operate the system with passive lithium transport driven by concentration gradients, without application of external electric potentials, may reduce energy consumption and operational complexity compared to electrochemical extraction methods.

### Improvements Over Existing Systems

The present disclosure addresses significant challenges in the lithium extraction industry that have long plagued existing direct lithium extraction (DLE) systems. Many lithium-containing brines, particularly lower-grade domestic resources, contain dissolved impurities that can interfere with lithium extraction operations. These impurities, which may include silica species, multivalent cations, organic substances, and hydrogen sulfide, can foul, poison, or otherwise degrade the performance of lithium-capturing materials used in extraction systems. Existing approaches to address foulant interference typically rely on extensive upstream pretreatment of the brine before it contacts the lithium-capturing materials. Such pretreatment steps may include various forms of filtration, chemical precipitation using lime softening or soda ash treatment, pH adjustment, aeration, and other conditioning methods. While these pretreatment approaches can effectively protect downstream extraction components from foulant exposure, they introduce significant process complexity and operational burden. The additional equipment, chemical inputs, and process steps required for pretreatment can substantially increase capital and operating costs for lithium extraction facilities. Chemical precipitation methods used to remove multivalent cations and silica species from brines often generate substantial quantities of sludge and solid waste streams that require handling, treatment, and disposal. In many cases, the volume and cost of managing these waste streams can render an otherwise viable lithium extraction project commercially impractical.

The disclosed system overcomes these deficiencies through a novel approach that places a membrane-based barrier between the raw brine and the lithium-capturing sink, such that lithium can be extracted while reducing exposure of the sink to foulants. The membrane is configured to permit transport of lithium ions from the feed solution to the receiving solution while reducing transport of at least a portion of the one or more foulant species. The lithium sink is configured to reduce a concentration of lithium ions in the receiving solution, and transport of the lithium ions through the membrane may be driven by diffusion resulting from a concentration gradient between the feed solution and the receiving solution.

The transport of lithium ions through the membrane may be passive in nature, driven by diffusion as a result of concentration differences between the feed and receiving solutions, without application of an external electric potential across the membrane. The membrane may be non-porous, such that fouling is limited to an outermost surface of the membrane rather than within pores, making it easier to clean off the foulants from the membrane through cleaning-in-place procedures. The system may include additional membrane layers and guard solutions between the feed and receiving solutions, where the additional membrane layers can be configured to act as additional barriers for foulants or can act as barriers to different types of foulants than the first membrane. The system assembly of membranes may be modular, such that a given lithium processing rate can be met by scaling up the number of individual modules to meet a throughput target. This innovative approach not only protects the lithium-capturing sink from foulant exposure but also simplifies DLE flowsheets, reduces sludge generation, and enables lithium recovery from resources that may otherwise be difficult to process.

Further, in various embodiments, the membrane-assisted lithium extraction system may provide mechanistic advantages over conventional membrane-based processes that further reduce fouling and improve operational efficiency. The crossflow configuration of the disclosed system, in which process solutions flow parallel to the membrane surface, promotes turbulence at the membrane surface and makes adhesion of foulant species to the membrane difficult. In contrast, reverse osmosis (RO) membranes and other conventional membrane-based water treatment systems typically use dead-end flow configurations that force liquid perpendicular to and through the membrane. Dead-end flow has the opposite effect of crossflow—it actively encourages foulant deposition on the membrane surface and even within membrane pores, leading to fouling that is often irreversible and requires membrane replacement rather than simple cleaning.

In various embodiments, the passive, diffusion-driven transport mechanism of the disclosed system may provide advantages over other membrane-based processes that use cation-exchange membranes such as PFSA or Nafion in electrochemical cells. Electrodialysis processes, for example, use cation-exchange membranes with applied electric fields to drive ion transport. In addition to requiring a significant amount of electrical power—which alone may render the process non-viable for lithium extraction from brines where lithium is present at low concentrations relative to other ions—the electric fields and concentration gradients in electrodialysis create additional effects such as local concentration polarization and pH gradients at the membrane surfaces. These local concentration and pH gradients can cause local precipitation of multivalent ions such as calcium, magnesium, and other multivalent species, as well as silica, directly on or within the membrane. This localized precipitation is a primary mechanism of fouling in electrodialysis cells. By not using electric fields, the disclosed system may prevent this mechanism of fouling entirely, relying instead on passive diffusion driven by the concentration gradient maintained by the lithium sink.

In various embodiments, the disclosed system may provide advantages related to the buffering chemistry of the feed and receiving solutions. Natural brines are typically buffered by dissolved carbonates, including carbonic acid and bicarbonate, which is commonly referred to as the alkalinity of the brine. In conventional pretreatment processes, precipitating foulants from the brine requires first adding sufficient reagent to consume the carbonate buffer past its buffering capacity before the pH can increase enough for precipitation to occur. Typically, lime (Ca(OH)2) is used to adjust pH due to its low cost, requiring a large quantity of calcium to first consume the carbonate buffer, then additional calcium to precipitate magnesium as Mg(OH)2 and silica as magnesium and/or calcium silicates. Subsequently, sodium carbonate is added to precipitate the calcium—including the calcium that was added solely for consuming the buffer and precipitating the magnesium—as calcium carbonate (CaCO3). This multi-step reagent addition process consumes large quantities of chemicals and generates substantial waste streams.

In contrast, the carbonate buffer species in the brine may not readily cross the membrane, which allows the receiving solution and/or guard solution to use a different buffer system and buffer concentration than the feed solution. If a recycle stream is used to precipitate multivalent cations and silica that cross into the receiving solution or guard solution, the operator may benefit from both having substantially less foulant to precipitate and not needing to add lime solely to consume the carbonate buffer. The buffer system and concentration in the receiving solution and/or guard solution may be selected to have low alkalinity, thereby reducing the quantity of reagents required to achieve precipitation of the foulant species that have crossed the membrane.

In various embodiments, the magnesium precipitated from the receiving solution or guard solution may be of higher purity than magnesium precipitated in conventional DLE or water treatment processes. In conventional processes, magnesium is typically precipitated using lime (Ca(OH)2) or occasionally sodium hydroxide (NaOH), but because the brine naturally contains carbonate ions, the precipitated Mg(OH)2 often contains calcium impurities that may be too expensive to remove. In the disclosed system, the membrane may be more effective at blocking carbonate species in the brine from crossing to the receiving solution, making it easier to precipitate magnesium without introducing calcium impurities from the carbonate buffer. The resulting Mg(OH)2 precipitate may be of sufficient purity to be collected and sold as a commodity, providing an additional value stream for the lithium extraction operation beyond the primary lithium product.

### System Implementation Embodiments

A number of implementations have been described. Nevertheless, it will be understood that various modifications may be made without departing from the spirit and scope of the disclosure. Accordingly, other implementations are within the scope of the following claims.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A system for extracting lithium from a lithium-containing brine, the system comprising:
a feed solution comprising lithium ions and one or more foulant species;
a receiving solution configured to receive lithium ions from the feed solution;
a membrane separating the feed solution from the receiving solution, wherein the membrane is configured to permit transport of lithium ions from the feed solution to the receiving solution while reducing transport of at least a portion of the one or more foulant species; and
a lithium sink in physical contact with the receiving solution, wherein the lithium sink is configured to remove lithium ions from the receiving solution to limit lithium accumulation in the receiving solution and to preserve a concentration difference across the membrane that promotes transport of lithium ions from the feed solution to the receiving solution,
wherein transport of the lithium ions through the membrane occurs by diffusion under a concentration gradient between the feed solution and the receiving solution.

2. The system of claim 1, wherein the one or more foulant species comprise at least one of silica species, multivalent cations, organic substances, sulfate anions, borate anions, or hydrogen sulfide.

3. The system of claim 2, wherein the silica species comprise at least one of SiO₂ particles, silicic acid, or polymeric silica, and wherein the multivalent cations comprise at least one of magnesium, calcium, barium, strontium, aluminum, or iron.

4. The system of claim 1, wherein the lithium sink comprises one or more materials configured to reduce the concentration of lithium ions in the receiving solution by at least one of sorption, adsorption, electrochemical intercalation, or ion exchange.

5. The system of claim 4, wherein the one or more materials comprise at least one of aluminum hydroxide, lithium titanate, lithium iron phosphate, or lithium manganese oxide, and wherein the one or more materials are configured to maintain the concentration gradient by continuously removing lithium ions from the receiving solution as the lithium ions migrate through the membrane.

6. The system of claim 1, wherein the concentration gradient is maintained without application of an external electric potential across the membrane, and wherein the transport of lithium ions through the membrane occurs without application of a current across an anode and a cathode.

7. The system of claim 1, wherein the lithium sink maintains the concentration gradient by reducing a concentration of free lithium ions in the receiving solution below a concentration of lithium ions in the feed solution.

8. The system of claim 7, wherein the lithium sink reduces the concentration of free lithium ions in the receiving solution to near zero, or to approximately 10 ppm or below.

9. The system of claim 1, wherein the lithium sink is configured to periodically release accumulated lithium ions for downstream processing and subsequently resume reducing the concentration of lithium ions in the receiving solution.

10. The system of claim 1, wherein a rate of transport of the lithium ions through the membrane is proportional to the concentration gradient, and wherein the lithium sink is sized to maintain a target transport rate by reducing the concentration of lithium ions in the receiving solution at a rate at least equal to the rate of transport through the membrane, and wherein the lithium sink comprises one or more electrochemical intercalation compounds and an applied current to the one or more electrochemical intercalation compounds is controlled based on the rate of transport of the lithium ions through the membrane such that the applied current is decreased as the concentration gradient decreases over time.

11. The system of claim 1, wherein the membrane is non-porous such that fouling is limited to an outermost surface of the membrane, and wherein the concentration gradient drives the lithium ions through a bulk of the membrane material rather than through pores.

12. The system of claim 1, wherein the membrane comprises a perfluorosulfonic acid polymer, and wherein the membrane is reinforced with a porous support material.

13. The system of claim 1, wherein the membrane comprises at least one of a polymeric membrane, an inorganic membrane, or a hybrid membrane, and wherein the polymeric membrane comprises at least one of a perfluorosulfonic acid membrane, a cation exchange membrane, a sulfonated hydrocarbon membrane, a nanoporous membrane, a zwitterionic membrane, or a fluoropolymer membrane.

14. The system of claim 1, wherein the membrane is configured to undergo a cleaning-in-place procedure comprising treatment with at least one of a strong acid, a strong base, a chelator, an oxidizer, or a surfactant to remove foulants from a surface of the membrane.

15. The system of claim 1, further comprising:
a guard solution disposed between a first membrane and a second membrane, wherein the first membrane is configured to permit transport of lithium ions while reducing transport of one or more silica-based foulant species, and the second membrane is configured to permit transport of lithium ions while reducing transport of one or more multivalent cation foulant species; and wherein the receiving solution is disposed on a side of the second membrane opposite the guard solution.

16. The system of claim 15, wherein the first membrane comprises a perfluorosulfonic acid polymer and the second membrane comprises a monovalent-selective cation exchange membrane, and wherein the system further comprises a bleed stream or a precipitation stream configured to periodically or continuously remove a portion of the guard solution to prevent accumulation of foulant species that have crossed the first membrane.

17. The system of claim 1, wherein the membrane is housed within a membrane stack comprising a plurality of membrane layers separated by flow compartments, wherein the feed solution flows through at least one of the flow compartments in a crossflow configuration parallel to a surface of at least one of the plurality of membrane layers.

18. The system of claim 17, wherein the membrane stack is modular such that a lithium processing rate is scalable by adjusting a number of membrane stack modules.

19. The system of claim 1, further comprising one or more electrodes disposed within a housing of the membrane, wherein the one or more electrodes are configured to generate an electric field to dislodge foulants from a surface of the membrane.

20. The system of claim 1, wherein the one or more foulant species comprise at least one of silica species, multivalent cations, organic substances, or hydrogen sulfide, and wherein the membrane reduces transport of the at least one of the silica species, the multivalent cations, the organic substances, or the hydrogen sulfide while the concentration gradient passively drives the lithium ions through the membrane to the lithium sink.
